(19) United States
(12) Patent Application Publication
(10) Pub. No.: US 2025/0062644 A1
(43) Pub. Date: Feb. 20, 2025

(54) TIMESCALE POWER BEAMING TRANSCEIVER ENERGY STORAGE DEVICES

(71) Applicant: Anthony CALOMERIS, Silver Spring, MD (US)

(72) Inventor: Anthony CALOMERIS, Silver Spring, MD (US)

(21) Appl. No.: 18/662,588

(22) Filed: May 13, 2024

Related U.S. Application Data
(60) Provisional application No. 63/466,072, filed on May 12, 2023.
(60) Provisional application No. 63/524,299, filed on Jun. 30, 2023.
(60) Provisional application No. 63/646,081, filed on May 13, 2024.
(60) Provisional application No. 63/646,101, filed on May 13, 2024.

(51) Int. Cl. H02J 50/30; H01J 29/04; H01J 29/82; H01J 29/96; H02J 50/50

(52) U.S. Cl. CPC H02J 50/30; H01J 29/04; H01J 29/82; H01J 29/96; H02J 50/50

(57) ABSTRACT

The fundamental constituents of the beam processes coming from the atomic, molecular, optical, selective advanced materials, laser and plasma wakefield reactor cell device makeup the quantum mechanics process solution for a stable power beaming transceiver. This is done by applying the energy processes manipulation during timescale operation. The main aim is to control stable beams from the power transmission to receiver devices into high energy storage banks at multiple locations. This energy beam process manipulation will prove useful and economically beneficial for real time applications. Additionally, this process solution uses laser, polarizer, plasma, and photonic technologies as well as using the scale range from macro to nano photonics and plasmonics applications to manipulate atomic quantum mechanics for wide a range of power transceiver beam applications.

### CROSS-REFERENCE TO RELATED APPLICATIONS

The present application claims priority benefit of U.S. Provisional Patent Application No. 63/466,072 filed on May 12, 2023 entitled “Laser Driven Quantum Plasma Capacitor Energy Storage in Vacuum,” U.S. Provisional Patent Application No. 63/524,299 filed on Jun. 30, 2023 entitled “Power Beaming Energy Storage Network,” U.S. Provisional Patent Application No. 63/646,081 filed on May 13, 2024 entitled “Guided Particle Beam Propagation and Energy Barrier Conversion,” and U.S. Provisional Patent Application No. 63/646,101 filed on May 13, 2024 entitled “Power Beaming Transmission, Extraction, Conversion, Energy Storage, and Network.” The entirety of each of the above-listed applications are hereby incorporated herein by reference.

### FIELD OF DISCLOSURE

The present disclosure relates generally to energy storage and more specifically to systems and methods of wireless transmission and storage of high energy electrical power.

### BACKGROUND

The fundamental constituents of matter in our everyday world, such as electrons, protons, ions, atoms, molecules, elementary particles, and plasma as well as electromagnetic radiation emissions into particular high energy beam propagation travels at a great distance. These ultimate potential processes are coming from the manipulated atomic, molecular, optical, electronic controller circuits, advanced materials, and the plasma physics into reactor cell chamber stages. Using lasing, electrons, ions, particles, and plasma, and photonic technologies at the scale from meters to nanometer as well as using nanophotonics and plasmonics applications to manipulate atomic quantum mechanics for a wide range of different applications.

These schemes of particle acceleration have aimed potential into multi-GeV energy gain in plasma wakefield accelerator and low-energy spread electron bunches (100 MeV-GeV) from laser wakefield acceleration.

Another aimed potential is producing the quantum mechanics beam propagations by applying the energy processes manipulation via beam waveguide chamber with electronic circuit as timescale controller.

An aim is to control and image these quantum processes manipulation from the compact of multi-stages reactor cell chambers via lasing beam into high electron energy beam energy propagations, keeping all the acceleration process beams long enough toward the target during timescale operations, and enables adjusting the level of the energy beams over great distances at greater flexible processes to our useful and economic applications in real needed time.

Using the methods of laser and plasma wakefield acceleration chambers via electronic circuit controller processes allows and enables the selective of desired wide range of different types of beam propagations, adjusting to the high energy beam for output transmission, and downloads its beam energy into storage receiver devices. All these devices, methods, and systems that will be discussed herein address this huge potential and other needs.

### SUMMARY

Several mechanisms for laser-driven electron and plasma acceleration have been described in U.S. Pat. No. 11,310,900, the entirety of which is incorporated herein by reference, such as direct laser acceleration and acceleration by pondermotive force of laser-induced in various forms including gas, liquid, and vacuum medium conditions using the timescale controller that may be applied in greater compact devices.

The pondermotive force following either linear or circular polarization accelerates the electron, particles, and ions or excites a large amplitude plasma wave that may accelerate electrons (or ions, particles, and nanoparticles) indirectly.

Using optical mixing of laser light in plasma and electron acceleration by relativistic electron plasma waves has the potential of keeping the divergence beam along at greater propagation distance that used the particle acceleration process in relativistic laser channels.

The propagated multi-GeV energy beam come with the spread electron, particle, and ion bunches, and may be transformed into an energy receiver device as the storage energy banks, as well as transfer its reserved leftover energy back to another target.

According to the present disclosure, methods are disclosed for using and storing high energy and power density. The systems and methods may provide electrical power from long durable energy storage scalable at the macroscopic to nanometer range using electron/photonic high and low isolation sides, and photon/electron emission control systems. The systems and methods of electrical power generation using laser driven electron injector waveguide include: (1) an efficient switching energy source, (2) a quantum mechanics approach, (3) a tunneling current, (4) capacitance barriers that may comprise a metal, carbon, graphite, or semiconductor plate, (5) an injector or anode, (6) a cathode, (7) a floating gate, and (8) one or more control plate layers. In certain embodiments, using two different axis paths of laser waveguides controls the highest plasma flow safely and provides protection under different isolation sides via electron emission mechanism, tunneling effects, and compact geometrical dimension design.

According to the present disclosure, a power beaming energy storage network includes a laser waveguide, high voltage dielectric barriers discharge reactor tube device, high voltage plasma electrodes, electron field emission path control, and charging/discharging nanometer capacitor tube devices. The systems and methods disclosed herein may utilize a high voltage dielectric barriers discharge (DBD) reactor tube device and electric field emission path control during the operation of the input laser beam propagation for a wireless power grid or power beaming network. In some embodiments, laser driven electron plasma beams can then convert into energy storage and transport energy/power to grids without wiring.

Producing the plasma filament in straight line at the speed of light can be achieved using one electrode by high voltage source generator via the electrical circuit loop at any location such as from air, space, and ground. A reactor tube device having enough impulse force to get the electrons to travel along the laser-driven electron-plasma as conductor path across the vacuum. The plasma can travel at any location where there is charge region concentration availability either in upstream or ground. Using either polarity of charging regions from or to electrode separately allows the plasma filament flow to any location.

### BRIEF DESCRIPTION OF THE DRAWINGS

The features and advantages of the present disclosure will be more fully disclosed in, or rendered obvious by, the following detailed descriptions of example embodiments. The detailed descriptions of the example embodiments are to be considered together with the accompanying drawings wherein like numbers refer to like parts and further wherein:

FIG. 1A depicts a first type of photolithographic sandwiches with a plurality of nanometer capacitors;

FIG. 1B depicts a second type of photolithographic sandwiches with a plurality of nanometer capacitors;

FIG. 1C depicts a third type of photolithographic sandwiches with a plurality of nanometer capacitors;

FIG. 2A depicts a front view of a capillary or tube having nanotube layers;

FIG. 2B depicts a side view of a capillary or tube having nanotube layers;

FIG. 3 depicts a laser driven quantum plasma capacitor energy storage device;

FIG. 4 depicts sequence switching timing for a quantum plasma capacitor circuit;

FIG. 5 depicts a tube dielectric charge barriers for laser waveguide incoming;

FIG. 6 depicts an electron emission strike from photons and electrons from a laser waveguide;

FIG. 7 depicts a capacitor circuit used for electrons that jump across the dielectric tunnels;

FIG. 8 depicts a block diagram of long duration quantum capacitance energy storage;

FIG. 9 depicts a pulse content diagram;

FIG. 10 depicts a pulse duty cycle;

FIG. 11 depicts a laser driven electron beam plasma stepped leader power transmission grid;

FIG. 12 depicts one example of a high voltage dielectric barrier discharge reactor tube;

FIG. 13 depicts a second example of a high voltage dielectric barrier discharge reactor tube;

FIG. 14A depicts a first isometric view of a third example of a high voltage dielectric barrier discharge reactor tube;

FIG. 14B depicts a side view of a third example of a high voltage dielectric barrier discharge reactor tube;

FIG. 14C depicts a second isometric view of a third example of a high voltage dielectric barrier discharge reactor tube;

FIG. 15 depicts a reactor tube support;

FIG. 16 depicts a reactor tube support and a base;

FIG. 17 depicts a fourth example of a reactor tube;

FIG. 18 depicts a cross-sectional view of a reactor tube;

FIG. 19 depicts a dielectric barrier discharge equivalent circuit using two electrode rings;

FIG. 20 depicts an exemplary Q-V Lissajous diagram;

FIG. 21 depicts a bipolar short pulse voltage supply circuit;

FIGS. 22A-22B depict a ultrafast barrier energy conversion model with pulse shape control system;

FIG. 23 depicts a waveform of an exemplary bipolar short pulse circuit;

FIG. 24 depicts an exemplary graph of voltage and current pulses from a dielectric barrier discharge reactor tube;

FIG. 25 depicts an exemplary Q-V plot of the voltage and current rates from a dielectric barrier discharge reactor tube;

FIG. 26 depicts an exemplary Q-V parallelogram;

FIG. 27 depicts a time frame of quantum mechanics for laser-electron propagation beams;

FIG. 28 depicts different types and stages of beam propagation along a transmission distance;

FIG. 29 depicts electrons trapped in a laser guided beam;

FIGS. 30A-C depict the charge medium polarization effect;

FIG. 31 depicts sequence timing events for a dielectric barrier discharge reactor tube and capacitor energy storage circuit;

FIG. 32 depicts a cycle of timing events by a microprocessor in accordance with some embodiments;

FIG. 33 depicts a high voltage dielectric barrier discharge plasma mirror;

FIG. 34 depicts an exemplary field electron emission model and circuit;

FIG. 35 depicts control and responder energy storage devices;

FIG. 36A depicts charging trapping flash;

FIG. 36B depicts nano-electronic packing;

FIG. 37A depicts a first exemplary model of Fowler-Nordheim tunneling;

FIG. 37B depicts a second exemplary model of Fowler-Nordheim tunneling;

FIG. 38 depicts laser driven field electron emission facilitated by a heterostructure charge transport device;

FIG. 39 depicts a laser beam waveguide field electron emission controller system;

FIG. 40 depicts an electron beam waveguide layout;

FIG. 41 depicts a charge transport device mechanism;

FIG. 42 depicts a flat anode and associated circuit diagrams;

FIG. 43 depicts a MOSFET switching feedback circuit;

FIG. 44 depicts an exemplary graph of voltage, current, and charge events for transferred charge;

FIG. 45A depicts an exemplary low side current sensing circuit;

FIG. 45B depicts an exemplary high side current sensing circuit;

FIG. 46 depicts an exemplary switching control system layout;

FIG. 47 depicts plasma progressive step;

FIGS. 48A-C depict different exemplary techniques for plasma leader models;

FIG. 49 depicts a global electric field;

FIG. 50 depicts an exemplary plasma one step leader model;

FIG. 51 depicts an exemplary plasma one stepped leader circuit;

FIG. 52 depicts a block diagram of an exemplary impulse power circuit;

FIG. 53 depicts an exemplary high voltage dielectric barrier discharge and high voltage impulse power circuit for a reactor tube;

FIG. 54 depicts an exemplary block diagram of high voltage power supplies for each operation event;

FIG. 55 depicts potential nature and man-made energy sources for power beaming;

FIG. 56 depicts an exemplary block diagram of a wireless power transmission grid;

FIG. 57 depicts grade levels and classifications of power beaming; [[and]]

FIGS. 58A-B depict two different options for Power Beaming Transceiver, Polarizer, and Plasma Window Shield Protection; and[[.]]

FIGS. 59A-G depict an exemplary block diagram of one embodiment of the system in accordance with some embodiments.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

This description of the exemplary embodiments is intended to be read in connection with the accompanying drawings, which are to be considered part of the entire written description. It should be understood, however, that the present disclosure is not intended to be limited to the particular forms disclosed and that the drawings are not necessarily shown to scale. Rather, the present disclosure covers all modifications, equivalents, and alternatives that fall within the spirit and scope of these exemplary embodiments. In the description, relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected” refer to a relationship wherein structures are secured or attached to one another either directly or indirectly through intervening structures, as well as both movable or rigid attachments or relationships, unless expressly described otherwise. The terms “couple,” “coupled,” “operatively coupled,” “operatively connected,” and the like should be broadly understood to refer to connecting devices or components together either mechanically, or otherwise, such that the connection allows the pertinent devices or components to operate with each other as intended by virtue of that relationship.

Systems and methods of compressing and storing fluids without rotating machinery or hydrated electrochemical are disclosed in U.S. Pat. No. 10,704,540 entitled “Ultrashort Pulse Laser-Driven Shock Wave Gas Compressor,” and systems and methods for electrical power generation are disclosed in U.S. Pat. No. 11,310,900 entitled “Pulse Laser-Driven Plasma Capacitor.” The entirety of each of the above-listed patents are hereby incorporated herein by reference.

### Laser Driven Quantum Plasma Capacitor Energy Storage in Vacuum

According to some embodiments of the present disclosure, the systems and methods for laser driven quantum plasma capacitor energy storage in a vacuum utilizes the nanometer technology (e.g., size, timescale, etc.) scale under vacuum conditions. In some embodiments, using the scalable size and timescale gives further versatile and flexible control over the wide range of power and energy density applications. For example, using a quantum system with a timescale switching system and voltage sources may produce the high energy and power density, providing for a long, durable energy storage battery according to some embodiments. This quantum system provides for a wide range of choices of existing clean energy technologies.

The laser driven quantum plasma capacitor energy storage system may be configured to work in a vacuum environment and may be configured to operate on a variety of technology scales. For example, the scalable technology sizes may include macroscopic, mesoscopic, microscopic, nanoscopic, and nanometer. Plasmonic effects on the nanometeric scale is one of rapidly growing areas of physics and nanotechnology. Laser driven quantum plasma capacitor energy storage is different from typical quantum battery mechanism. According to the present disclosure, the systems and methods disclosed herein eliminate the work function issues and the factors of anode tip involved with geometrical shapes that were used for typical digital quantum batteries.

The laser driven quantum plasma capacitor energy storage device of the present disclosure provides high energy and power density using controllable laser electron-photon waveguide power from energy sources, such as lithium-ion batteries, fuel cells, capacitors, supercapacitors, electrochemical capacitors, and quantum batteries. The laser driven quantum plasma capacitor energy storage device of the present disclosure also enables and provides the highest longest duration energy storage under vacuum conditions. It is a controllable laser waveguide that enables power-energy transmitter safety into long, durable energy storage operation. This feature is also a redundant system that may either use two different directions toward the target area using isolation sides. The system may use electron dielectric barriers switching and voltage switching sources switching system either in a DC or pulse control system.

Laser is a relativistic light that is independent from any electromagnetic interferences and disturbance results. The advantage of using a laser waveguide is the ability to control pulse rate and time duration of input energy for safe electron charge storage. The laser electrons-photons waveguide provides the electron-photons emission that may convert the striking conductive target area either in planar or concentric tube capacitors. This produces electron emission and tunneling effects on dielectric and semiconductors/graphite layers. The gate control plate or tube may pull out the electrons out of any conductive materials into charge capacitance. This enables a large energy storage capacity and keeps the longest durable energy storage without leakage current. The laser driven quantum plasma capacitor energy storage device of the present disclosure also enables charge of the floating gate quickly under both macroscopic and nanometer scale operations or from full range of the macroscopic to nanometer scale. The purpose of floating gate is to collect and keep electrons storage between dielectric and conductive areas, which may scalable (e.g., nanometer scale). The nanometer scale, using either a planar or a concentric capacitor, permits millions times gravimetric capacitance charge and provides high energy and power density.

These methods are also used for both planar layers in nanometer capacitors and nanometer concentric cylinder layers. Each voltage output from these planar and/or tube layers may be connected either in series or parallel circuits.

Using quantization phenomena to prevent the dielectric breakdown, the ratio between the stored energy and atomic volume during excitation from the ground state of conductive material, such as carbon, graphite, metallic, etc.) and semiconductor ions is around 10,000 times higher than in hydrogen atoms. The plasma current flows and the intensity of electron emission field are controlled by one or more intelligence processors coupled to one or more computing devices. In some embodiments, the laser driven quantum plasma capacitor energy storage device of the present disclosure uses a small Leo Szilard engine that converts the information using pulse switching control into energy output.

The teachings in the systems and methods disclosed in U.S. Pat. Nos. 10,704,540 and 11,310,900, already incorporated herein by reference, may be used and applied to the systems and methods described herein such as high energy transformer and cooling pump heat exchange system using hydrogen gas circulation to cool down dissipated power quantum battery devices. A difference is the isolation sides, photon-electron emissions, laser driven electron waveguide, timescale injector control, and a high voltage injector electrode interface mechanism. The time events for the tunneling electrons may be controlled by the switching system either in electron dielectric barriers or/and high voltage sources.

The laser driven quantum plasma capacitor energy storage device may be also used with both: (1) dielectric medium disturbance via impulse plasma waveguide mechanism for tube (shown and described in U.S. Pat. No. 11,310,900 not using Fowler-Nordheim electron emission field); (2) and Fowler-Nordheim electron emission field via current tunneling and the plasma flow target toward the planer layers capacitance of floating gate, which may also act as heat sink dissipation.

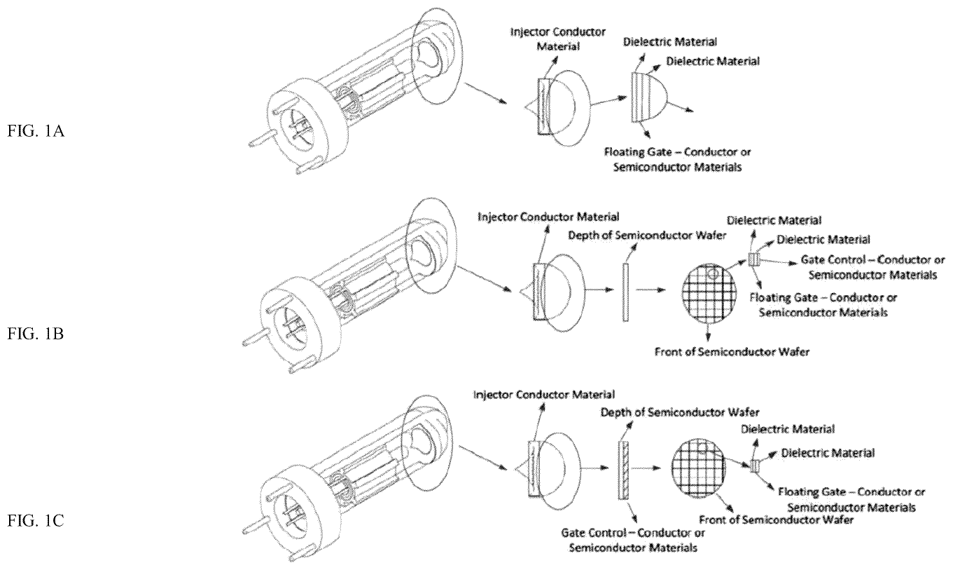

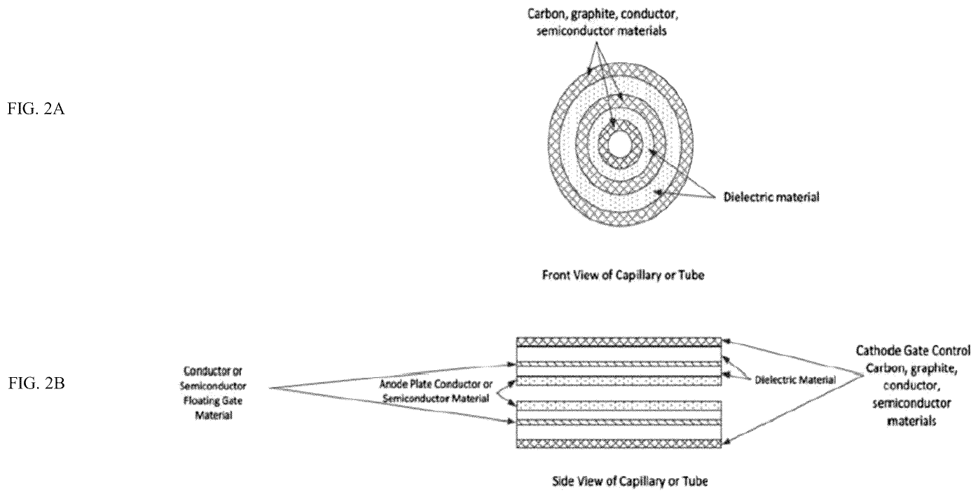

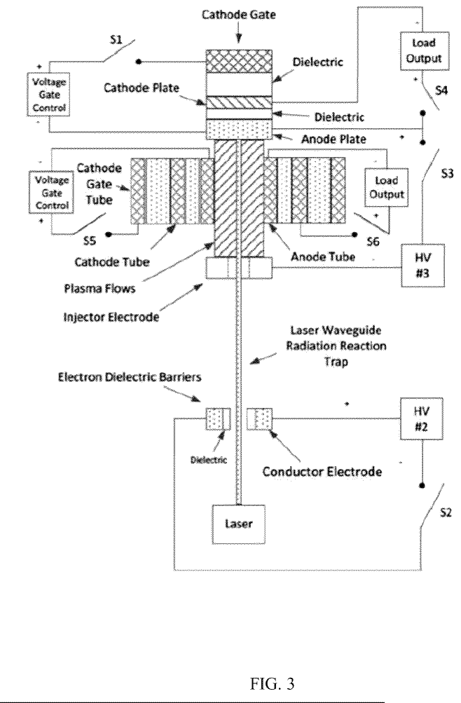

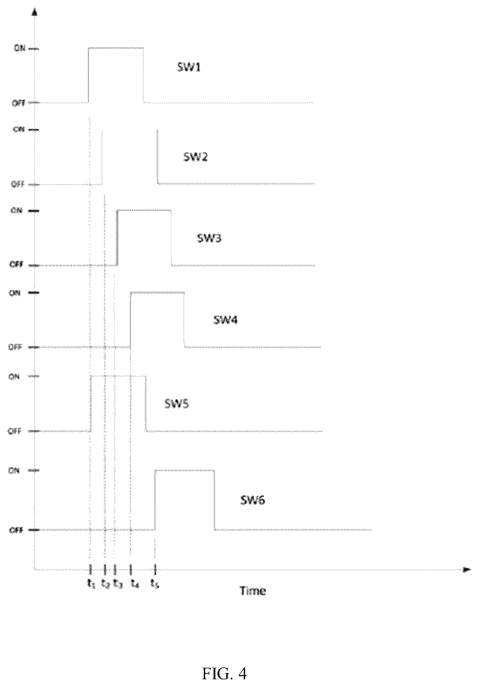

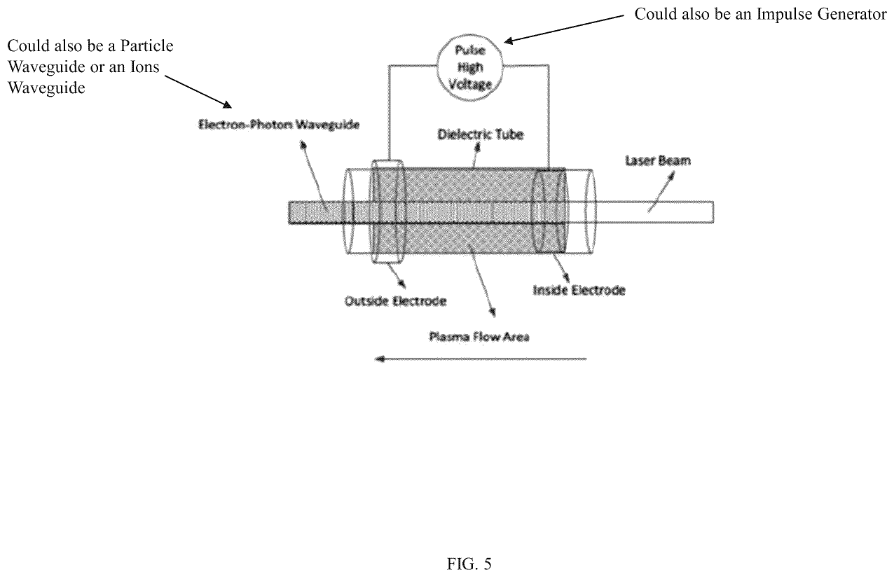

FIGS. 1A-1C depict different types of photolithographic sandwiches with a plurality of nanometer capacitors in accordance with some embodiments. FIGS. 2A-2B depict front and side views of a capillary or tube having nanotube layers in accordance with some embodiments. In some embodiments, the anode plate of an embodiment of the system may be in front for electron-photon emission purposes, and the anode plate back may be used as a cover with millions of nanometer capacitors disposed in a vacuum seal as depicted in FIGS. 1A-1C. This may be done by using one or more photo lithographic techniques, and may be integrated with electron-photonic integrated circuits for electrical energy storage as depicted in FIGS. 2A-2B. These energy storage systems and methods may be used for planar layers in millions of nanometer capacitors. In some embodiments, nanometer tube layers techniques may be used and applied for a capillary or tube as will be further discussed herein.

In some embodiments, the systems and methods for laser driven quantum plasma capacitor energy storage may also utilize a dielectric medium disturbance via impulse plasma waveguide mechanisms for a tube, such as that disclosed in U.S. Pat. No. 11,310,900. In some embodiments, the impulse plasma waveguide mechanism for a tube may not use a Fowler-Nordheim electron emission field. In other embodiments, the impulse plasma waveguide mechanism for a tube may use a Fowler-Nordheim electron emission field via current tunneling and the plasma flow target toward the planer layers capacitance of floating gate, which may act as heat sink dissipation. The target planar may be designed as a flat shape, a cone shape, or some other suitable shape as illustrated in FIGS. 1A-1C.

Laser Waveguide from Electron Dielectric Barriers

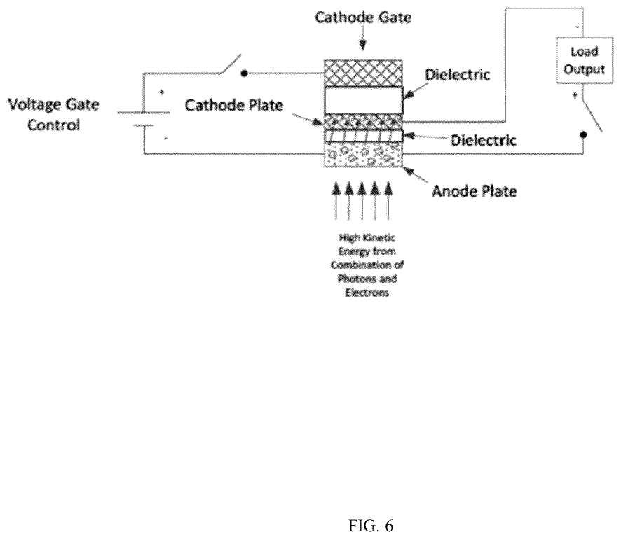

FIG. 3 depicts a laser driven quantum plasma capacitor energy storage device in accordance with some embodiments. In some embodiments, the laser driven quantum plasma capacitor energy storage systems and methods utilize a laser waveguide, facilitated by electron dielectric barriers. For example, a laser beam may trap bunches of electrons and carry them a long distance in a waveguide as a high photonic-electron isolation side. The laser beam does have both electric and magnetic fields. The motion of a free electron in a laser field may be given as:

$$\frac{dp}{dt} = {F}_{L} + {F}_{rr} \qquad ( Equation 1 )$$

Where:
p is the electron momentum;
F_{L} is the Lorentz Force; and
F is the radiation reaction force.

This free electron equation using electron momentum illustrates a new trapping effect of electrons inside the laser pulse using electron dielectric barrier devices. A plurality of electrons gather around the laser propagating axis and form a dense bunch through the pinching effect. The radiation reaction trapping also provides a collimated high density plasma bulk inside the laser pulse where y-proton emission is high intensity.

In some embodiments, there are four stages in this process. The electron dielectric barriers is the second stage before using the first stage using high applied electric field between the cathode gate and anode plate of the laser driven quantum plasma capacitor circuit.

According to some embodiments of the present disclosure, there are two different axis paths of laser waveguides that control the highest plasma flows under different isolation sides. The first path is in the x-axis, or horizontal direction. The second path is the y-axis, or vertical direction. In some embodiments, there are one or more plasma capacitors used in the system of the present disclosure. For example, the plasma capacitor may be a concentric capacitor, a planar capacitor, or some other suitable capacitor. The capacitors may be used for electricity output simulation in nanometer technology. In some embodiments, the methods used for a concentric capacitor are different from planer capacitor methods, but still use the same common tunneling effect under vacuum conditions. In some embodiments, there are several different isolation sides. The purpose of using isolation sides is to protect the other lower side under tremendous energy flush or surge during highest voltage and current impulse operation. In some embodiments of the present disclosure, the system is designed and configured to prevent the dielectric breakdown under extreme operating conditions. The advantage of using an isolation side is that it allows for increased energy and power density operation under sudden extreme conditions.

### Voltage Sources

The systems of the present disclosure may use one or more different voltage source methods, alone or in combination. For example, the systems may use voltage gate control, an external high voltage source, and/or a dielectric barriers discharge high voltage source. These high voltage sources may be also be provided using one or more of natural energy power sources, such as nature resources (e.g., solar, wind, harvested lightning, etc.).

A voltage source for gate control may be used to create an electric field and overcome the potential and surface of anode barriers. In other words, the electric field enables free electrons to pull out of these barriers (e.g., through the tunneling effect) and jump over the insulator or dielectric materials. The voltage source may also be used to create three different capacitances in one embodiment of Laser Driven Quantum Plasma Capacitor Energy Storage (LDQPCES) circuits as depicted in FIG. 3. The gate control voltage source may be either used in pulse control or a DC bias control circuit.

A voltage source may also include a dielectric barriers discharge high voltage source that is used for producing electrons trapped in laser waveguide flows toward both the capillary tube and against the target of the anode plate of the planer structure of quantum energy storage.

A voltage source may also be an external high voltage source, such as harvested lightening or user controller. The external voltage source may be used and transferred either from the laser driven plasma capacitor tube or any other external power supplies such as solar, wind power, tide power, hydrogen fuel cell, and even harvested lightning. The purpose of this voltage source is to produce electron/photon emission against the anode plate and the electrode coating of the capillary tube. The capillary tube may be made in nanometer scale along with the planer (i.e., structure of electrical energy storage).

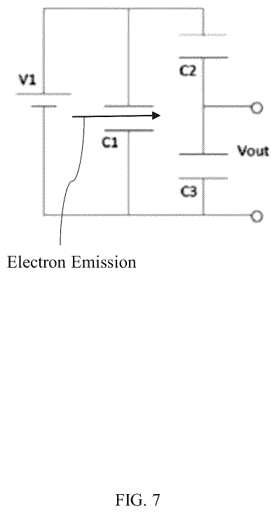

FIG. 4 depicts sequence switching timing for a quantum plasma capacitor circuit in accordance with some embodiments. In some embodiments, the systems and methods disclosed herein may use one or more switching steps for the different event stages. In some embodiments, there are six switching steps using either photoconductive or electronic semiconductor switching. The sequence timing switching for this quantum plasma capacitor circuit follows FIG. 4 for a laser driven energy storage system.

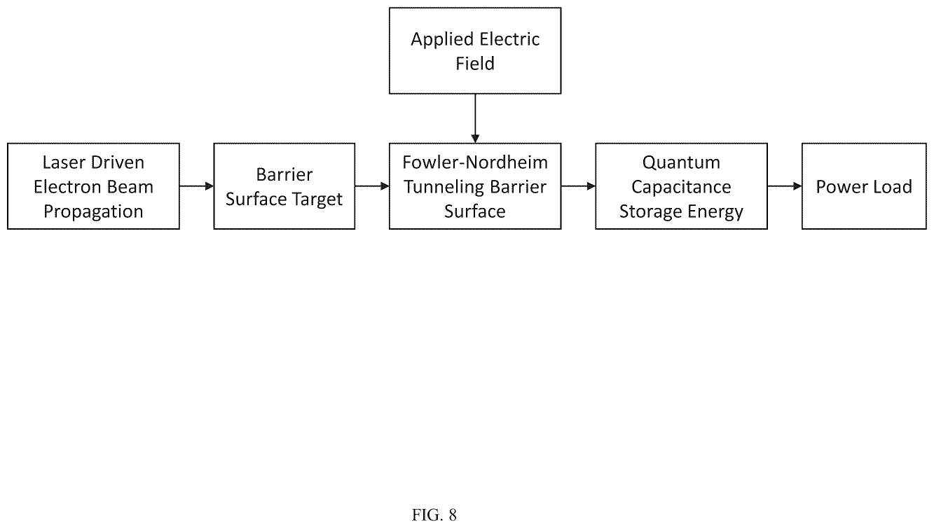

FIG. 5 depicts a tube dielectric charge barrier for laser waveguide incoming. Although FIG. 5 is depicted as a tube, the dielectric charge barriers connected to high voltage DC bias or pulse high voltage power source may be any suitable enclosure or shape.

Injector Cathode and Anode

In the first stage of the laser driven electron energy storage system, such as the one depicted in FIG. 3, either an external voltage source pulse or DC bias is applied between the cathode gate and anode plates to negatively charge the cathode plate. In the second stage, the laser driven electron waveguide uses a small electron dielectric barrier. Next, the highest voltage surge flows through between an injector and anode plate from laser waveguide via electron dielectric barriers device. The laser waveguide carries the trapped electrons through the hole of the injector electrodes and strikes against the anode plate as target area. This is the third stage process. The electrons are attracted to the cathode using high electric field (high voltage source) and jump through the tunnel (dielectric) in the cathode gate, charging the cathode plate in this way negatively, which is the quantum approach. The potential voltage of the cathode gate changes with the time using an external voltage source as the low isolation side. This effect causes an increase of the number of tunneled electrons. The tunneling current as discussed herein is based on the materials used, the strength of the applied electric field, and the principle of Fowler-Northeim equation.

The third stage of the laser driven electron energy storage (LDEES) process uses injector cathode and anode electrodes with an external high voltage source, which is the high isolation side. After the second stage activates (e.g., electron dielectric barriers), 0 to 1 million volts may surge toward the injector cathode and anode electrodes and then may be controlled under a laser waveguide. The purpose of the waveguide is to prevent any dielectric breakdown flows among the materials, except the anode plate of the laser driven quantum plasma capacitor circuit. The injector anode electrodes may be adjusted for the distance gap with the anode plate. This is just one of several examples of scalability. Scalability may also be done by timescale pulse control, by adjusting the pulse duration of energy input from any external power source.

Electron Emission

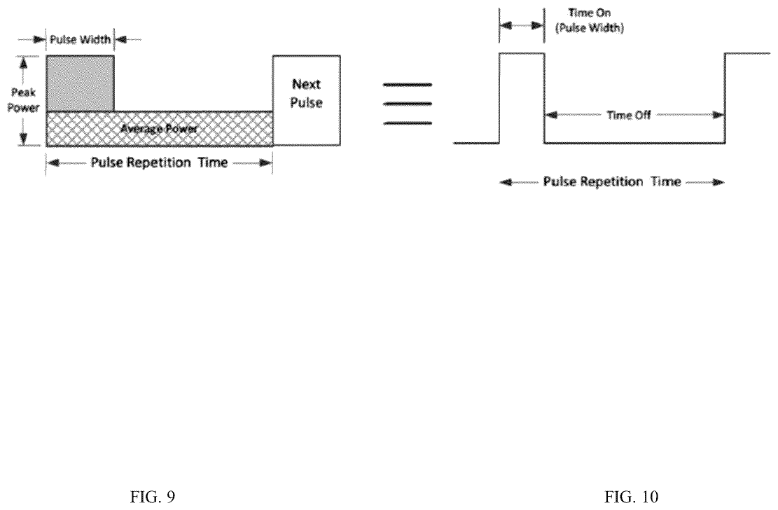

FIG. 6 depicts an electron emission strike from photons and electrons from a laser waveguide in accordance with some embodiments. Electron emission is the liberation of electrons from any conductive surface material. A piece of conductive metal block has a plurality of free electrons. This is similar to field electron emission principle from solid surface into a vacuum, which later evolved into the field of quantum mechanics. The free electrons may move randomly inside the metallic crystal, but cannot leave the surface of the metal and jump across the insulator material.

The free electrons reach the extreme boundary of the conductive block and are pulled back by the positive nuclei, which include electrically positive protons and electrically neutral neutrons. The free electrons are attracted to the positive nuclei from all sides and may move freely in any direction inside the metallic conductive material. Free electrons are still not free to jump across the dielectric materials yet, but may be done by using an applied high energy electric field across the dielectric tunneling barriers between the cathode gate, floating cathode, and anode plates. The electrons inside the metallic anode plate need to cross the potential barriers using a high voltage control source from the cathode and anode plate terminals. There is also surface potential which prevents free electron to liberate from the metallic surface. When laser waveguide with electron bunches strike against the anode plate and provide enough external energy to the free electrons inside anode plate, the free electrons may cross the surface barrier from the metallic material. A free electron processes some kinetic energy toward the anode plate, but still requires extra energy to overcome the surface barrier of any metal by an electron. For example, suppose if a tungsten metal required 4 eV to overcome the surface barrier, the electron still has 1 eV kinetic energy in it and then applied 5 eV from the laser waveguide. Then, the extra energy as a work function is 5 eV - 1 eV=4 eV. Hence, the electron emission from a metal surface depends on the work function of the metal. The work function varies for a wide range of different types of metal or conductive materials. The metal used for electron emission should preferably have a low work function, which may depend upon the external energy source. Laser waveguide may be used in one or more electron emission categories, such as thermionic emission, field emission, photoelectric emission, and secondary electron emission.

As an example, plasma may flow from the laser waveguide and produce thermionic electron emission, which gives some heat against the target metal surface, or anode plate (e.g., the injector plate). This intensity depends on the type of metal used, which would need to be able to withstand high temperatures. The field emission happens when the high electric field is applied toward the control gate and anode plate terminals. A strong external electric field pulls all the electrons out of the potential barrier using alternative force in the outward direction. This force overcomes the positive nuclei surrounding the metallic surface. This type of electron emission is caused by the electric field using a controlled high voltage source. In this emission, a million volts per centimeter would be the voltage gradient of the field. However, this does not require any extra heat energy for the field emission, which is so called cold cathode emission or cathode gate control.

Photoemission may also be involved in this process as laser waveguide carries both photons and electron bunches from the electron dielectric barriers process. Every light has the flow of photons, which processes kinetic energy. The energy depends on the wavelength and/or frequency of the laser beam waveguide. When the laser electron waveguide strikes against the anode metal surface, some of the photons and also the electron bundle transfers their energy to the free electron of the metallic surface. The free electron gets enough energy to overcome the surface barrier and start electron emission tunneling. The intensity of photoelectric emission depends on the intensity of the laser waveguide beam. When a beam of high velocity electrons from the laser waveguide strikes against the metal surface, the kinetic energy of high velocity electrons is then transferred to the free electrons on the anode plate surface. This starts electron emission, where the free electrons get enough energy to overcome the surface barrier, and may be called secondary emission. These combinations of electron emission work during the process of laser beam waveguide toward the anode plate. Also, this process represents high voltage isolation using controlled laser waveguide beam.

Tunneling Effect

The principle of this laser driven quantum plasma capacitor work is based on the quantum mechanics phenomenon of the electron tunneling and the estimation of the Fowler-Nordheim equation. The energy and movement of the electron may be explained in wave function of the Schrodinger equations and work function of the metal conductive material. A very effective electron energy storage based on the quantum mechanics may be done in the processes of the electron tunneling and laser electron waveguide using nanometer scale. This system may include five layers sandwiched together with a target of an anode plate from injector electrodes and electron dielectric barriers. In some embodiments, there are three conductive materials of either metal or semiconductor, and two different sizes of dielectric or insulator layers built in the structure as shown in FIGS. 1A-3 and 6.

The bottom of the layer structure is an anode plate. This metal or semiconductor anode layer will be used as a conductor for the work function on the principle of the Fowler-Nordheim equation. The purpose of this anode conductive plate is to create excited or avalanche electrons jumping over the dielectric or insulator barrier from the positive pole of the laser driven quantum plasma capacitor circuit toward the cathode plate as negatively charged.

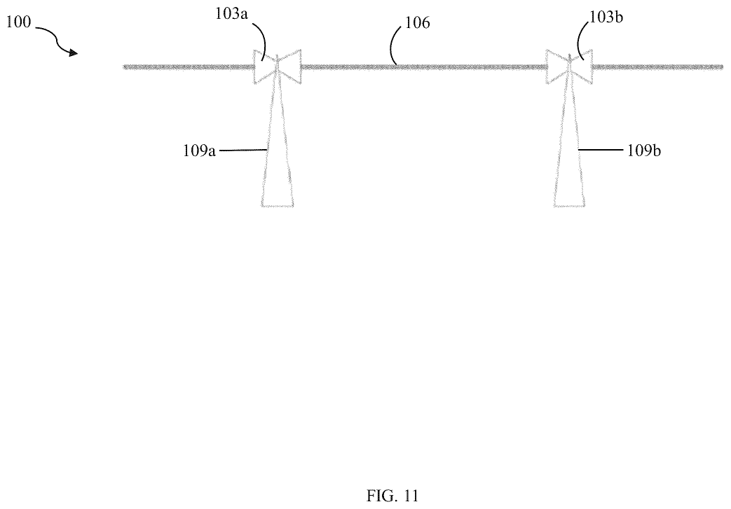

FIG. 7 depicts a capacitor circuit used for electrons that jump across the dielectric tunnels. The cathode plate, or the second conductive layer, may be called a floating gate. The purpose of using the cathode plate is to create capacitance in negative charge during the plasma flow straight from the injector electrodes to the anode plate. Both dielectric layers are placed in isolated sandwiches on the top and the bottom of the cathode plate. As illustrated in FIG. 7, Vᵢ is the high voltage gate control source (V_{GC}). C₁ is the capacitance between the cathode gate control and anode plate circuit. C₂ is the capacitance between the cathode gate control and the floating gate circuit. C₃ is the capacitance between the floating gate and anode plate control. The dielectric between the cathode gate plate and cathode plate is larger than the second dielectric between the cathode plate and anode plate. All these layers are in a vacuum structure in order of nanometer scale. In some embodiments, there is a high voltage isolation side between the anode plate and the injector electrode. The purpose of using a high isolation side is to protect the low side of laser driven quantum plasma capacitor circuit from the danger of high voltage dielectric breakdown.

The fifth control gate plate is on the top of this whole structure connected to the high voltage control source. The purpose of this cathode gate is to control the process of the electron tunneling. All these conductive layers may be achieved in a pattern of the maximum tunneling current. A cathode plate is placed in the middle of these layer structures in a vacuum environment, and it is the capacitance charged as the floating gate. The depth size of these dielectric layers may determine the amount of the charge build up, and may depend on the type of strength voltage breakdown. The amount of the voltage control level parameter depends on the type metal conductive of the work function and Fowler-Nordheim equation.

The Fowler-Nordheim equation may explain the electron tunneling inside dielectric material. The electron tunneling inside dialectical materials using the Fowler-Nordheim equation may be given by:

$$( Equation 2 )$$

$${J}_{FN} ( V ) = \frac{A {e}^{3}}{8 π h {ϕ}_{B}} \frac{m}{{m}^{*}} {( \frac{V}{d} )}^{2} {e}^{( \frac{8 π \sqrt{2 {m}^{*}} {ϕ}_{B}^{\frac{3}{2}}}{3 he} \frac{d}{V} )} \to {J}_{FN} = a {∅}^{- 1} {F}^{2} {e}^{- v ( f ) b {∅}^{\frac{3}{2}} / F}$$

### Where:

J_{FN} is the current density of the tunneling electron current;
α is the system specific constant, where

$$a = \frac{A {e}^{3}}{8 π h} ( \frac{m}{{m}^{*}} ) ;$$

∅ is the barrier height;
F is the macroscopic field between plates,

$$where = \frac{V}{d} .$$

V is the applied voltage and d is the plate separation width;
v(f) is the correction factor that is generally determined by numerical integration using other different shape barriers; and
b is the universal constant that is so called Fowler-Nordheim constant using triangular barrier shape, where

$$b = \frac{8 π \sqrt{2} {m}^{*}}{3 h e} .$$

The control plate provides the electric field that helps the electron tunneling and keep electron charges in capacitance. Using Coulomb barriers effect between conductive and dielectric layers helps and prevents the current leakage flows. Using microscopic and nanometer technologies, the series and parallel section in vacuum for this application may be used for increasing desired voltage, and current at the highest energy and power density. Each floating gate or cathode plate, N, may include hundreds, thousands, or millions of components either in series or parallel sections.

The current density equation is:

$$J = \frac{I}{A} = {J}_{FN} \qquad ( Equation 3 )$$

### Where:

I is the current; and
A is the cross-sectional area of the anode pate.

Tunneling Current may be given as:

$${I}_{FN} = N * A * {J}_{FN} \qquad ( Equation 4 )$$

### Where:

A is the area of the single floating gate, which may be a carbon, graphite, or conductive cathode plate;
N is the number of floating gate cells; and
J_{FN}is the tunneling current density per unit using the Fowler-Nordeim equation.

When using a plurality of floating gate cells (N), such as millions of cells in nanometer size and/or a large floating gate area of conductive material that the tunneling current may flow, the current increases. In other words, the gravimetric capacitance would be highest in the range of a few thousands Farads. For time derivation using the capacitance value in the circuit, the current flow through a capacitor is a function of time is given by:

$${I}_{FN} = N * A * {J}_{FN} \to {I}_{FN} = {C}_{c} * d ( {V}_{GC} + {V}_{A} ) / dt \qquad ( Equation 5 )$$

### Where:

C_{c} is the cathode gate capacitance;
V_{GC} is the high voltage control; and
V_{A} the anode voltage between the cathode gate control and anode plate.

This time function shows that the current flow through the cathode plate from the gate control plate will stop the current flows from voltage bias control or any high voltage source during constant charge in cathode gate capacitance. This load current starts equal to I_{F}m becoming quantum plasma capacitor load which means no energy is consumed from the supply resources, but load output dissipates.

A spacer is the nanometer laser that may be built with nanometer electron dielectric barriers with anode electrodes on the high isolation side. The purpose of using timescale is to control the amount of energy input dump into anode plate from the anode electrodes safely. This also allows the high isolation side to be used for protection and safety purposes. These allow flushing a huge amount of energy or fast charge in floating gate capacitance much more quickly. This means that it may be done due to smaller inductance, even in nanometer size. Also, this enables a much lower current leakage due to Coulomb barriers built in floating gate between two dielectric layers in structure.

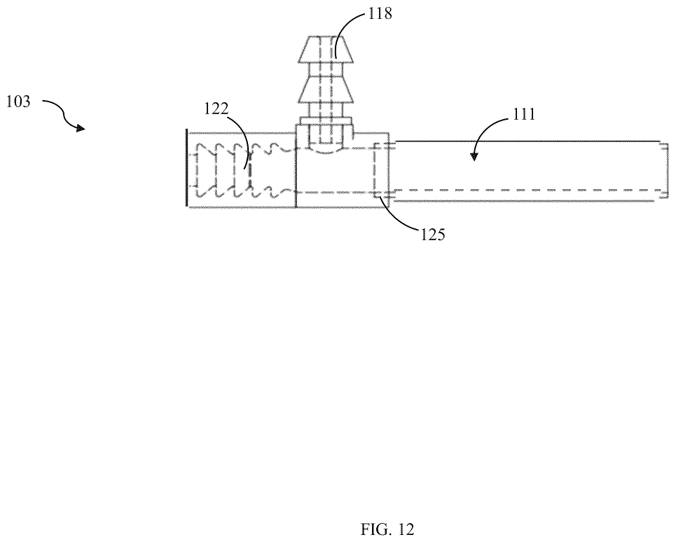

FIG. 8 depicts a block diagram of long duration quantum capacitance energy storage in accordance with some embodiments. Laser driven quantum plasma capacitor energy storage as disclosed herein uses the Fowler-Nordheim tunneling characteristics. Fowler-Nordheim tunneling is the wave-mechanical tunneling of photons electrons through barrier created at the surface of an electron conductor by applying a very high electric field. Individual electrons may escape by Fowler-Nordheim tunneling from many materials in various different circumstances.

The system of the present disclosure is different from a typical digital quantum battery mechanism. For example, the system of the present disclosure includes the isolation sides, photon-electron emissions, laser driven electron waveguide, two different axes of plasma flows, timescale switching control, and the high voltage injector electrode. The time events for the tunneling electrons may be controlled by a switching system. The high tunneling current may need a high electric field, such as the high voltage control source. The time structure for controlling switching for the injector electrode and the anode plate provide the highest electron tunneling probability. The injector electrode emits a plurality of electrons under laser waveguide control condition. The cathode plate traps all of the electrons, where the control gate plate creates a strong electric field for controlling the tunneling flows, but stays at capacitive connected to two different capacitance plate circuits.

Capacitance Charge

The vacuum quantum plasma capacitor inductance circuit limits the charging and discharging rates of a vacuum quantum capacitor circuit, which may require higher voltage to reach higher energy densities. The gravimetric capacitance in nanometer scale may be given by:

$$( Equation 6 )$$

$$C = \frac{2 ( \frac{{ε}_{0}}{2 {E}_{a}^{2}} )}{Δ V} \to C = \frac{Q}{Δ V} = \frac{Q}{V} \to I = C * \frac{d V}{d C} \to Q = {C}_{c} ( {V}_{GC} + {V}_{A} )$$

### Where:

Eₐ is the magnitude of the electric field at the surface of the anode plate;
∈₀ is the electric permittivity of vacuum;
ΔV is the potential difference between the electrodes or plates;
C_{c} is the cathode gate capacitance between the cathode and anode plate/tube;
V_{GC} is high voltage gate control; and
V_{A} is the anode voltage between the cathode plate and the anode plate.

For microscale, the gravimetric capacitance may be in the range of hundreds Farads. For nanometer scale, the gravimetric capacitance may be the range of few thousands Farads. The current flow from the cathode to the anode plate may be given by:

$${I}_{FN} = {C}_{c} * \frac{d ( {V}_{GC} + {V}_{A} )}{dt} \qquad ( Equation 7 )$$

Thus, the capacitance charge may be given by equation 8 below, which provides the ability for a large amount of energy storage, at a fast speed, and long, durable energy storage with little to no current leakage.

$$Q = N * [ {C}_{c} * ( {V}_{GC} + {V}_{A} ) \qquad ( Equation 8 )$$

Voltage Gate Control

The purpose of the voltage gate control is to create a high electric field between the cathode gate plate and anode plate. Again, the purpose of using high electric field is to help to pull up free electrons out of the surface and the potential barriers of the anode plate. Controlling the strength of the electric field depends on the amount of kinetic energy feeding from the injector anode and laser waveguide from the electron dielectric barriers device. The higher kinetic energy toward the anode plate, the lower applied electric field is used. Conversely, the lower kinetic energy toward the anode plate, the higher applied electric field is used.

Timescale Control

Energy and power have a direct relationship with one another and may be given as:

$$E = \int P d t \qquad ( Equation 9 )$$

The input plasma power via laser waveguide may be controlled by the pulse rate and the pulse width of the laser. The energy content of a laser waveguide transmission may be determined because the laser waveguide transmitter operates pulse control continuously. However, pulsed waveguide transmitters are switched on and off to provide range timing information with each pulse. The resulting waveform for a transmitter may be seen in FIG. 8. Also, the electron dielectric barriers switching control system may be used. The monitor and feedback control system may be done using intelligence processor via programming. Maximum range is directly related to transmitter output power. The more energy the laser waveguide system transmits to target areas, the greater the range of target detection of the electron-photon emissions will be. The energy content of the pulse is equal to the pulse peak (or maximum) power level of the pulse multiplied by the pulse width. However, combined laser waveguide and anode injector gives the power in an electron-photon emissions system over a period of time that is longer than the pulse width. For this reason, pulse-repetition time is included in the power calculations for laser electrons-photons waveguide transmitters. Power measured over such a period of time is referred to as average power.

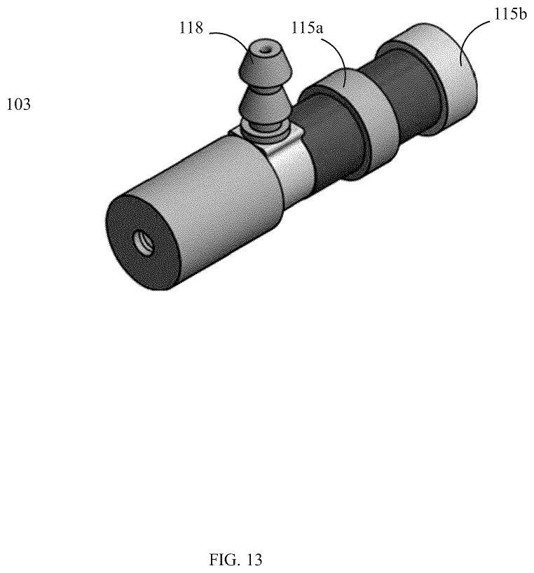

FIG. 9 depicts a pulse content diagram in accordance with some embodiments. FIG. 9 helps illustrate the way this average power would be shown as the total energy content of the laser waveguide pulse. The shaded area represents the total energy content of the pulse, the cross hatched area represents average power and is equal to peak power spread out over the pulse repetition time that no energy is actually present between pulses in a pulsed laser waveguide system. FIG. 9 also helps show how average power is calculated. Pulse-repetition time is used to help average power because it defines the total time from the beginning of one pulse to the beginning of the next pulse. Average power may be given as:

$${P}_{avg} = {P}_{peak} \times {p}_{w} / {p}_{rpt} = {P}_{peak} \times duty cycle \qquad ( Equation 10 )$$

### Where:

P_{avg} is the power average;
Pₚₑₐₖ is the power peak;
p_{w} is the pulse width; and
pᵣₚₜ is pulse repetition time, and 1/prt (1/time=pulse frequency) is equal to pulse repetition frequency (prf)).

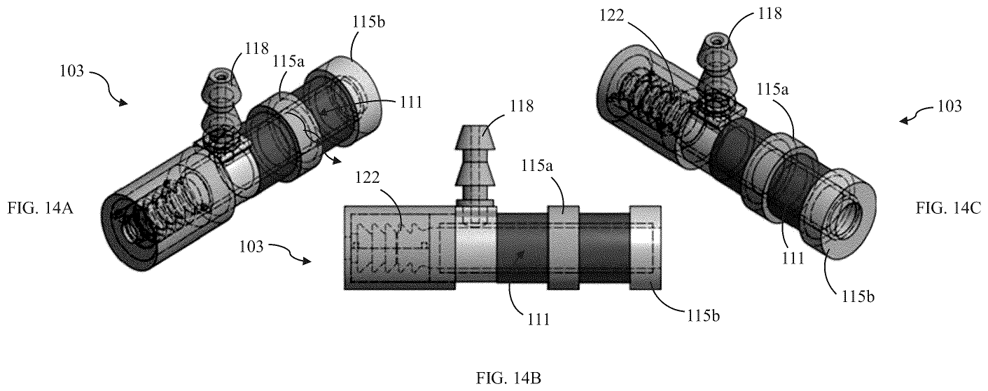

FIG. 10 depicts a pulse duty cycle in accordance with some embodiments. The product of the pulse width (pw) and the pulse-repetition frequency (prf) is called the duty cycle of a laser waveguide system. The duty cycle is a ratio of the time on to the time off of the laser waveguide transmitter, as illustrated in FIG. 10. The duty cycle is used to calculate both the peak power and average power of a laser waveguide system. The equation for duty cycle is given by:

$$duty cycle = {p}_{w} / {p}_{rpt} \qquad ( Equation 11 )$$

The duty cycle refers to the ratio of time a signal is “on” (active) to the total time of one complete cycle. It is associated with Pulse Width Modulation (PWM) signals. By adjusting the duty cycle of a PWM signal, you may control the average power delivered to a load. This allows precise control of parameters like brightness, speed, material barriers, or amplitude, depending on the application. When the duty cycle increases, the average output (voltage or current) also increases. Conversely, decreasing the duty cycle reduces the average output.

The intensity of electron-photon emission field via plasma current flow depends on the duty cycle. The plasma current density flow depends on the amount of high voltage levels providing sources via the control system. All these are monitored, utilize feedback, and are controlled by one or more intelligence processors for one or more computing devices.

High Voltage Isolation Sides

High isolation side is the area between the laser beam and the anode injection electrodes separately. The pulse rate and duration rate of the pulse using pulse repetition time control determines the amount of energy flush directed toward the target area for safety and protection.

Power Beaming Energy Storage Network

According to the present disclosure, the systems and methods for a power beaming energy storage network build on disclosure of U.S. Pat. Nos. 10,740,540 and 11,310,900 already incorporated by reference herein in its entirety.

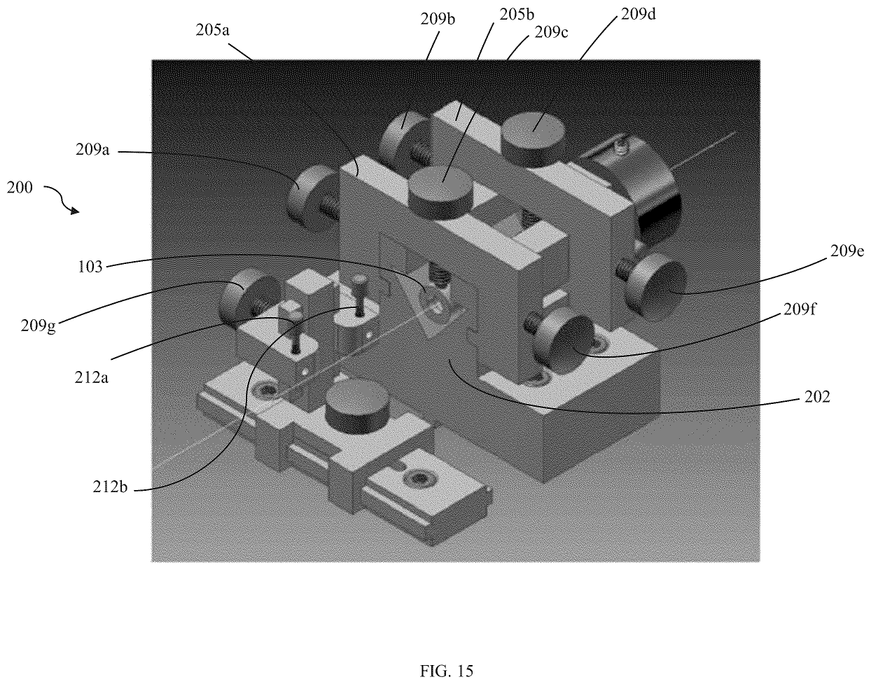

FIG. 11 depicts a laser driven electron beam plasma stepped leader power transmission grid 100 in accordance with some embodiments. The wireless power transmission grid 100 may include one or more reactor tube devices 103a-b that are configured to transmit a laser driven electron beam plasma stepped leader 106. In some embodiments, the reactor tube devices 103a-b may be coupled to a support 109a-b, which may be spaced apart from the ground. The power beaming energy storage systems and methods of the present disclosure provide greater distance power transmission and longer duration of energy storage in support of a wireless power transmission grid as depicted in FIG. 11. The wireless power transmission grid 100 of the present disclosure, called a power beaming energy network, may provide energy transportation and storage to any location of power loads.

The systems and methods disclosed herein eliminate energy transform loss issues and provides a more efficient way to store its entire power beams into long duration energy storage. As an example, this is similar to the fiber optic communication lines set up. Each fiber optic grid needs its own power source box, such as battery or external power line to keep laser working for communication signals working along the longer path of fiber optic pipes. But the big difference for this system is to flush and collect all the energy beam transmissions into long duration storage, which act as capacitor banks instead of heat loss or power dissipation as heat sink.

In some embodiments, the power beaming energy storage network uses a high voltage dielectric barrier discharge (DBD) reactor tube device (e.g., reactor tube devices 103a-b) that provides laser-electron beam waveguide with plasma stepped leader along greater distance and long duration plasma capacitor energy storage devices. The utilization of the laser driven electron beam 106 and plasma stepped leader are new innovative technologies that enable the transfer of high energy, facilitating power transfer to any power grid without wiring as depicted in FIG. 11. The power beaming energy storage network, or wireless power transmission grid 100 is not limited to communication systems. The systems and methods disclosed herein may be applied for wireless power grids, aerospace applications, space applications, the medical field, communications, manufacture machining, and even for atmosphere electricity extraction or lightening harvest for clean energy solutions.

The systems and methods disclosed herein extract and collect all the trapped electrons charges using the evolution of beam current distribution by laser beam propagation. The systems and methods utilize ionization injection from gas flow through the high voltage dielectric barriers charge reactor tube device (e.g., through wireless power transmission), facilitated by a time control system, and creates a conductor path without wiring. In some embodiments, the systems and methods disclosed herein include high voltage dielectric barriers discharge reactor tube (e.g., reactor tube device 103a-b), a laser driven module for use during the operation of the input laser beam propagation, along with corrected parameters of the plasma density, the injected beam charge, and the effect on the final electron beam energy and energy spread. Using the qualitative relationship between the input laser-plasma parameters and output beam parameter provides the excited guidance for future clean energy solutions.

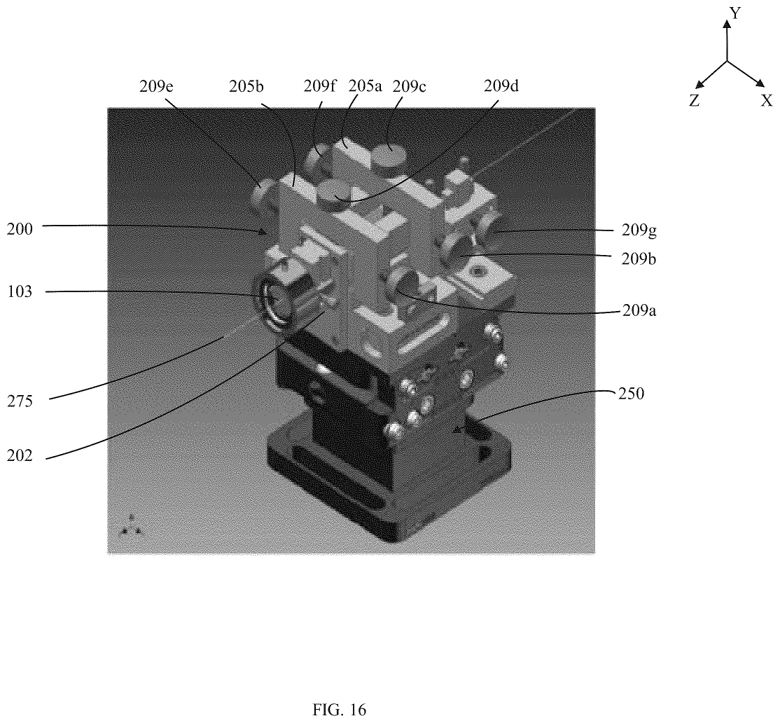

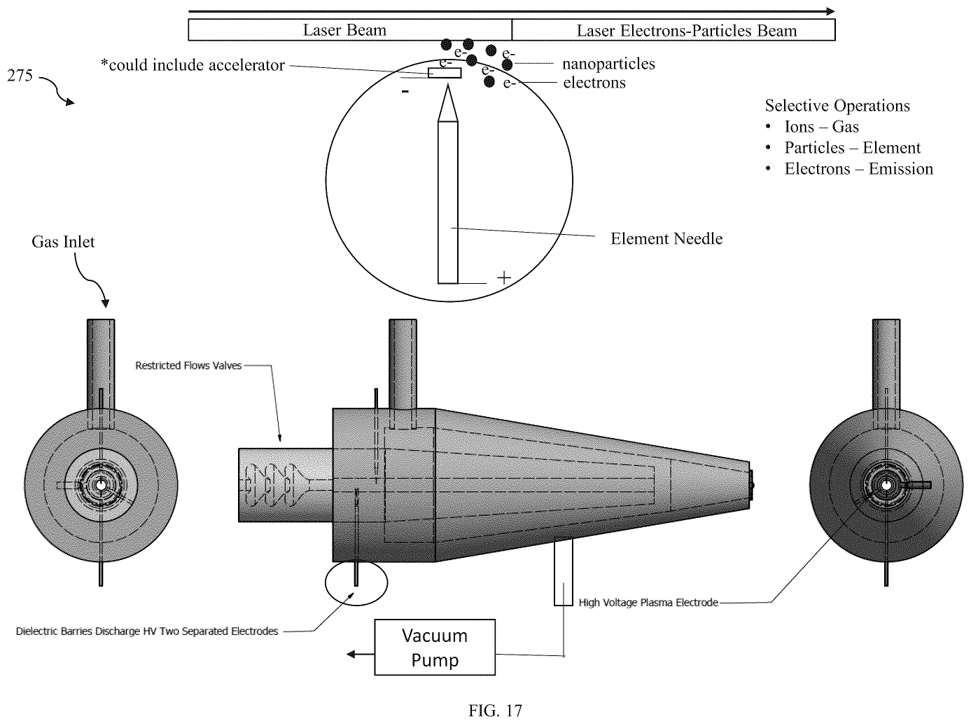

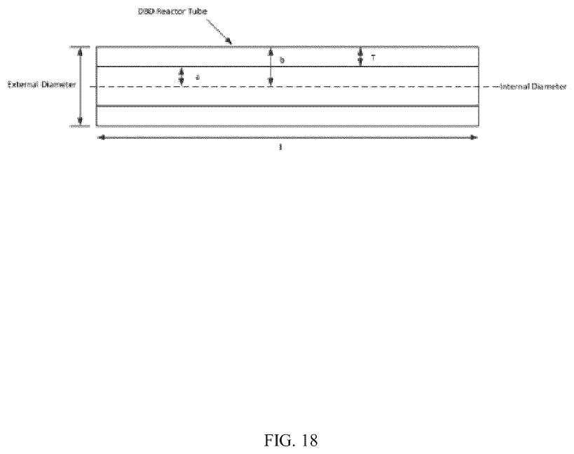

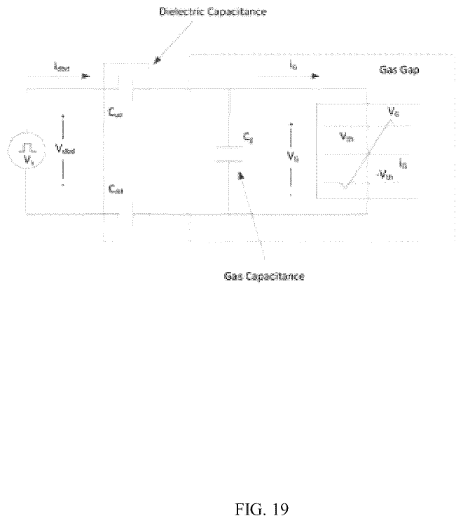

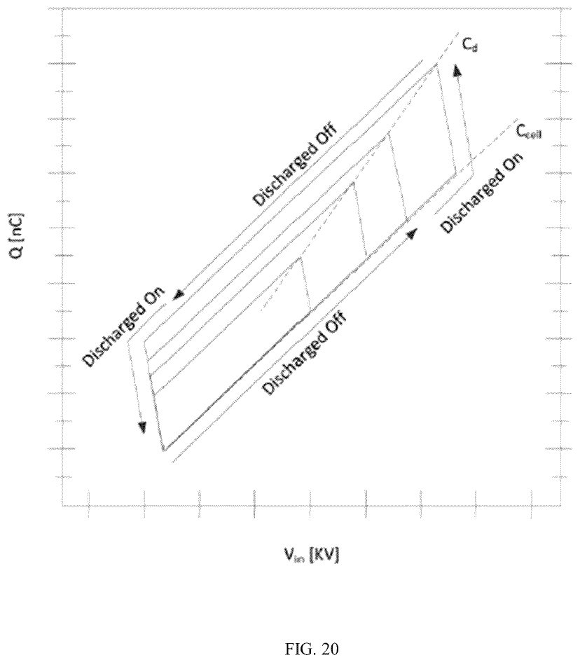

FIGS. 12-14C depicts a high voltage dielectric barrier charge reactor tube 103 in accordance with some embodiments. The reactor tube 130 includes an insulated gas cell 111 between two electrode rings 115a-b, a gas feeding barter 118, and optionally one or more restricted flow valves 122 and an optional window disk 125. As will discussed herein, the reactor tube 103 uses dielectric barriers to deal with thermal shock or heat transfer during a transient. In some embodiments, the materials for the dielectric barriers may include a glass material (e.g., fused silicon, quartz, etc.) or a ceramic material (e.g., Shapal type 30).

The reactor tube 103 is a gas cell device fed by a gas resource, either in gas pumping device or a pressure tank source, and electronically fed by the HV power supply with either timing pulse or any waveform signal (e.g., sinusoidal, ramp step, triangle, pulse) controlled circuit.

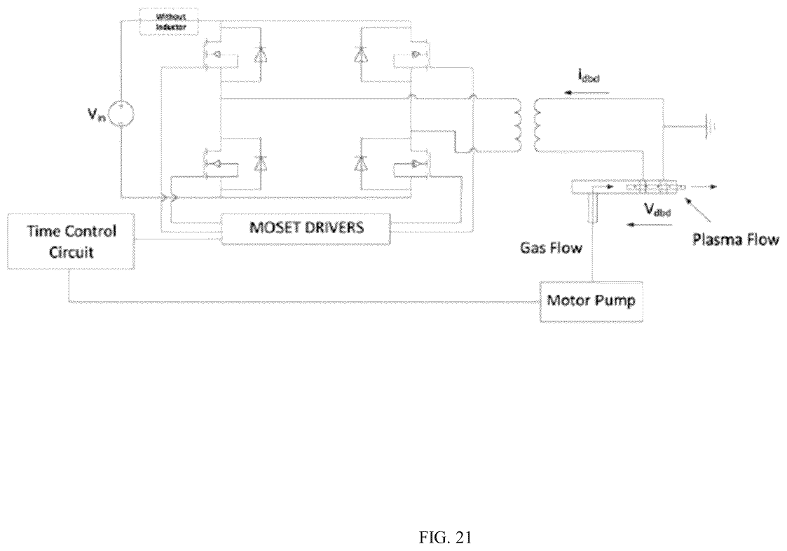

FIG. 15 depicts a reactor tube support 200. The reactor tube support includes a rest 202, one or more restraints 205a-b, one or more adjustment devices 209a-f, and one or more plasma electrodes for testing 212a-b. The reactor tube support 200 firmly supports the reactor tube 103 and locks the reactor tube 103 in place. For example, the reactor tube support 200 is configured to receive the reactor tube 103 on the rest 202. the reactor tube is then locked in place with the one or more restraints 205a-b The one or more restraints 205a-b each have one or more holes disposed therein that are configured to receive the one or more adjustment devices 209a-f, which are used to adjust and secure the tube device 103. In some embodiments, the one or more adjustment devices 209a-g may include a knob coupled to a threaded set screw as illustrated in FIG. 15.

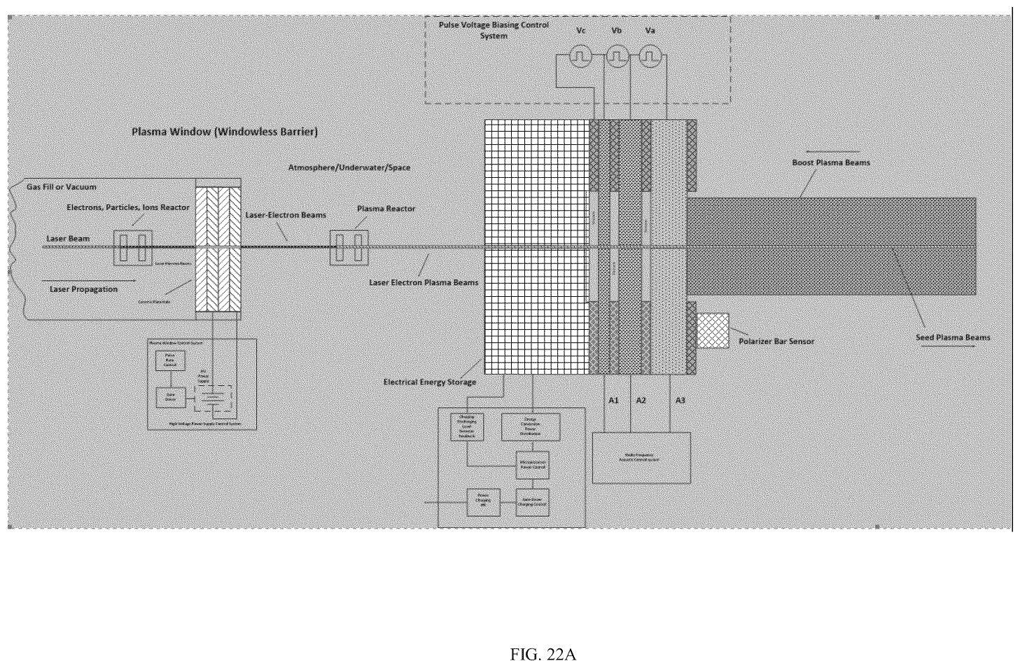

FIG. 16 depicts a reactor tube support 200 and base 250 in accordance with some embodiments. The reactor tube support 200 may also be mounted to a base 250 as illustrated in FIG. 16. In some embodiments, the base 250 is configured to be adjusted manually, such as with adjustment device 209a-g, or automatically with a robotic arm or computing device. For example, the reactor tube 103 may be configured to be adjusted in the x-axis, y-axis, and z-axis in order to adjust the propagation line 255 from the reactor tube 103. The base 250 may also be configured to adjust the reactor tube 103 in the yaw and pitch directions in order to adjust the propagation line 255 from the reactor tube 103.

In some embodiments, the system may include a plasma tester device that includes two small bare wires connecting to tester base support device. These bare wires are connected to a high voltage power supply. The purpose of using the plasma tester device is to check the path of plasma flow (e.g., the propagation line 255), which should be flow in straight line - not zag-zag behavior. This means that there is electron beam flowing along the laser beam propagation 255 for confirmation. Again, using scintillation detector with a fiber optic collimator using a spectrometer device, connected to computing device, may determine the amount of the electron beam distribution hitting the target or the concentration of electron bunches flowing.

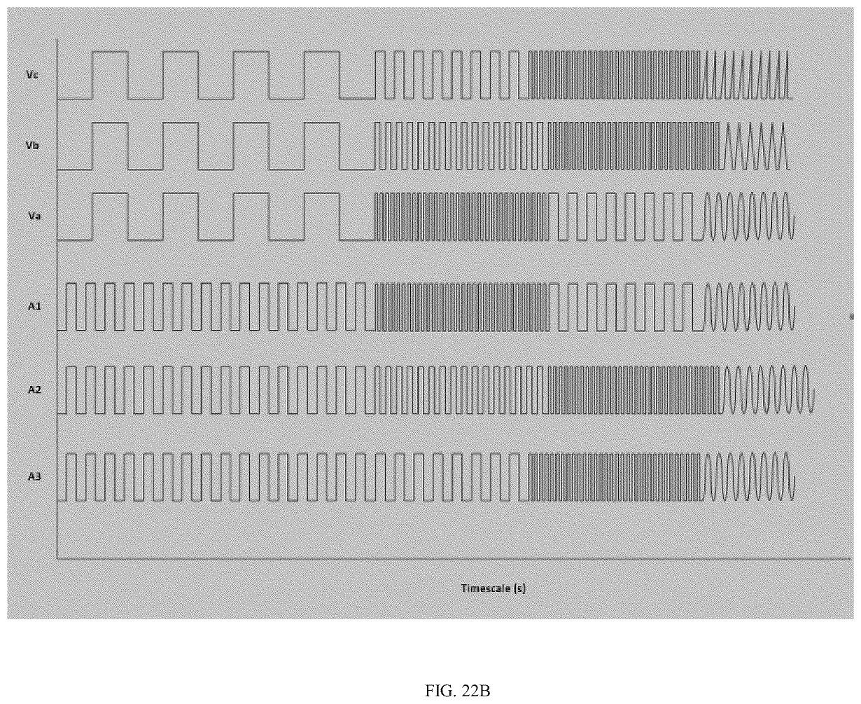

FIG. 17 depicts a second embodiment of a reactor tube 275. In some embodiments, reactor tube 275 improves smooth gas flow and deals with impulse electron discharge quickly. In some embodiments, the reactor tube 275 includes electrodes for plasma filament flows. The electrodes are disposed either inside the reactor tube 275 or at the end of the output of the reactor tube 275.

The pulse timing of the high voltage (HV) power supply is facilitated by wiring connected to two conductive (e.g., copper) rings. The gas (e.g., air) feeding pump uses small insulated tube (e.g., rubber or plastic) connected to the gas tube barter 218 of the reactor tube 103.

The power using I_{dbd} and V_{dbd} waveform may be controlled by one or more of the following three methods: (1) duty cycle (D); (2) current density (J); and (3) frequency (f) of the voltage and current pulses. The power supply for the system may include a full bridge inverter circuit with MOSFET driven, gate driver, and time controlled circuits (either using function generator circuit or external generator circuit). These circuits may be connected with a step-up transformer connected to the reactor tube 103, 275.

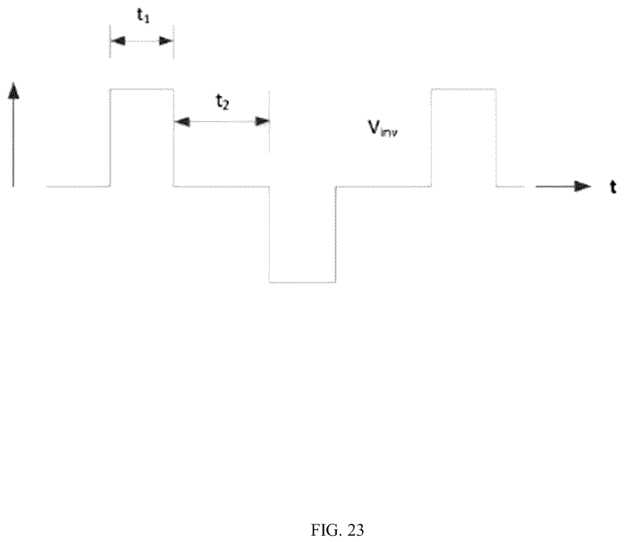

FIG. 18 depicts a cross-sectional view of a reactor tube (e.g., reactor tube 103, 275). The dimensions of the reactor tube include: (1) the dielectric thickness (T); (2) the internal radius (a): the external radius (b); and (4) the length of the reactor tube (1). It will be appreciated that the dielectric thickness and clearance (or gas gap) of the reactor tube may be any thickness or size. It will also be appreciated that the gas in the reactor tube may be any suitable gas, such as air, nitrogen, etc. The geometrical parameters of the reactor tube (e.g., T, a, b, and I) may be categorized as plasma flows.

The cylindrical capacitance of the reactor tube may be given by the following equations, where Cj is the dielectric series equivalenm capacitance, Cg is the gas equivalent capacitance, and V is the gas breakdown voltage:

$${C}_{g} = \frac{2 π \cdot {ε}_{g} \cdot l}{{l}_{n} ( \frac{b}{n} )} \approx y \frac{l}{ln ( \frac{b}{a} )} \qquad ( Equation 12 )$$

$${C}_{d} = z \cdot l \cdot \frac{1}{ln ( \frac{{T}^{2} + a \cdot T + b \cdot T + a \cdot b}{a \cdot b} )} \qquad ( Equation 13 )$$

$${V}_{th} = \frac{C \cdot {p}_{gas} \cdot d}{ln ( \frac{A \cdot {p}_{gas} \cdot d}{ln ( 1 + \frac{1}{y} )} )} \approx X \frac{d}{ln ( d )} \qquad ( Equation 14 )$$

### Where:

α is the internal radius of the tube;
b is the external radius of the tube;
I is the length of the tube;
T is the dielectric thickness;
A is a constant that depends on electron kinetic temperature;
C is related to A and to the effective ionization potential;
P_{gas} is the pressure of the gas; d is the distance of the dielectrics;
γ is the electron emission coefficient; and
X, Y, and Z are constants derived from the measurement of the tube with the same material for wall, gas mixture, and pressure.

The amplitude values of the reactor tube may be given by:

$$J = \frac{P}{D \cdot {V}_{th}} + f \frac{4 \cdot {C}_{g} \cdot {V}_{th}}{D} \qquad ( Equation 15 )$$

$${\hat{V}}_{th} = {V}_{th} + \frac{J \cdot D}{4 \cdot f \cdot {C}_{d}} \qquad ( Equation 16 )$$

### Where:

P is the desired average power electric power of the reactor tube;
D, J, and f are controlled by the idbd current shape by the current inverter (f,D) and the current source (J*N, N being the turn ratio of the transformer) with the converter circuit control system.

In some embodiments, the reactor tube may use two conductive electrode ring arrangements for generating cool plasma flow, building up the electron charge region, and several modes of working gas excitation. This design also uses the safest configuration to prevent discharges between the high voltage electrodes and the insulated surfaces. The reactor tube device may also include an electrode converter system using two dielectric barriers spacers, two metal rings, and a gas input barber as discussed above. The spacer, electrodes, and barter tube are placed on a safe insulating ceramic tube and support base. In some embodiments, the main component parts of the reactor tube use Shapol Type SH-30 materials and are not limited to glass materials. The metallic electrodes rings may use copper tube or bended curve plate materials. The reactor tube may uses a small air flow pumping motor, a dry air filter, and plastic/rubber tube. The purpose of the air pump is to cool gas flow and also to replenish gas ionization/excitation during the operation of buildup charge recycle and high voltage pulse control timing.

Using the pulse rate control circuit with a high voltage power supply connecting to two conductive electrodes rings creates a plasma flow inside a high temperature and insulated tube. The plasma/gas flow carries ionized particles out of the electrode tube system of the reactor tube device. This method forms a small plasma jet using subsequent voltage pulses that produces additional current channels including those directed toward the target. The purpose of the excited species in the gas flow is to scoop and carry electron charges output from the electrodes region toward the outlet of the reactor tube. This may be done with suitable laser beam propagation and timing systems as disclosed herein.

The input gas flow may be used to determine that plasma is fully controlled at lowest flow rate. Any gas or mixture gas may be selected as input gas depends on the relatively ignition voltage application and safety requirements. A proper power supply will be used with the timing pulse control circuits for controlling the plasma and gas flows in line with the electrical characteristics of the reactor tube. In some embodiments, the reactor tube equivalent circuit, which may be somewhat similar to a dielectric barrier discharge lamp using gas fully contained between the electrodes.

Understanding the voltage-charge behavior model with gas flow control will help determine which pulse rate generator should be tuned up in timing correctly for the system, such as the pulse circuit for high voltage power supply, air flow rate using motor pump, and the timing of laser beam propagation. The laser beam propagation may be operated either in continuity or pulse control.

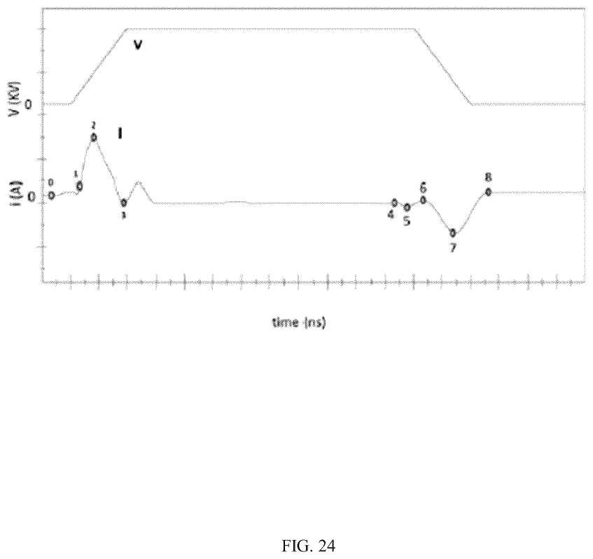

FIG. 19 depicts a dielectric barrier discharge equivalent circuit using two electrode rings in accordance with some embodiments. As illustrated in FIG. 19, a dielectric barrier discharge electrical model depicted in may use two conductive electrodes rings connected to reactor tube. Recall that the capacitance (C) is also equal to the ratio of charge it holds (Q or q) to the voltage across it (V). Also, this relation may be given as:

$$C = \frac{Q}{V} \to q = CV \qquad ( Equation 17 )$$

$$I = C \frac{dV}{dt} \qquad ( Equation 18 )$$

$$Q = {\int }_{O}^{T} l ( t ) dt \qquad ( Equation 19 )$$

Equations 17-19 above are used to determine the energy transferred to the plasma flow under both charged and discharge cycle following the voltage pulse rate into two conductive electrodes rings of the reactor tube device, which in some embodiments may be ceramic. Equations 17-19 may also be applied with the laser propagation beam combined with electron beam (-e) waveform equation entering the charge region of the reactor tube device.

Given C_{ud} and C_{dd} is the combination as in series C_{d} and C_{eq}=C_{cell}, the equation may be given as:

$${C}_{d} = \frac{{c}_{ud} {c}_{dd}}{{c}_{ud} + {c}_{dd}} \to {C}_{eq} = {C}_{cell} = \frac{{c}_{d} {c}_{g}}{{c}_{d} + {c}_{g}} \qquad ( Equation 20 )$$

This electrical model may be used for a determination of dielectric barrier discharge parameters and power according to some embodiments. The reactor tube may be operating in an off state when the voltage applied across the electrodes is too low to ignite an electric discharge in the gas. In this state, the reactor tube may be composed of capacitors connected in series. This derived network equation 20 following the dielectric barrier discharge equivalent circuit shows that the capacitance values, C_{ud}and C_{dd}, are the equivalent capacitance values of the dielectric barriers sections in contact with the upstream and downstream electrode rings, respectively.

The capacitance C_{d} showed in equation 20 simplifies the series connection between C_{ud} and C_{dd}. Since the gas conductance in this state is very low, the gas may be modeled by the equivalent capacitance of the discharged gap, C_{g}. In the off state, the dielectric barrier discharge behaves as the series C_{eq} combination of C_{d} and C_{g} shown in equation 20. In this state, the dielectric barrier discharge model is also good for the plasma flow.

The electric discharge inside the reactor tube is produced by applied high DBD voltage. The gas becomes ionized during the “on” state when the applied DBD voltage creates the gas voltage, V_{g}, inside the tube. This exceeds the Vₜₕ, gas breakdown threshold. The DBD equivalent circuit in the “on” state includes the C_{d} dielectric capacitance in series with the gas conductance (G). Following the gas conductance characteristics, the gas voltage remains almost constant after the electric breakdown. The DBD mode in the “on” state uses a series connection of the capacitance, C_{d}, and a constant voltage source of the +/−Vₜₕ value. This dark state condition (already built up charge regions) allow the air pump to stop, hold, and wait for the next step of laser beam fire and run propagation at greater distance. This timing step helps to minimize the turbulence energy, lower temperature, and reduces the index refraction. The laser beam propagation will then trap and collect bunches of electrons (-e) and travel with the laser beam propagation a greater distance. This is the start of electron beam along the laser beam propagation path.

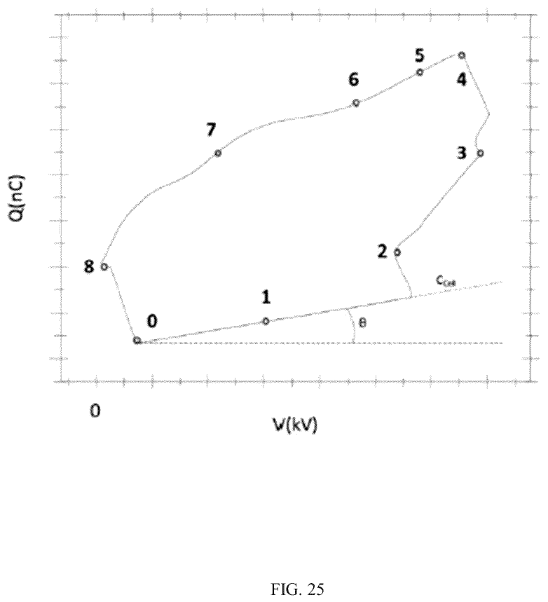

FIG. 20 depicts an exemplary Q-V Lissajous diagram in accordance with some embodiments. Using the Q-V Lissajous diagram shown in FIG. 20, the capacitance may be determined using any geometric shape design of the reactor tube device. These geometric shapes for the reactor tube may depend on the capacitance factors results obtained from the voltage across the reactor tube, V_{dbd}, with the electric charge, Q_{dbd} during time period (T), the operation cycle of the supply such as adjusting the gas flow rate, voltage, current, frequency, pulse rate, and duty cycle of the control systems. These factors may determine the energy transferred to the plasma flow under both charged and discharged cycle following the voltage pulse rate into two conductive electrodes rings of the reactor tube device.

The electric charge, Q_{dbd}, is given as the integral of the DBD current, I_{dbd}, which may be given as:

$${Q}_{dbd} = {\int }_{O}^{T} {l}_{dbd} ( t ) dt \qquad ( Equation 21 )$$

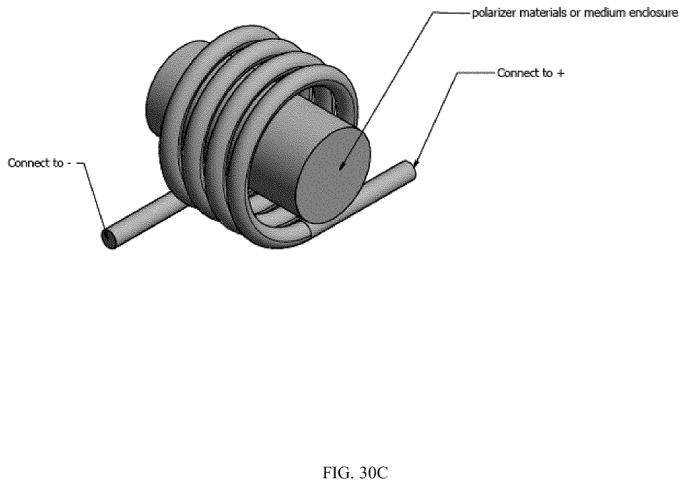

FIGS. 20 and 26 (discussed below) form a parallelogram model that may also be explained as the plasma reactor operating at power (W), frequency with pulse rate control (using duty cycle, DC=t/T x 100%, where t is the pulse width and T is time period of the pulse), voltage input (Vᵢₙ), and gas flow (L/min). The upper and lower segments are shown when the reactor tube operates in the “off” state, and the slope is related to the equivalent DBD C_{eq} capacitance in this state may be given by:

$${C}_{eq} = {C}_{cell} = \frac{{c}_{g} \times {c}_{d}}{{c}_{g} + {c}_{d}} = \frac{{dQ}_{dbd}}{{dV}_{dbd}} OFF state \qquad ( Equation 22 )$$

The right and left segments of the parallelogram diagram shown in FIG. 20 are conversely acquired when the plasma is ignited during the “on” state. The slope of these segments determines the dielectric capacitance, C_{d}, shown in FIG. 20. It will be appreciated that FIG. 20 is just one exemplary diagram and that other parallelogram diagrams are possible due to different range of experiment voltage adjusting input. The left and right segments of the plasma flow figure are neither straight nor smooth eclipse. Therefore, a linear approximation of the segment may be used to determine the dielectric capacitance, C_{d}, which may be given by:

$${C}_{d} = \frac{{dQ}_{dbd}}{{dV}_{dbd}} ON state \qquad ( Equation 23 )$$

The gas capacitance is given by knowing C_{d} and using C_{eq} calculated following the displacement equation. In some embodiments, when the discharge is not ignited, the reactor tube may behave as capacitor with a fixed value. However, in this case, total measured current may represent displacement current flowing through the reactor tube. The relation between measured current i(t) and voltage V(t) may be given as:

$$i ( t ) = {C}_{cell} \frac{dV ( t )}{dt} \qquad ( Equation 24 )$$

Using the comparison of the current measured by the current probe i(t) to current predicted by a time derivative of the voltage waveform C_{cell} dV(t)/dt, this equation is reveals two results, a skew in time between the two signals and an estimation of the C_{cell} value.

Dielectric Barrier Discharge Bipolar Power Supply

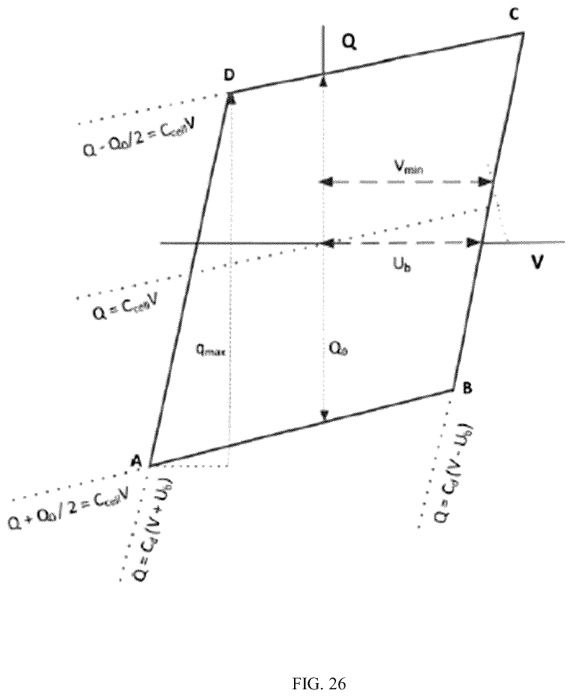

FIG. 21 depicts a bipolar short pulse (BSP) voltage supply circuit in accordance with some embodiments. The DBD bipolar power supply (BPS) may be used without adding an inductor connected to the voltage supply, which may also act as a current source, in order to control the plasma flow tube device. Also, this embodiment includes a pulse air motor pump used to control the right volume rate flow into the DBD reactor tube device, as depicted in FIG. 21. If an inductor is added in this DBD circuit, a so-called series resonant inverter current supply, plasma flow temperature will increase.

The DBD power supply may include a voltage inverter, which controls its switching legs to apply short bipolar voltage pulses across the primary winding of a step-up transformer. The secondary winding is connected to the conductive electrodes of the plasma reactor tube. The waveform is fully controllable. The following settings and parameters to achieve the controllable waveform are merely exemplary and should not be construed as limiting. The magnitude of the positive and negative levels may be linearly adjusted using the Vᵢₙ voltage of the BSP controller power supply circuit. Exemplary settings and parameters for the controllable waveform include: (1) 0 to 100-300 V using an external power supply; (2) pulse duration, t₁, in the range of 0.75 to 1.5 μs or smaller (e.g., nano seconds) depending on the type of gas provided; (3) the varied frequency for pulse with a range of 5 to 20 KHz or higher depending on the strength of materials (permittivity or dielectric strength), considering the limitations of the step-up transformer (reactance); and (4) a transformer with a turns ratio of 1:10. The waveform of the Vᵢₙᵥ is applied to the primary winding of the transformer, which could leak possible parasitic elements into the PCB and circuit. Also, there may be a leakage inductance, forming a resonant circuit with capacitive characteristics of the plasma flow reactor tube. The resonant behaviors of the DBD board circuit are responsible for the damped oscillation, facilitated by the PCB design layout, high performance MOSFET driver parts, gate driver, and precision pulse timing circuit.

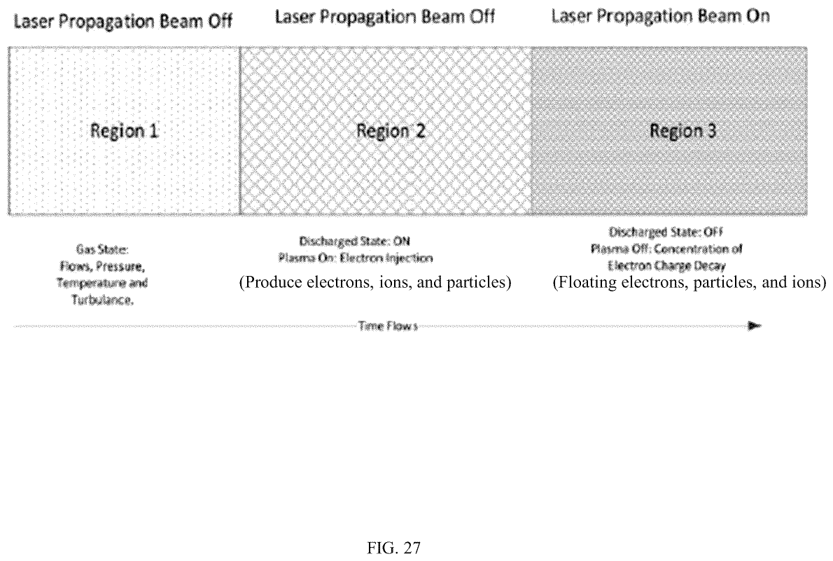

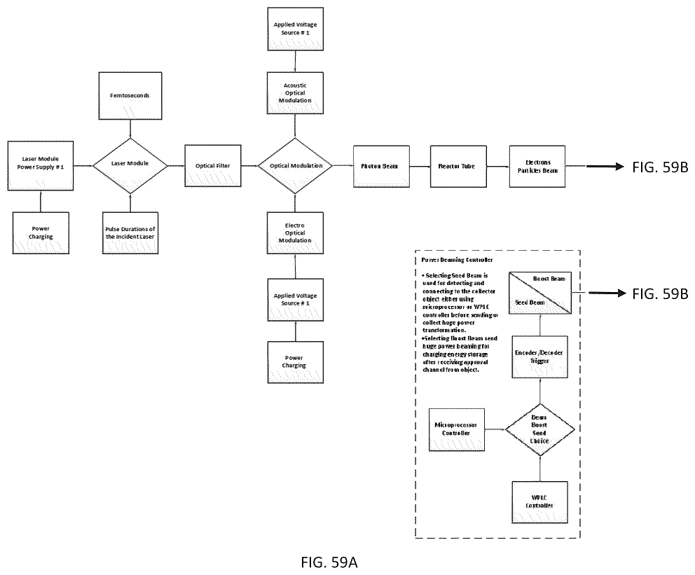

FIGS. 22A-22B depict a ultrafast barrier energy conversion model with pulse shape control system in accordance with some embodiments. These pulse signals are used for signal inputs toward impulse circuit (see dot line of block diagram) connecting to plate's barriers of receiver device. The void space between plates may be used for gas filled, liquid, and vacuum. For an example, only impulse signal (impulse shape should be like triangle pulse trains) will able to let the electricity flows using pure distilled water inside void space (no impurities such as salts) where DC and AC signal cannot do that. See the diagram of impulse circuit with upside down of triangle pulse trains output (FIG. 53). This impulse signal may able to disturb the dielectric medium or barrier material. This complex timescale behavior is acting as the transition from an insulator to a conductor switching as well as the mechanism of the electrons flow absorption. These plate's barriers are also acting as filter (the mechanism of allowing the electrons shower flow absorption) and shockwave absorption. Also, there was acoustic (supersonic) controller connecting to plate barrier. The purpose of this acoustic controller system is to control thermal flow diffusion and allow electron bunches flowing into barrier plates of the receiver.

An ultraintense laser-driven polarized particle source possesses the advantages of high pondermotive force and accelerator, and compactness, which could open the way for the unexplored aspects in a range of power beaming researches. However, it is necessary to understand the polarization behavior via different medium even inside the chamber and optic lens.

The scattering cross sections inside reactor cell chamber depend on the spin and polarization of the particles, and the spin-dependent photon emission and the radiation-reaction effects in strong-field quantum electrodynamics (QED) processes may be utilized to produce the polarized particles.

Using the effects in strong-field QED processes, as well as the progress made in reactor cell chamber for production of the polarized particles by laser-beam or laser-plasma interactions. This is driven mainly by the rapid advancements in ultrashort and ultraintense laser technology.

Radiation may emit particles and electrons inside reactor cell chamber. In summary, radiation emits particles, electrons, and the types of particles emitted depend on the specific form of radiation producing in reactor cell chamber. These trapped these particles and electrons may be carried by laser waveguide beaming.

High-energy spin-polarized electron, positron, and 7-photon beams have also many significant high power beaming applications. A positron is antielectron that is the particle with an electric charge of +le, a spin of ½ (the same as the electron), and the same mass as an electron. A 7-photon is a form of ionizing radiation.

Currently available laser pulses may achieve peak intensities in the range of 10²² −10²³ Wcm-² with pulse durations of femtoseconds. The dynamics of particles in laser fields of the available intensities is dominated by quantum electrodynamics (QED) and the interaction mechanisms have reached regimes spanned by pondermotive force and accelerator conditions under nonlinear multiphoton absorption.

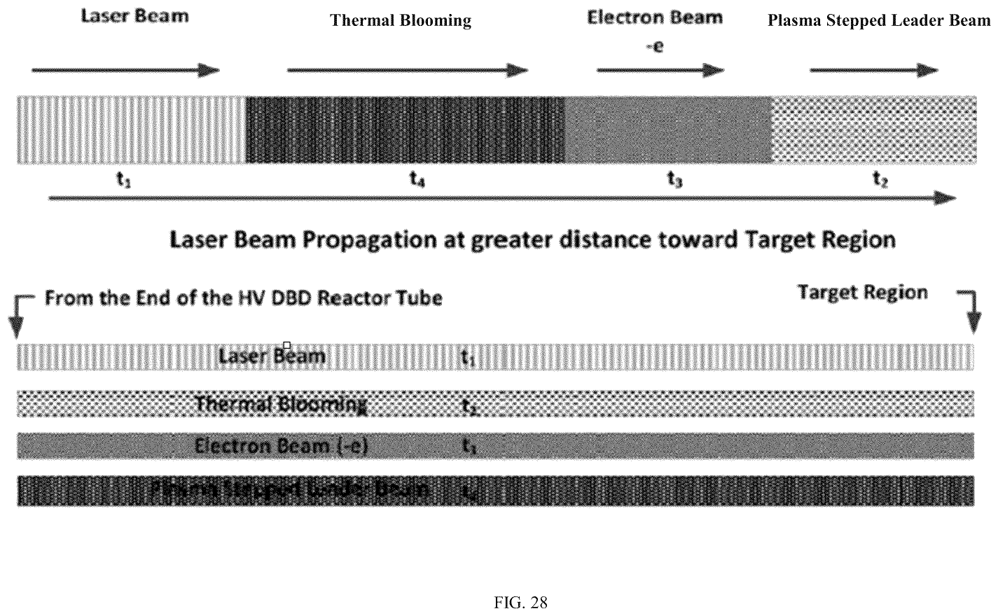

FIG. 23 depicts a waveform of an exemplary BSP circuit in accordance with some embodiments. The exemplary waveform using for BSP circuit shown in FIG. 23 may use the circuit depicted in FIG. 21, facilitated by a timing control circuit feeding to the MOSFET drivers circuit. The timing control circuit may be pulse controlled by adjusting the pulse rate, pulse duration, duty cycle, and time cycle of pulse signal. Also, the air flow rate may also be controlled with the BSP controller.

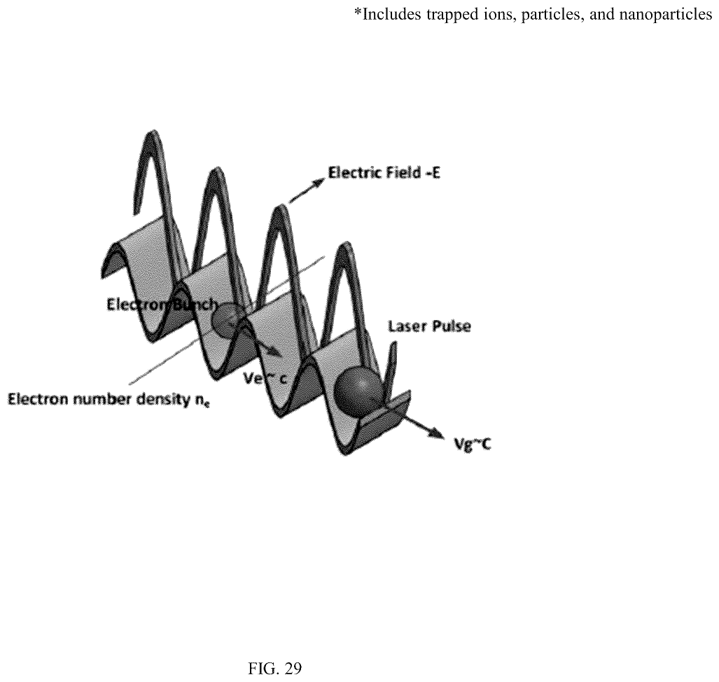

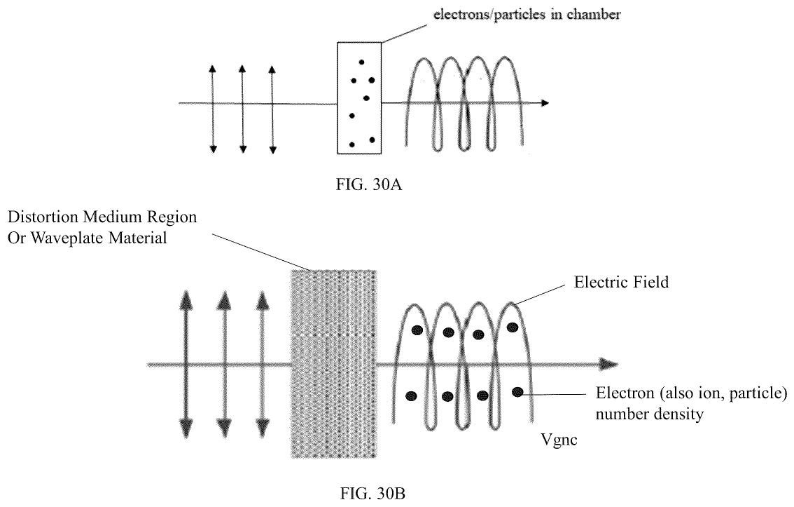

FIGS. 24 and 25 depict an exemplary discharge ignition of the reactor tube. For example, FIG. 24 depicts exemplary DBD reactor tube voltage and current pulses and FIG. 25 depicts exemplary DBD reactor tube voltage and current rates. In some embodiments, the high amplitude of the applied voltage may depend on gas breakdown. Using both FIGS. 24 and 25, the C_{cell} value may be determined using the tangent of the angle between the line and axis of abscissa, given as:

$${C}_{cell} = tan ( θ ) \qquad ( Equation 25 )$$

Where θ is the angle of the exemplary Q-V plotted graph depicted in FIG. 25.

The value of C_{d} may be determined using the Q-V plot of discharge shown in an example of FIG. 19. The Q-V plot may be excited by either the sinusoidal voltage shown in FIG. 25 or pulse voltage shown in FIG. 20.

FIG. 26 depicts a parallelogram of the Q-V plot in accordance with some embodiments. The AB and CD sides of parallelogram describes the “passive” or “dark part” state of the reactor tube. During this phase, there will be no charge transfer through the gas gap of tube. The capacitance of the reactor tube (C_{DBD}) is equivalent to C_{cell}. BC and DA sides of the parallelogram model describes the “active part state” where C_{DBD}=C_{d} and potential drop across the gas gap (U_{g}) is constant. U_{g} is equal to the voltage breakdown (Vₜₕ=U_{g}=U_{b}), which is found at voltage at zero charge intercept. The variation of the charge during the active phase state is equivalent to the maximum charge transferred through the gas gap (qₘₐₓ).

When the ignition occurs, there is a minimum external voltage larger than the gas cap voltage. This minimum voltage corresponded to the breakdown voltage and is given by:

$${V}_{min} = \frac{1}{1 \frac{{c}_{cell}}{{c}_{d}}} {U}_{b} \qquad ( Equation 26 )$$

The Q-V plot may also be described as analogous to:

$$Q ( t ) + Q ( 0 ) = {C}_{cell} [ V ( t ) + V ( 0 ) ] \qquad ( Equation 27 )$$

Where V(0) is a voltage at time zero.

The active discharge phase may be given as:

$$Q ( t ) \pm \frac{{Q}_{O}}{2} = {C}_{DBD} ( V ( t ) \pm {U}_{g} ) \qquad ( Equation 28 )$$

Where:
when C_{DBD}=C_{d}, U_{g}=U_{b}, and q₀=0 are in active discharge phase;
when C_{DBD}=C_{cell} and U_{g}=0 are in dark phase (not active); and
Q₀ is related to the charge transferred through the gas gap, qₘₐₓ, which is given by

$${q}_{max} = \frac{1}{1 \frac{{C}_{c e l l}}{{C}_{d}}} {Q}_{0} \qquad ( Equation 29 )$$

In some embodiments, the Q-V parallelogram model equations may be computed and/or estimated from the plot in FIG. 25.

The capacitor of the system shows the memory effect. This is also related to the recombination phenomena that do not allow the excited species to return their ground states. Using idle time interval between two consecutive pulses (using the timing controlled circuit) will determine the “power injection pause.” This is the result from the level of plasma recombination that takes place during the injection pause between the power pulses. The remaining medium region inside the reactor tube will be very conductive between the consecutive pulses and the electric field in the discharge gap will be weaker for subsequent pulses.

Conversely, a longer power injection pause will permit the recombination and restores the electrical properties of the discharge space. Also, the reactor tube uses the gas flow feeding, helping this recombination process as well. The next pulse will develop a nonconductive medium due to high electric field, which requires higher voltage levels than the previous case. The higher reduced electric field in the presence of the recombination process will give a significant redistribution of the discharge energy results. This will allow the excitation of the electric levels without significant heating in the reactor tube. Hence, using the BPS is a good choice for the expansion of plasma flow and the temperature rise to deal with the controlled index refractive effect during the operation of the laser beam propagation transmission.

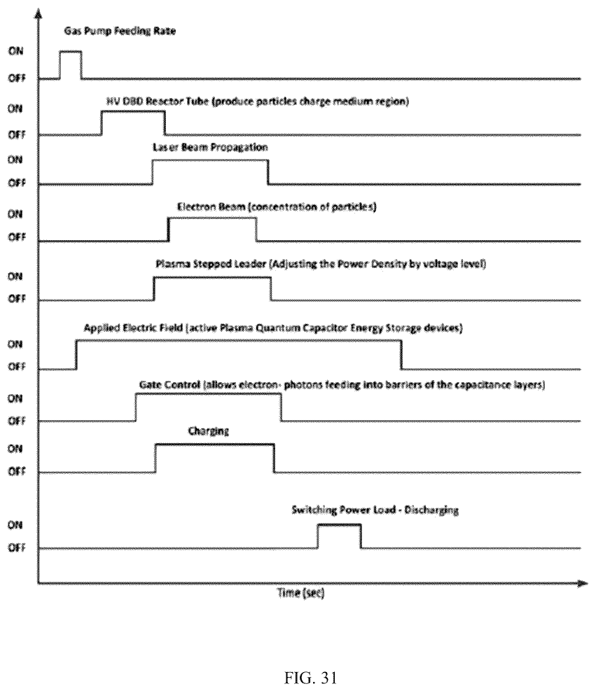

The Q-V parallelogram depicted in FIG. 26 may also be used to understand the behavior of the reactor tube under three different regions states, as depicted in FIG. 27, following the quantum mechanics model. The displacement current may be obtained from the Q-V model during the reactor tube operations, which may be transformed into wave form electron beam energy coupling with the non-linear Schrodinger equations for laser propagation beam. The purpose of using the non-linear Schrodinger equation is to deal with charge injection, the structure of index refractive, energy conversion transmission, and even the polarization outcome. Capacitance is a barrier using displacement current waveform that may be disrupted by the tunneling effects on the timing controlled circuit.

In quantum mechanics, the De Broglie hypothesis stated that matter is believed to behave both like a particle and a wave at the sub-microscopic level. Schrodinger's equations also stated that there is a duality wave and matter using Heisenberg uncertainty principle following the law of energy conversion (uses both potential and Kinetic energy) include the tunneling behavior. This is applied to the capacitance and displacement current following Maxwell and Schrodinger equations. Plank's constant, index refractive, polarization, particle distributions, and Boltzmann equations are also used. As for optical application, all these quantum mechanics will be used with a laser propagation beam, including electron beam phenomenon.

The Schrodinger equation is used to describe the behavior of quantum particles in a variety of situations, including tunneling through a potential barrier. The probability of a particle tunneling through the potential energy barrier is from the Schrodinger equation and may be given by:

$$P = {e}^{( \frac{- 4 a π}{h} \sqrt{2 m ( V - E )} )} with E < V \qquad ( Equation 30 )$$

### Where:

P is the probability of tunneling;
V is the height of the potential barrier;
E is the kinetic energy processed by the electron-particle
H is Planck's constant; and
a is the thickness of the barrier.

Thus, the probability of an electron-particle tunneling through a barrier, such as the capacitance (Q-V) model, decreases with the electron-particle's increasing mass and with the increasing gap between the energy of the object and the energy of the barrier. Although the wave function never quite reaches zero, this explains how tunneling happens frequently on nanoscale, but negligible at the macroscopic level.

Laser Driven Electron beam Propagation Path

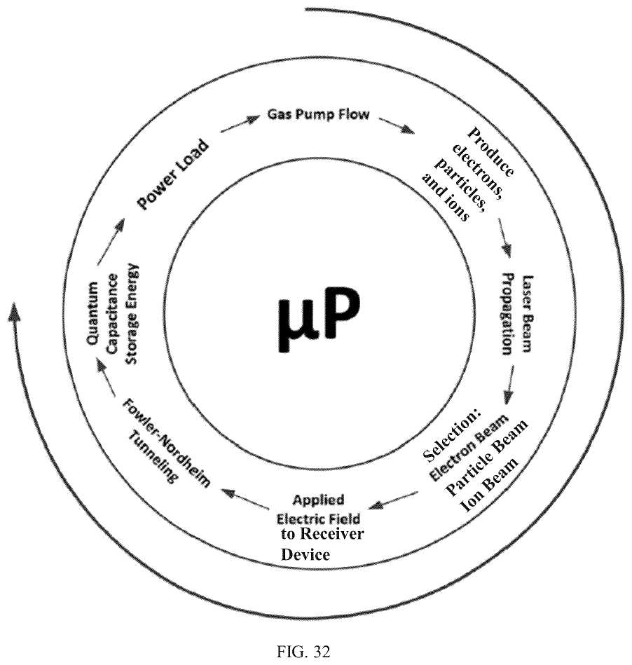

Regarding the laser beam propagation, there will be dynamic optical manipulation and transmission of light through scattering media of the reactor tube as well as formation of complex optical patterns and light filamentation from the exiting of the charge region toward the target region. Also, the reactor tube will provide all four different stages of beam propagation at greater distance toward target region. For example, as depicted in FIG. 28, the laser beam propagation may initially be the laser beam, then a plasma stepped leader beam, then an electron beam, then thermal blooming as the laser beam propagation gets closer to the target region. In some embodiments, the laser used in the systems disclosed herein may use a Thorlabs laser module (part number, AQWPOSM-580-01/2” Mounted Achromatic Quarter-Wave Plate, 01” Mount, 350-850 nm) or a PL-350 linear beam module (using air convection) without achromatic quarter wave plate. However, it will be appreciated that other lasers are possible.

There may be several different region boundaries during the operation of the reactor tube. First, an optical vortex beam propagating along the z- direction in a nano-particle system is considered that includes dielectric particles with refractive index np lower than the refractive index of the background medium nb. If np<ne, the nano-particle regions might have a negative polarizability. The nano-particles are driven away from the high intensity region of the beam, resulting in a change of the local refractive index in the suspension, which exhibits a focusing nonlinearity and produces a charge vortex charge beam in outward of free space.

However, this complex beam evolution process is described by the nonlinear Schrodinger equation (NLSE). The nonlinear Schrodinger equation governing the evolution of the slowly varying electric field envelope E may be given by:

$$i \frac{\partial E}{\partial z} + \frac{1}{2 {k}_{0} {n}_{b}} {∇}_{⊥}^{2} E + {k}_{0} ( {n}_{b} - {n}_{p} ) {V}_{p} {ρ}_{0} {e}^{\frac{α}{4 {k}_{B} T} {\vert E \vert}^{2}} E + \frac{i}{2} σ {ρ}_{0} {e}^{\frac{α}{4 {k}_{B} T} {\vert E \vert}^{2}} E = 0 \qquad ( Equation 31 )$$

### Where:

∇_{⊥}² is the transverse Laplacian;
α is the particle polarizability;
K_{BT} is the thermal energy;
K_{B} is the Boltzmann constant;
T is the temperature;
Vₚ is the volume of a particle;
p₀ is the unperturbed particle concentration;
σ is the scattering cross-section;
k₀ is the wave number; and
λ₀ is the free space wavelength.

This important non-linear equation will be analyzed using the linear stability analysis and may be solved numerically using the split-step Fourier algorithm. Using the Maxwell equations, Ampere's law, and Gauss's law equations, the charge injection with current displacement may be determined using the electric field of the beam wave equation.

The electric displacement field is given by:

$$D = {ε}_{0} E + P \qquad ( Equation 32 )$$

### Where:

ε₀ is the permittivity of free space;
E is the electric field intensity; and P is the polarization of the medium region.

Using the differential of this equation with respect to time defines the displacement of current density. Therefore, this has two components in a dielectric given by:

$${J}_{D} = {ε}_{0} \frac{\partial E}{\partial t} + \frac{\partial P}{\partial t} \qquad ( Equation 33 )$$

The first term on the right side of equation 33 describes material media and in free space. It is associated with the magnetic field just as current is to change motion, but does not necessarily come from any movement of charge. The second term on the right side of equation 33 is polarization current density that comes from the change in polarization of the individual molecules of the gas (or fluid) and solid dielectric materials. Polarization may occur when the applied voltage is active and influence of an applied electric field. The charges in molecules may move from the position of exact cancellation. The positive and negative charges in molecules are separate, causing an increase in the state of polarization P.

When a changing state of polarization corresponds to charge movement, it is equivalent to a current. This is called “polarization current” which may be given by:

$${I}_{D} = \int {\int }_{S} {J}_{D} \cdot dS = \int {\int }_{S} \frac{\partial D}{\partial t} \cdot dS = \frac{\partial }{\partial t} \int {\int }_{S} D \cdot dS = \frac{\partial {Φ}_{D}}{\partial t} \qquad ( Equation 34 )$$

This polarization is the displacement current that was developed by Maxwell. This is treating it as material medium, but no special treatment of the vacuum. Maxwell used changing the relative permittivity, C_{T}, in the relation D=ε_{T} ε₀E for the effect of P.

For a linear isotropic dielectric, the polarization P may be given by:

$$P = {ε}_{0} {χ}_{e} E = {ε}_{0} ( {ε}_{r} - 1 ) E \qquad ( Equation 35 )$$

Where Xₑ is the susceptibility of the dielectric to electric fields, ε=249 ᵣε₀=(1+Xₑ)ε₀.

There may be three different regions with state conditions in the DBD reactor tube. Both permittivity and susceptibility are used for the effect of polarization among three different regions of tube. There is a displacement current I_{D} flows in the tube and this current produces the magnetic field in the region of capacitance according to Ampere's law. This determines and relates to the charging of the capacitor of the tube, and may be given by:

$${∮}_{C} B \cdot d l = {μ}_{0} {I}_{D} \qquad ( Equation 36 )$$

### Where:

[symbol] is the closed line integral around some closed curve C;
B is the magnetic field;
dl is the infinitesimal line element along the curve C (vector with magnitude equal to the length element of C, and direction given by the tangent to the curve C);
μ₀ is the magnetic constant and the permeability; and
I_{D} is the net displacement current that passed through a small surface bounded by the curve C.

The electric field build up increases as the capacitor charges. This is described by Gauss's law assuming no dielectric among the figure of capacitor. The displacement current is related to charging of the capacitor and described by Gauss's law, which may be represented by:

$$Q ( t ) = {ε}_{0} {∮}_{S} E ( t ) \cdot dS \qquad ( Equation 37 )$$

### Where:

S refers to the cylinder surface;
ε₀ is the permittivity of free space; and
E(t) is the electric field.

The chare conservation equation may be given by:

$$I = - \frac{d Q}{dt} = - {ε}_{0} {∮}_{S} \frac{\partial E}{\partial t} \cdot dS = S {ε}_{0} \frac{\partial E}{\partial t} {\vert}_{R} \qquad ( Equation 38 )$$

Where the first term is a negative sign due to the charge leaving the surface area (i.e., the charge is decreasing), the last term is a positive sign due to the unit vector of surface R, S is the area of the surface R.

This added displacement current also leads to wave propagation by taking out the curl of the equation for magnetic field. This lead to electric field of wave propagation that may be expressed by:

$$E = - ∇ φ - \frac{\partial A}{\partial t} \qquad ( Equation 39 )$$

### Where:

φ is the electrical potential, which is Poisson's equation; and
A is a vector potential.

Regarding equation 39 above, the ∇_{φ} component on the right side is the Gauss' law component. The second term on the right side of equation 39 is the one used in the electromagnetic wave equation that contributes to the curl of E. ∇_{φ} does not contribute to ∇×E because the vector identity said that the curl of the gradient is zero. Hence, the displacement current is related to the charging of the capacitor and includes wave propagation.

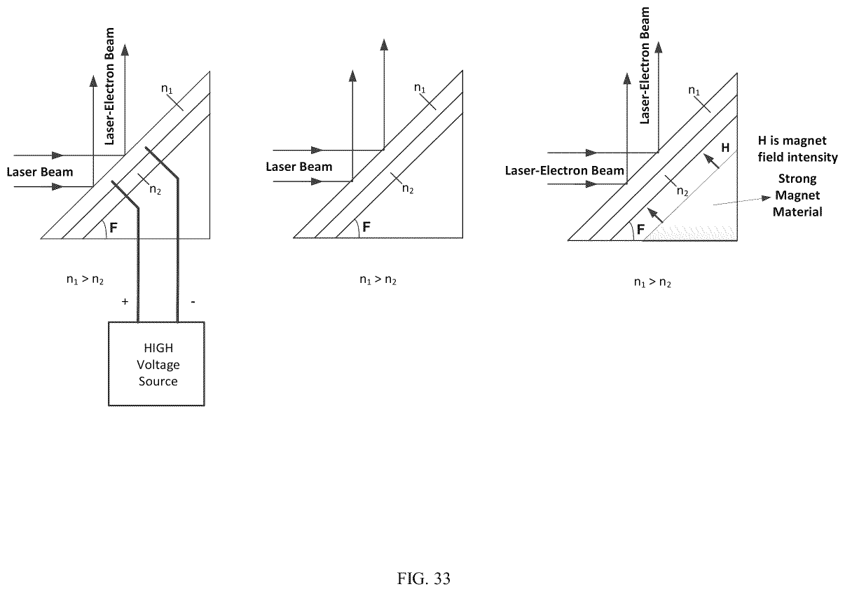

FIG. 29 depicts electrons trapped in a laser guided beam in accordance with some embodiments. There are one or more layers of beams, which include laser ablation, laser electron trapped waveguide; and plasma one stepped leader. Embodiments of the reactor tubes of the present disclosure use only laser beam shot, meaning the system produces self-injection by electron space charge tube and the laser beam propagation is trapped and carries the electron charge during DBD charge and discharge cycle inside tube. In other words, a laser beam traps bunches of electrons and carries them in long distance in a waveguide as a high photonic-electron isolation side as depicted in FIG. 29. The laser beam does have both electric and magnetic fields. The motion of a free electron in a laser field may be given as:

$$\frac{d p}{dt} = {F}_{L} + {F}_{rr} \qquad ( Equation 40 )$$

### Where:

F_{L} is the Lorentz Force;
Fᵣᵣ is the radiation reactor force;
γ² is the main term proportional the relativistic case;
E and B are the electric and magnetic field of the laser; and
p is the electron momentum.

This equation uses electron momentum to illustrate a trapping effect of electrons inside the laser pulse using electron dielectric barrier devices, such as the reactor tube. A plurality of electrons gather around the laser propagating axis and form a dense bunch through the pinching effect. Also, the radiation reaction trapping provides a collimated high density plasma bulk inside the laser pulse where y-proton emission has high intensity. The impact of the plasma flow on the laser propagation beam using injection laser beam parameters along the path of the gas flow effects the beam energy evolution along long target beam distance.

Using the reactor tube application, the beam current, I(ζ), may be obtained using a desirable beam charge along the laser beam propagation distance, and may give different energy evolution patterns. The total charge injected charge along the laser beam path may be given by:

$$Q ( ξ ) = ( 1 / c ) {\int }_{b e a m} I ( ξ ) d ξ \qquad ( Equation 41 )$$

### Where:

ζ is the phase angle inside the laser beam propagation;
v_{g} is the laser group velocity in the plasma;
c is the speed of light in a vacuum; and
Q is the beam charge with the starting laser propagation beam length (L).

The transient processes include not only migration of charges, but also sophisticated evolutions of electric and magnetic fields. These processes may be analyzed based on the Maxwell model of electromagnetism. For the simplest models of a charged medium, the current will continue until all the charges redistribute in such a way that the ultimate configuration of the charges will meet the following conditions: (1) there are no charges inside the conductor; (2) all charges are concentrated on the conductor's boundary; and (3) the final field inside the conductor vanishes.

However, using and combining Lorentz and radiation force, current/charged beams, displacement current wave propagation (include Maxwell's law, Ampere's law, and Gauss's law), Energy flux, and Planck equations. The Boltzmann constant and laser propagation beam waveform equations include non-linear Schrodinger equation together. The laser driven charged waveguide is then introduced, and produces energy along a straight line path, which is extracted high density plasma flow from external sources.

The achievable beam charge includes the laser intensity propagation, gas feeding, and power supply with timing controlled board, which may be tuned and adapted to provide suitable driver beams for high-transformer-ratio of the DBD reactor tube (space charge regions). The conservations of energy using charged injected and trapped electrons inside the laser propagation beam tube will determine how long the laser current beam propagation distance may be used. Laser thermal blooming propagation beam includes heat and even carries charge and travel at long distances.

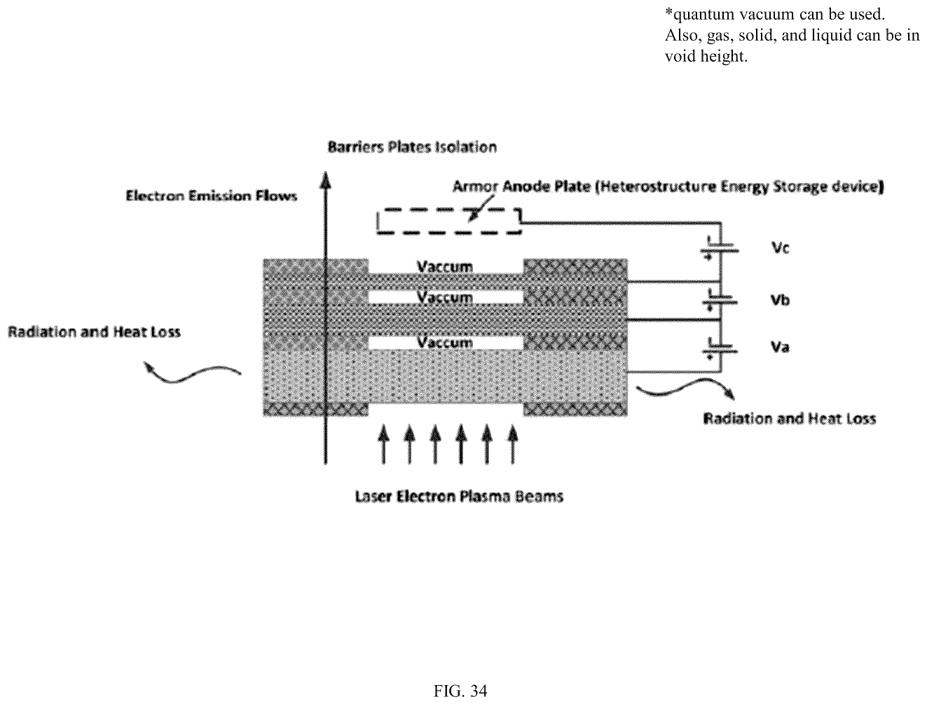

FIGS. 30A-C depicts the charge medium polarization effect in accordance with some embodiments. In free space, the helical wave front (right) and the doughnut intensity profile of the beam (left) are shown in FIGS. 30A-C. Inside the medium, the input vortex beam transforms into a rotating necklace beam. The repulsion of the particles in the path of the high intensity beam leads to a local nonlinear index change. FIG. 30C depicts a polarizer optic magnetic isolator in accordance with some embodiments. Optical isolators shown in FIG. 30C may be also described as a magnetic lens that allows a laser beam to travel in only one direction and block plasma backward to protect the laser source from the potential damage of backward reflection from the beam. The optic magnetic isolator may use nanoparticle fluid work as polarization by applied voltage signal. Both optic isolator (polarization) and magnetic isolator, using an electronic power source, may be used for bidirectional beams propagated to protect the laser source.

Sequence Timing Events

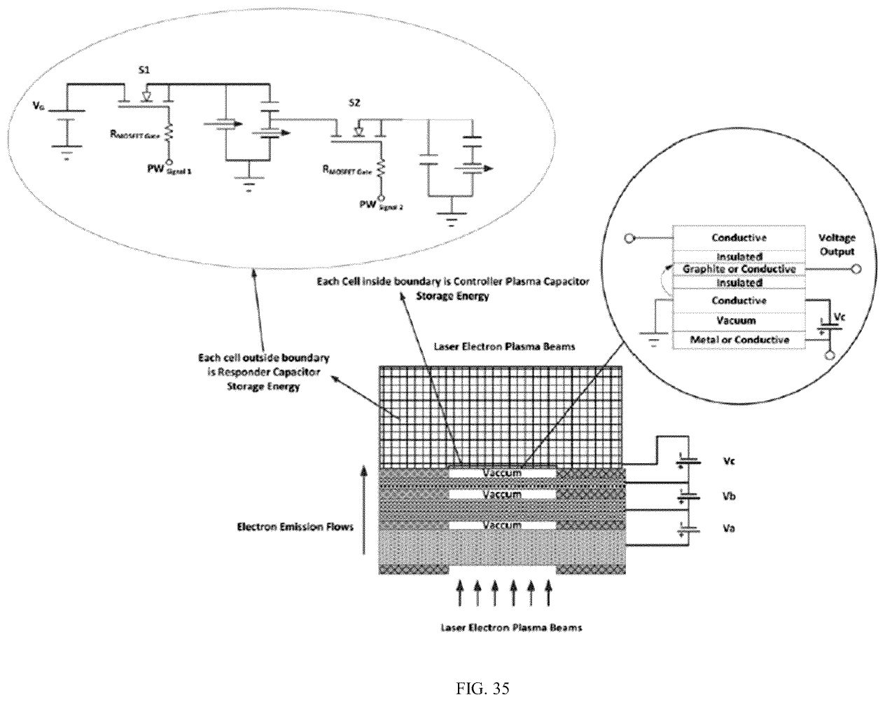

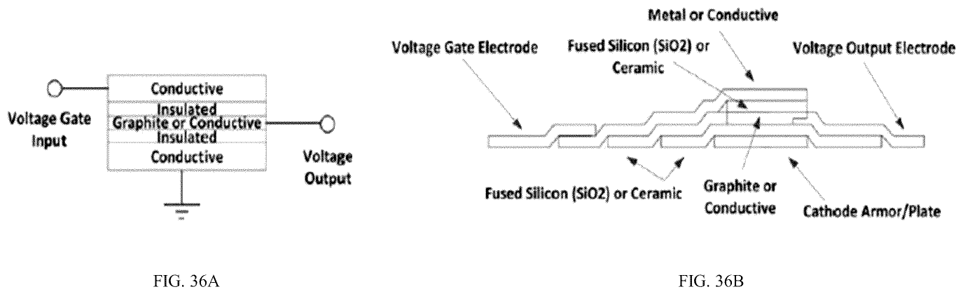

FIG. 31 depicts sequence timing events for a DBD reactor tube and capacitor energy storage circuit in accordance with some embodiments. The reactor tube and quantum plasma circuit work together through several event stages, which include one or more switching steps as illustrated in FIG. 31. The sequenced timing events may be controlled by a microprocessor (p) configured to perform the operations of the timing events. FIG. 32 depicts a cycle of timing events by a microprocessor in accordance with some embodiments.

Bending Laser-Electron Beam Propagation

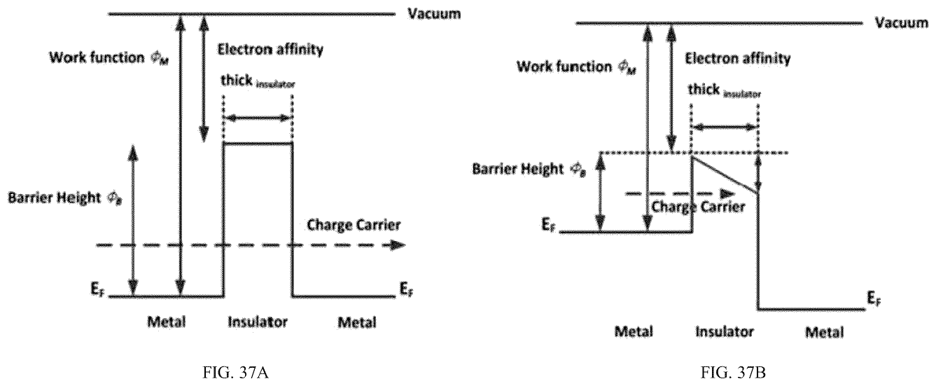

FIG. 33 depicts a high voltage DBD plasma mirror in accordance with some embodiments. In some embodiments, the laser-electron beam propagation may bend or reflect using a high voltage DBD plasma mirror as disclosed in U.S. Pat. No. 11,310,900 already disclosed herein by reference. This unique mirror may be made in different shapes, such as parabolic or right angle. The DBD Plasma mirror may include two different index refractive transparent materials with two separate electrodes regions using high voltage. As seen in FIG. 33, the plasma is produced by two electrodes that enable particle electron charge region and are tapped by the laser propagation reflection. The DBD plasma mirror is similar to the mechanism of the DBD reactor tube device disclosed herein.

Field Electron Emission Transfer to Energy Storage Devices

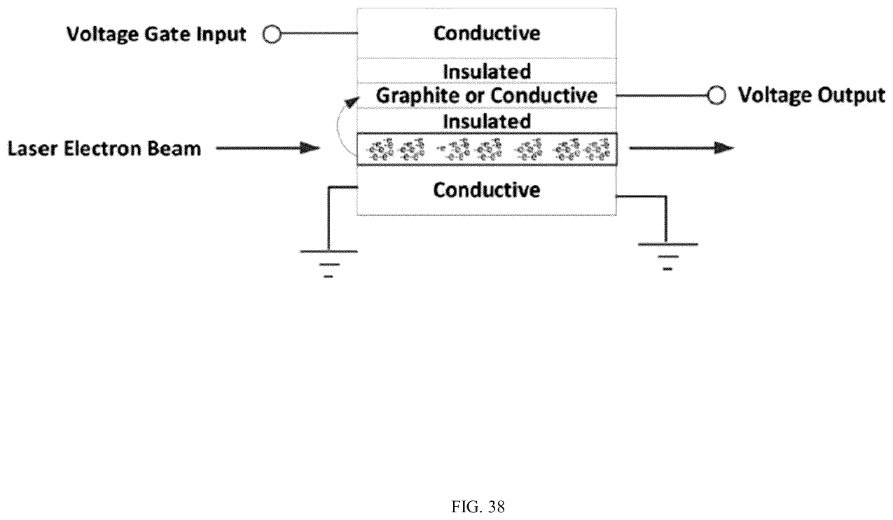

As illustrated in FIG. 34, electron field emission is the primary source that is produced across the surface barrier by an electric field, which may be transferred to energy storage devices. A strong external electric field near the surface of the emitter target area may be controlled and affect the emission of electrons. A free electron at the extreme surface of the metal or conductive material may overcome this surface barrier using strong electrostatic force of the created electric field (e.g., by applied voltage control). This causes electron emission by the electric field in the space, which is the mechanism of the electron field emission. There are another three other emissions types involved during beam operation: thermionic emission, photoelectric emission, and secondary electron emission, which may also transferred to energy storage devices. All three of these other types of emissions may be used when the laser electron plasma beams strike against the surface at straight path or even extract near the laser electron plasma path operation. Any of these methods may use waveguide material or straight beams path. A wide range of field electron emission densities may be controlled and transported by tuning the three voltage biases, barrier height, and the number of barriers.

Both the displacement current and also volumetric energy density may be transferred across the barriers following Maxwell's equation and Gauss's law given by:

$$D = {ε}_{0} ε E \to U = {ϵ}_{0} ϵ E \qquad ( Equation 42 )$$

### Where:

ε₀ and ε₀ are the vacuum permittivity;
ε and ε are the dielectric constant characterizing the dielectric; and
E is the electric field.

The electric field is the applied voltage (V) divided by the capacitor spacing (d) that is equal to the storied energy density scales and may be given by:

$$E = \frac{V}{{d}^{2}} \qquad ( Equation 43 )$$

Where d may also be the distance space between two conductive materials, which may act as a capacitor.

FIG. 34 depicts a field electron emission mechanism in accordance with some embodiments. Thermionic emission happens when the metal or conductive material has enough heat to produce free electrons at the extreme surface of the metal. These free electrons get enough energy to overcome the surface barriers that allows emitting from the metal. This intensity of thermionic emission depends on the metal temperature and the height of barrier.

Light from the laser uses the flow photons with each photon having its own energy. The energy of the photons depends on the frequency or wavelength of the light ray. Some of the photons transfer their energy to the free electrons during the striking on metal surface. Meaning, free electrons may get enough energy to overcome the surface barrier that starts electron emission, also called the photoelectron emission mechanism.

The secondary electron emission is produced when the free electrons have enough kinetic energy of high velocity striking electrons on the metal surface. However, the free electrons have sufficient kinetic energy to overcome the surface barrier and start electron emission.

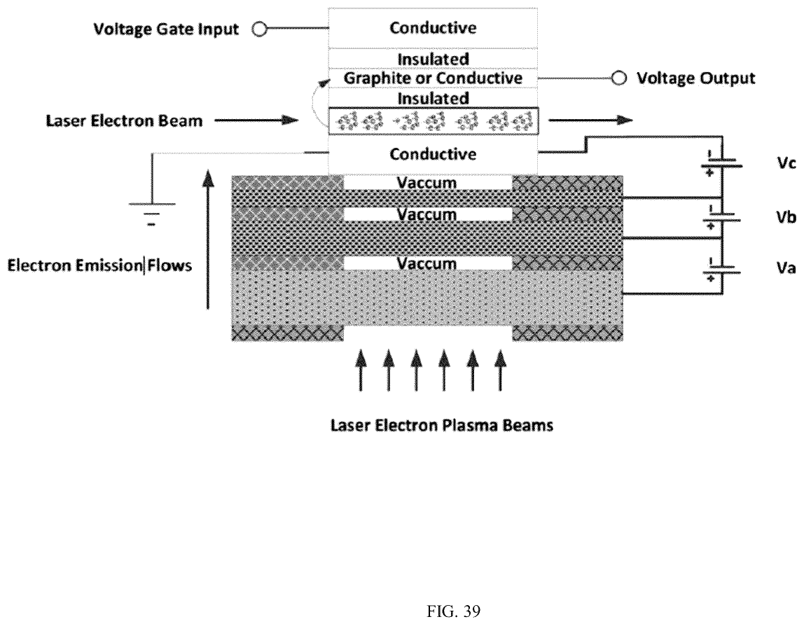

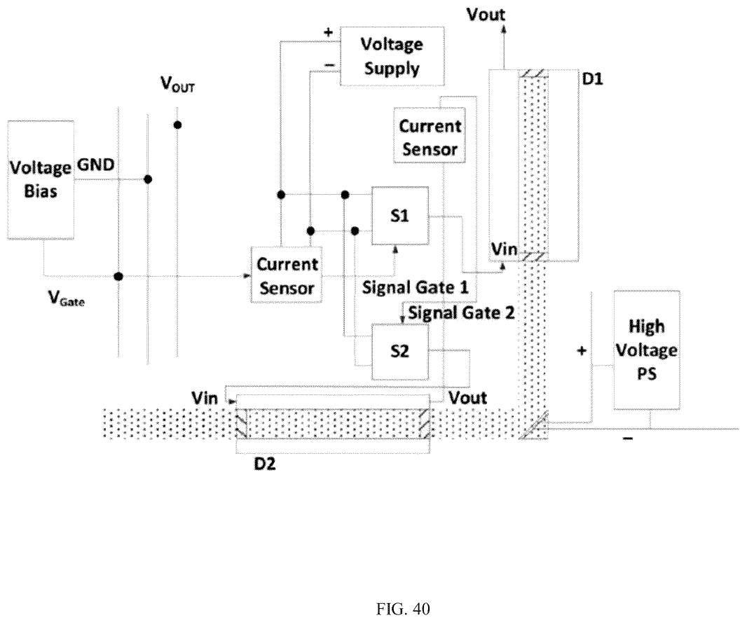

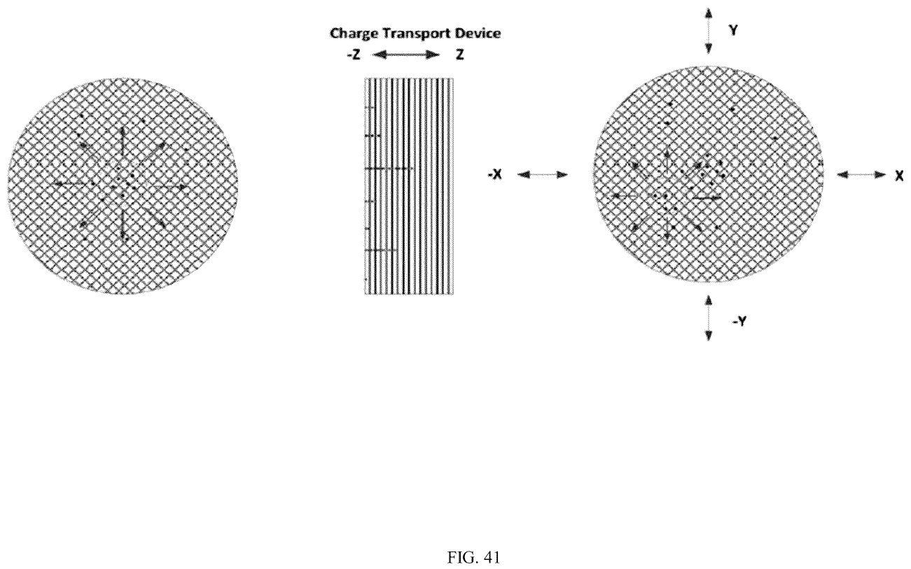

FIG. 35 depicts control and responder energy storage devices in accordance with some embodiments. FIGS. 36A-36B depicts charging trapping flash and nano-electronic packing, respectively, in accordance with some embodiments. In some embodiments, tungsten or tungsten alloys may be used for the diverter plasma material barriers or armor. Other materials having low erosion rate and high temperature properties may be used. These materials may be the target region induced into Fowler-Nordheim tunneling effect by laser electron plasma beam, which is depicted in FIG. 35. The barriers controller may be used together with heterostructure charge transport device controller shown in FIGS. 35-36B.

For a charge trapping flash, electrons may be trapped and stored in the floating gate (e.g., graphite material) layer using the electric field, controlled by applied voltage. The electron flowing through barriers between the metal and insulator may be broken down using the voltage gate control. In this way, the electron charge may be stored much more quickly and release huge capacity of energy following the number of increasing floating gate material layers in the middle of the metal and insulator barriers. Hence, this leads to long duration energy storage effectively acting as a quantum battery.

The quantum tunneling concept uses an accurate equation of the Fowler-Nordeim law as seen in Equation 2 above.

Equation 2 uses the quantum mechanical tunneling process and is important in design of thin barriers, such as metal-insulator-metal-insulator-metal junctions and another kind of tunneling across an insulator which is direct tunneling. This happens when the barrier width is small using low applied voltage bias as depicted in FIG. 36A.

The fermi energy may be given by:

$${E}_{F} = \frac{π {h}^{2} n}{{g}_{V} {m}^{*}} \qquad ( Equation 45 )$$

### Where:

n is the charge carrier density;
gᵥ is the pseudospin factor;
h is the Plank constant; and
m* is the effective mass.

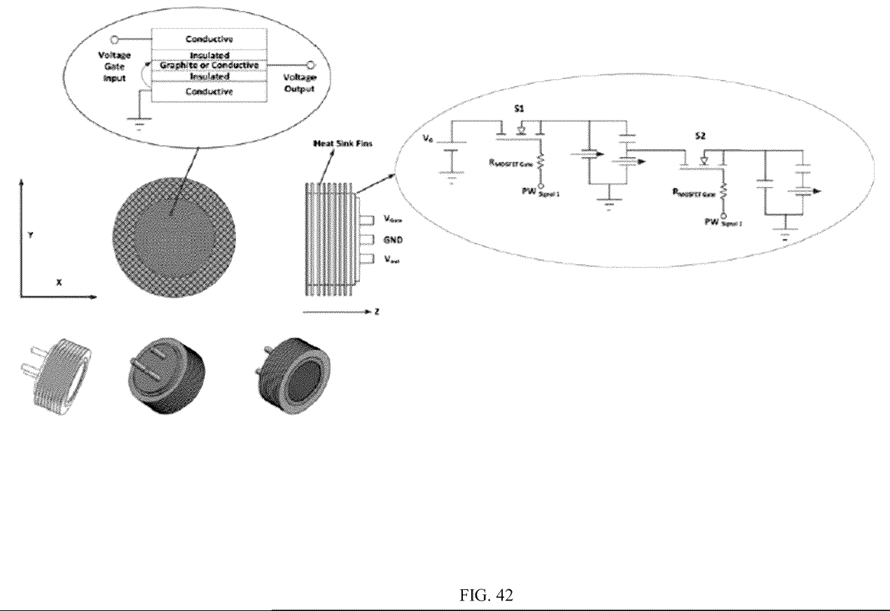

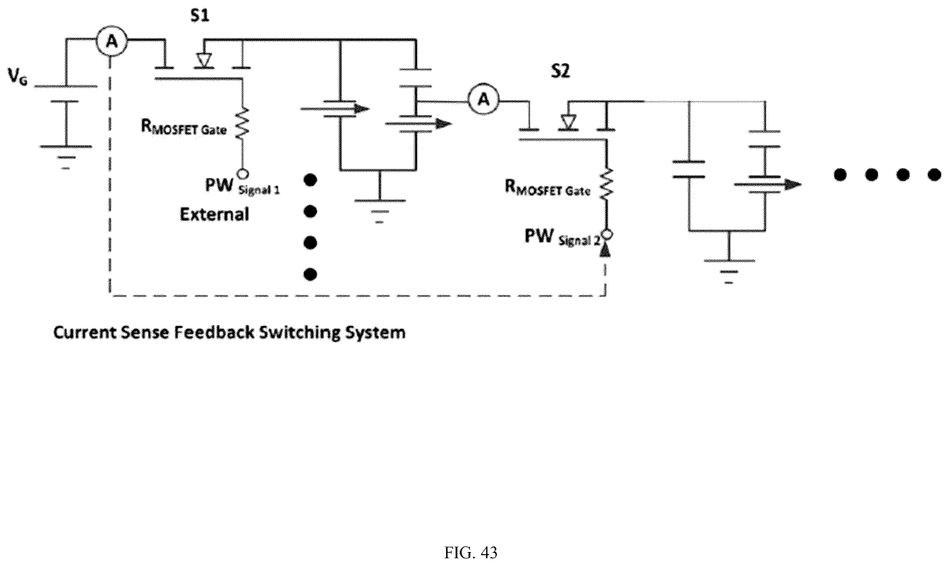

FIGS. 37A-37B depict exemplary models of Fowler-Nordheim tunneling in accordance with some embodiments. As depicted in FIG. 37A, the charge carrier tunneling happens without bias when using the applied direct tunneling, where electrons tunnel without the help of an electric field. As depicted in FIG. 37B, the electron tunneling occurs where the barrier height is pulled down efficiently by an electric field using voltage gate source. This helps to bring charge carrier injection through the insulator barrier.

Fermi level pinning theory suggests that in a metal-semiconductor (M-S) contact, wave functions of electrons in the metal may decay into the semiconductor in the band gap. This creates intrinsic states known as the metal-induced gap states (MIGS). The energy level in the band gap at which the dominant character of the interface states changes from donor like to acceptor like is called the charge neutrality level.

The design for a metal/semiconductor contact matches the wave function of an electron at the interface of the contact. The metal induced gap states using direct chemical bonding or surface includes two materials that match at the interface due to the Fermi levels. Hence, these high dense states are able to take a large amount of charge from the metal effectively. This allows shielding of the semiconductor from the influence of the metal. This result enables the semiconductor bands to align to a location relative to the surface states (band bending). This mechanism helps to pin down to the Fermi level due to their high density all without influence from the metal. Note there are other methods to contact to the anode plate or armor using laser-electron-plasma beam propagation to hit the target area region interface with all these heterostructure pinned layers design.

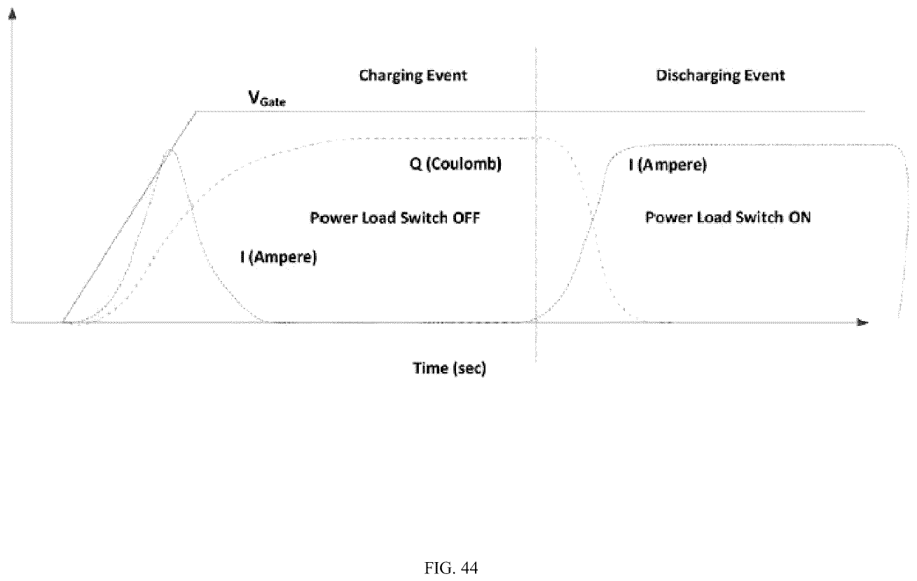

Also, there is another method that may be used for glass waveguide, such as a silicon nitrate integrated photonic circuit combined with van de heterostructure capacitance energy storage devices as depicted in FIGS. 37A-37B. An applied voltage bias controller may strip off some electrons from the laser electron beam while laser electron plasma beam strikes against the anode plate in its own voltage bias controller as depicted in FIG. 38. It should be appreciated that that there may be thousands or millions tiny nano cell packaged together against the anode plate as depicted in FIG. 35 for example.

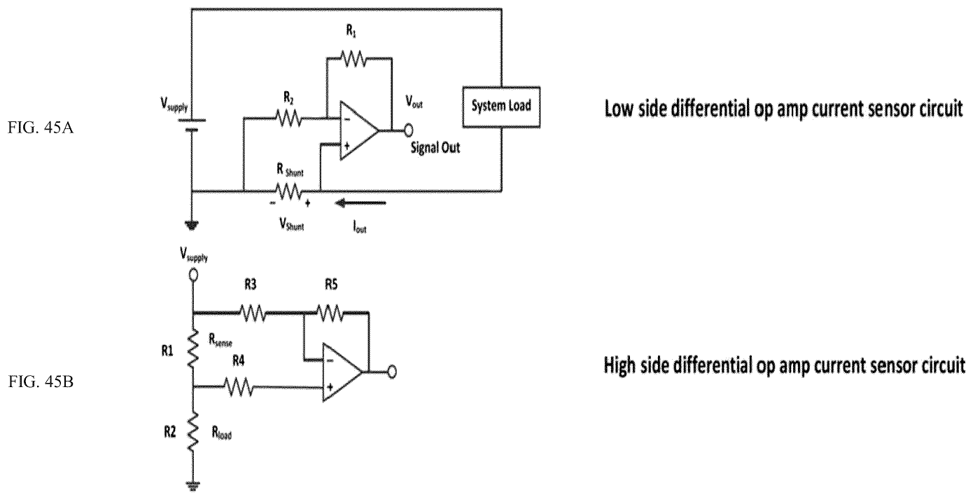

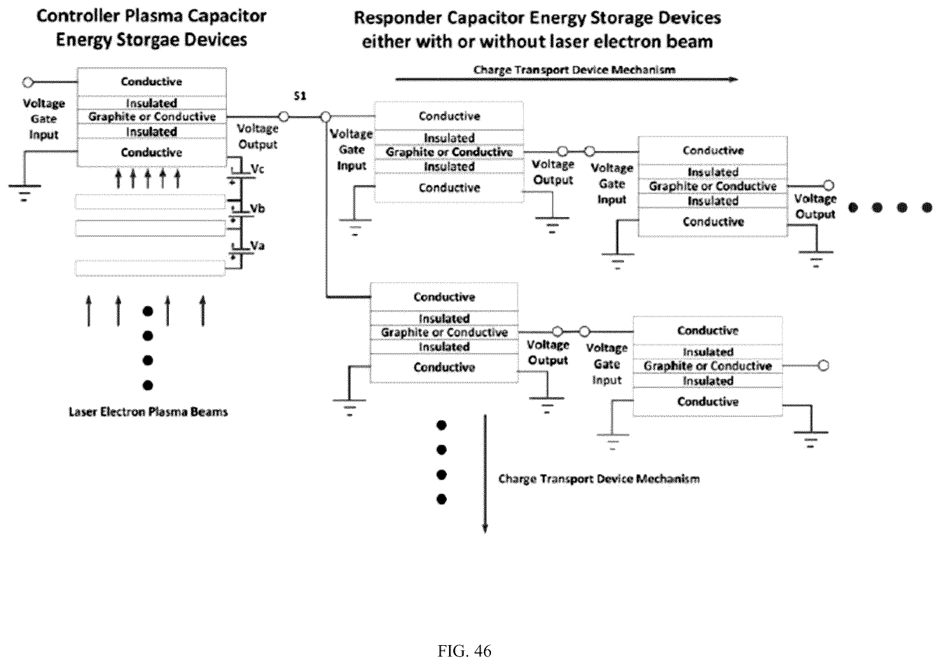

FIG. 39 depicts a laser beam waveguide field electron emission controller system in accordance with some embodiments. FIG. 40 depicts an electron beam waveguide layout in accordance with some embodiments. The layout design for these different methods may be employed as scalable packages as illustrated in FIGS. 39 and 40 as scalable packages. Note that there are also different rails of voltage supply and signals controlled.

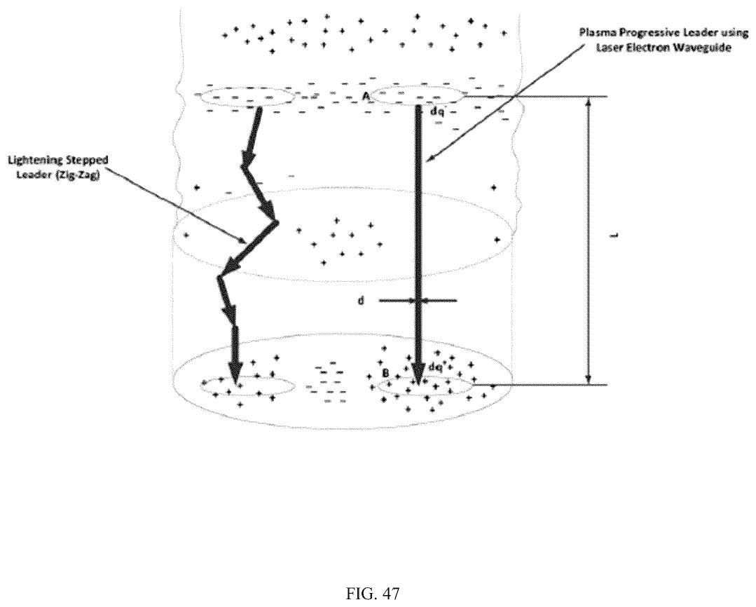

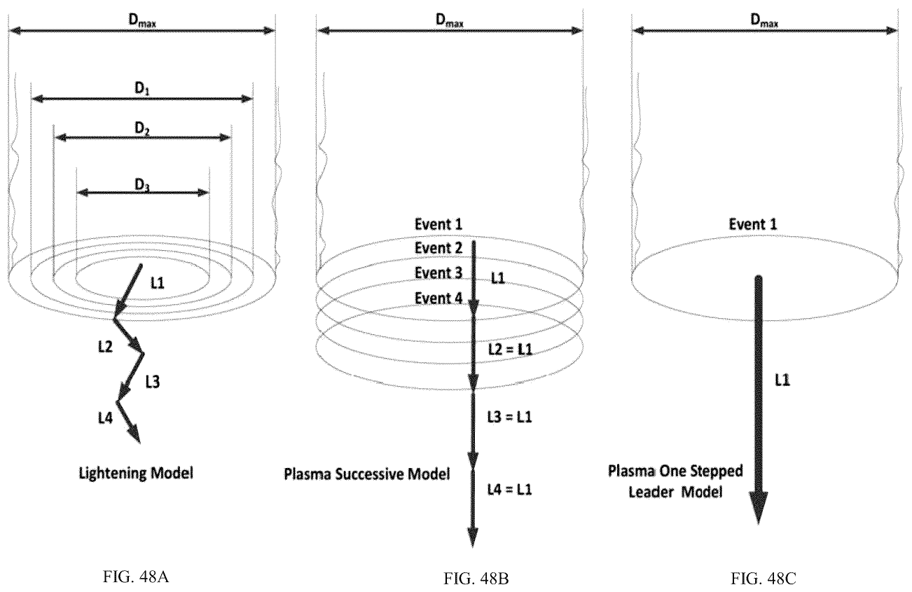

FIG. 41 depicts a charge transport device mechanism in accordance with some embodiments. FIG. 42 depicts a flat anode and associated circuit diagrams in accordance with some embodiments. These different methods may use switching control for charge transport devices as depicted in FIGS. 40 and 41. The purpose of switching is to allow charge transfer to any location at higher efficiency and better thermal management. Also, the laser beams do not always target at the center of the surface perfectly. Thus, the solution is to use charge transport devices. As depicted in FIGS. 41 and 42, each black square on the flat anode plate is charging while other cells are discharging or not.

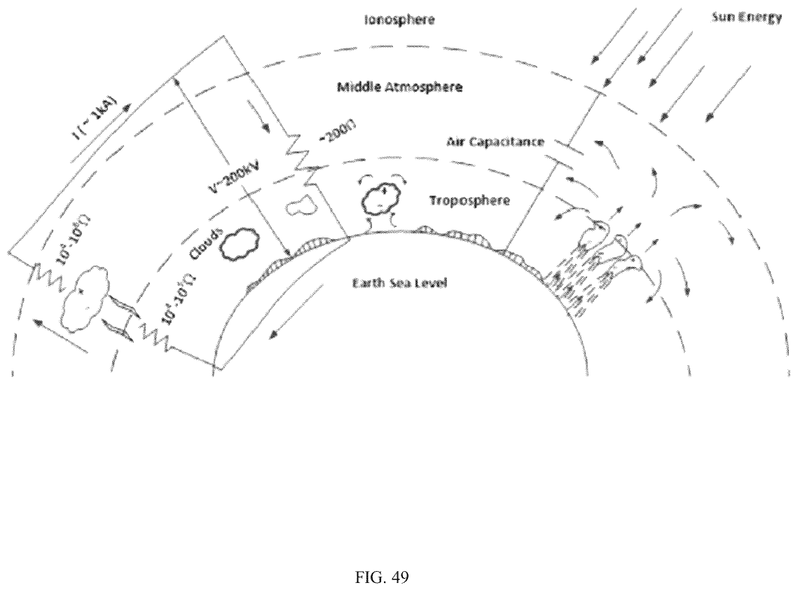

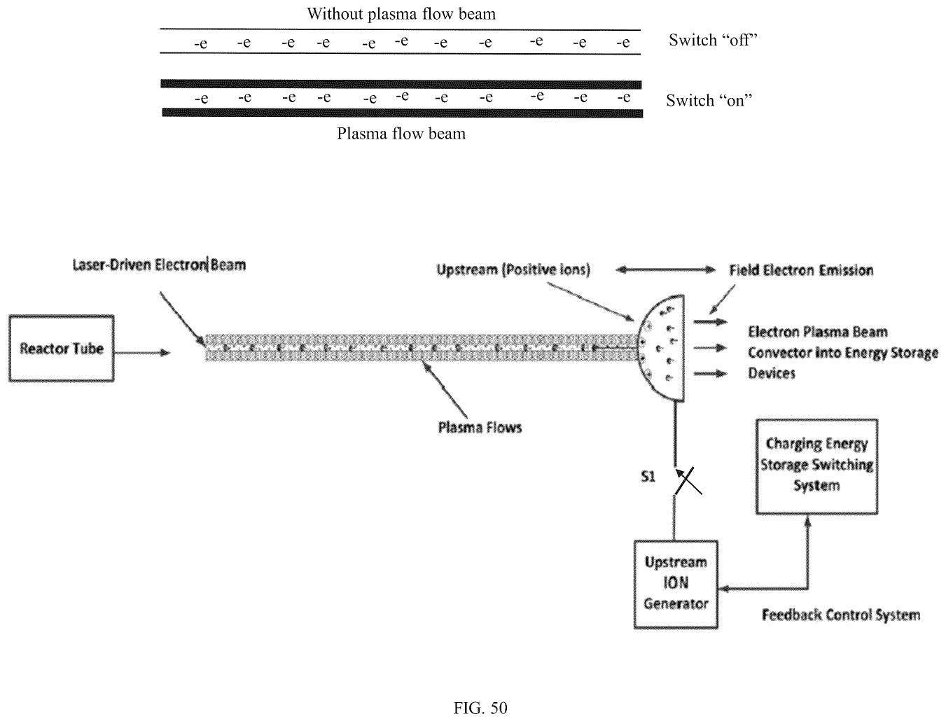

FIG. 43 depicts a MOSFET switching feedback circuit in accordance with some embodiments. Switching may be feedback controlled using current sensing circuits with laser electron-plasma energy storage devices as depicted in FIGS. 40 and 43. Note that there are also different events during beam operations. For example, an electron beam separate from the laser electron plasma beam may simulate charging many devices as depicted by the arrow toward the capacitor symbols shown in FIGS. 42 and 43. The purpose of this circuit is to transfer charge to another device when the current drops to nearly zero while the voltage gate operates continuously. An example of this transferred charge is illustrated in FIG. 44.

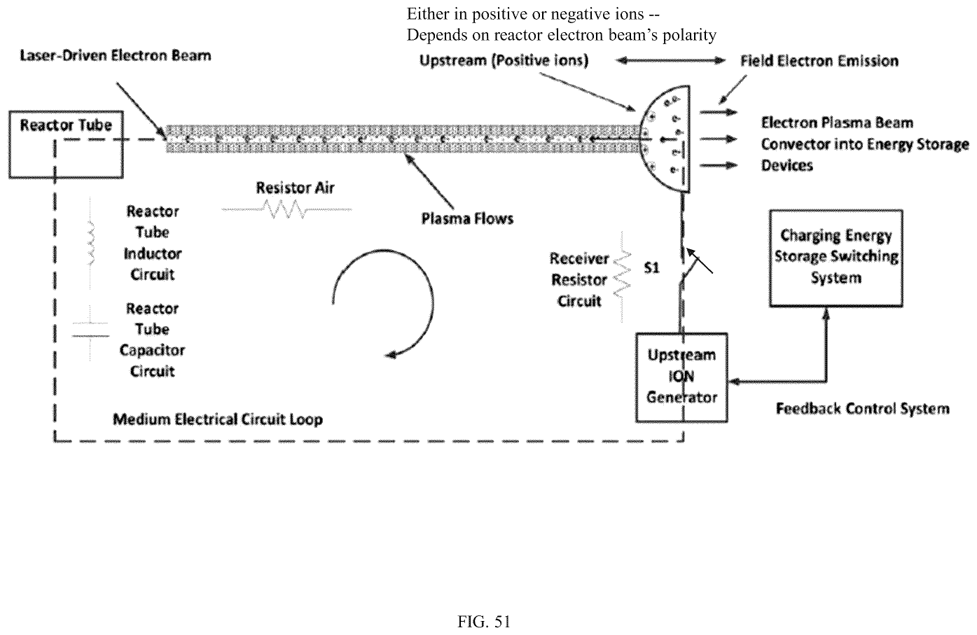

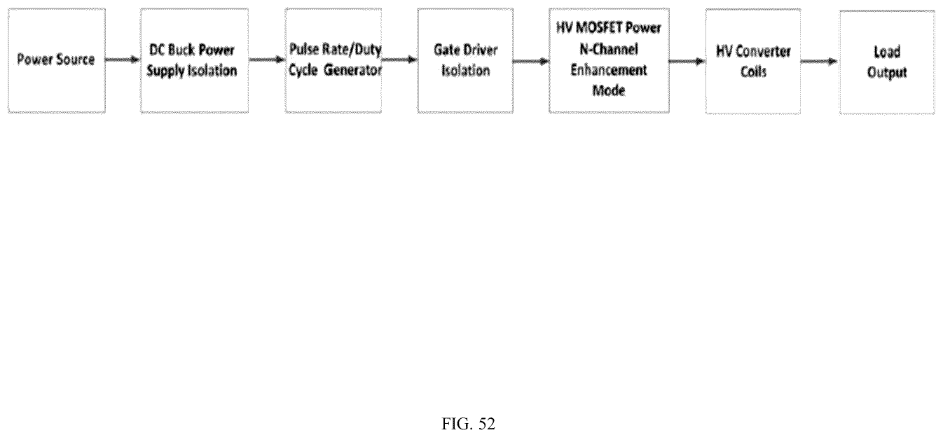

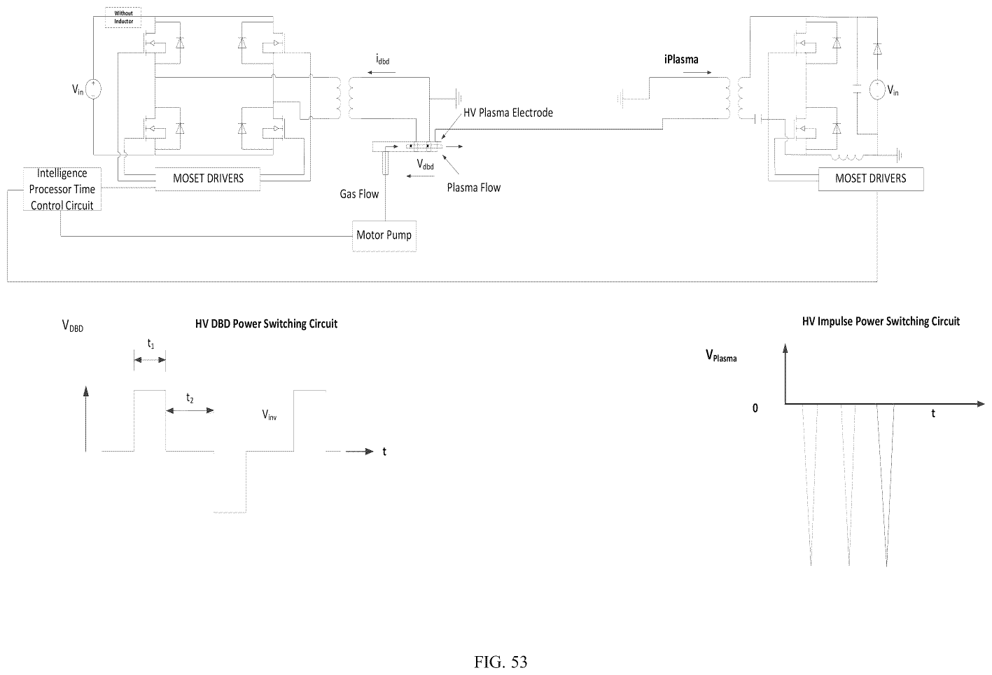

FIG. 45A depicts a low side current sensing circuit in accordance with some embodiments. FIG. 45B depicts a high side current sensing circuit in accordance with some embodiments. FIG. 46 depicts a switching control system layout in accordance with some embodiments. There are several different ways to accomplish current sensing on a voltage rail. For example, a low side and/or high side differential operational amplifier circuits as depicted in FIGS. 45A-45B may be used. Other methods may include IC solutions. However, as depicted in FIG. 46, the switching control system allows complex charge transfer to different location during beam operations.

One Plasma Stepped Leader Path

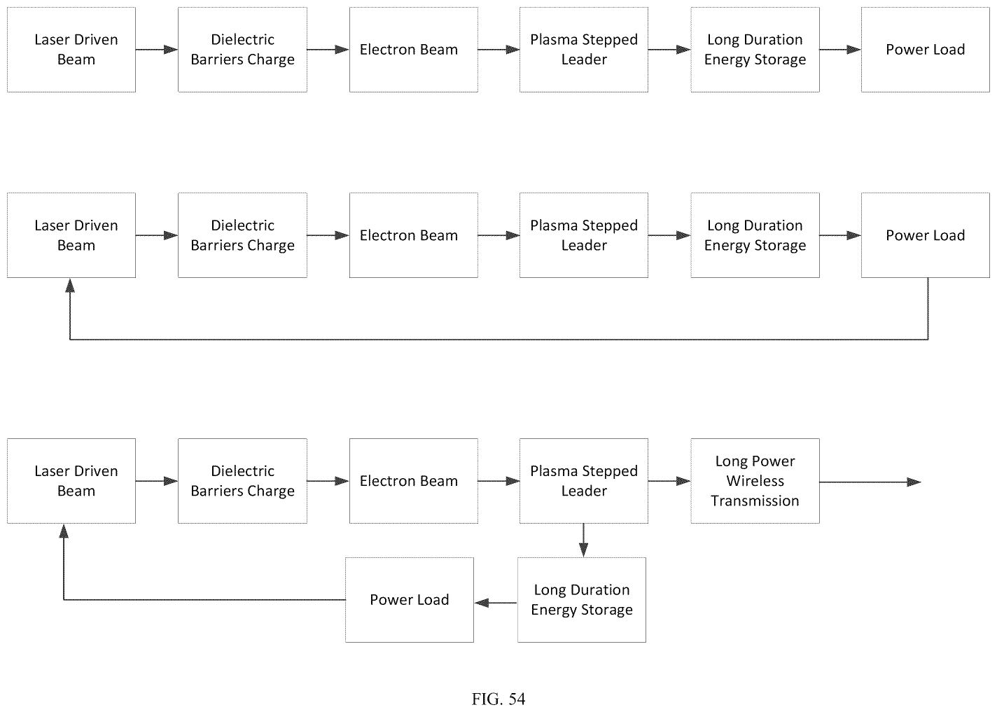

FIG. 47 depicts plasma progressive step in accordance with some embodiments. Electric discharge in long air gaps is a complex phenomenon. The plasma stepped leader is similar to the earth nature of lightening phenomenon, but without resistance, and travels in a straight path at the speed of light using an electron beam from a laser (e.g., no zig-zag paths). Once, the plasma stepped leader and the upstream device (e.g., energy storage device, ion generator, etc.) have met, the plasma channel resistance via laser electron waveguide drops to zero, or close to zero, and travels at the speed of light (e.g., with no resistance) or nearly to the speed of light (e.g., with little resistance). The electrons, using a high voltage generator, accelerate along the laser electron beam very quickly and move the whole leader network at a fraction of the speed of light. This so called “return stroke” from either chassis-ground or earth-ground to electrode of the object of laser electron beam. After that, a new stepped leader will repeat at one cycle event and the entire process may repeat several times. The manmade plasma trajectories are straight lines using the waveguide of the laser electron beam. The man-made plasma may use different trajectories from the lightning stepped leader as depicted in FIG. 47 for example.

Hence, the mathematical model for plasma stepped leader may be determined by its speed evolution in horizontal and vertical directions and at any angles direction. But plasma flows at the speed of light using only one stepped leader due to zero resistance of the laser waveguide (e.g., laser-electron beam from the reactor tube). It is a different mechanism from lightening stepped leader. The number of lightening plasma paths (e.g., zig-zag leader) depends on the surface charge density and the size of the cloud regions toward tree or earth ground. The energy of the plasma paths depends on the charge density, time durations, and laser electron beam path. Hence, it is only one straight path stepped leader during one cycle event of high voltage pulse frequency.

A stepped ladder progressive at the speed evolution of a lightning storm is a similar to the process of the reactor tube devices mechanism, but used in different beam processes using the high voltage charging power supply and laser guide electron beam. For example, the reactor tube uses only one straight stepped leader during the recycle impulse discharge operation.

The maximum initial charge, Qmx may be determined using the surface density given by:

$${φ}_{s} = \frac{{Q}_{max}}{π \cdot \frac{{D}_{max}^{2}}{4}} \qquad ( Equation 46 )$$

A partial progressive of the stepped leader is in the first stage. The plasma process evolves in this way. When the leader advances, the section of the initial negative charged decrease during the pulse high voltage power supply operation. When the leader advances a length of Li, the diameter of charge region changes to D₁. The total decrease in the charge region of diameter may be given as:

$$Δ D = {D}_{max} - {D}_{1} \qquad ( Equation 47 )$$

The maximum initial charge may be expressed as:

$${Q}_{max} = {φ}_{s} \cdot π \cdot \frac{{D}_{max}^{2}}{4} \qquad ( Equation 48 )$$

Then the remaining charge is given by:

$${q}_{1} = {φ}_{s} \cdot π \cdot \frac{{( {D}_{max} - Δ D )}^{2}}{4} \to {q}_{L 1} = \frac{{φ}_{s} π}{4} \cdot Δ D \cdot ( 2 {D}_{max} - Δ D ) \qquad ( Equation 49 )$$

The step length and the charge is related through the longitudinal density of^{PGP}-6⁸,E charge, and may be given by:

$${φ}_{L} = \frac{{q}_{L}}{L} \qquad ( Equation 50 )$$

Thus, the leader length of advance plasma in the first step may be given by:

$${L}_{1} = \frac{{φ}_{s} π}{4 \cdot {φ}_{L}} \cdot Δ D \cdot ( 2 {D}_{max} - Δ D ) \qquad ( Equation 51 )$$

But again, using secession events may by done by a different method cycle, such as use of repeated increasing charge pulse rate. For instance, in the second step, the leader advanced would be L₂, and may be given by:

$${L}_{2} = \frac{{φ}_{s} π}{4 \cdot {φ}_{L}} \cdot Δ D \cdot ( 2 {D}_{max} - Δ D ) \qquad ( Equation 52 )$$

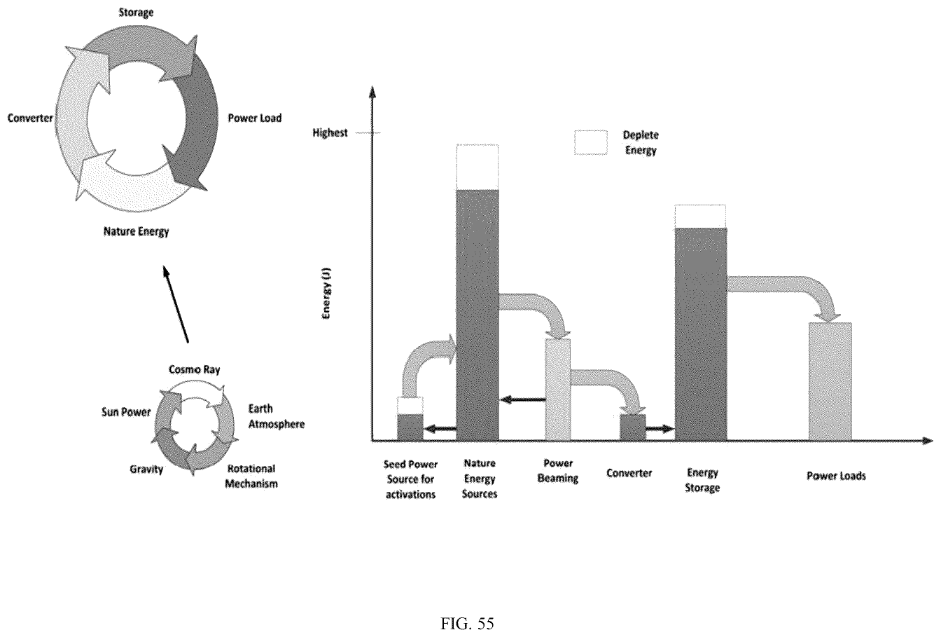

FIGS. 48A-C depicts different exemplary techniques for plasma leader models in accordance with some embodiments. The term ΔD=Dₘₐₓ−D₁ may still be used where the increasing charge is still feeding after the first cycle event during charge pulse rate operation. When using the lightning model, then L₂ may be given by:

$${L}_{2} = \frac{{φ}_{s} π}{4 \cdot {φ}_{L}} \cdot Δ D \cdot ( 2 {D}_{max} - 3 \cdot Δ D ) \qquad ( Equation 53 )$$

Where D₂ will get smaller for the lightning model, but not for the plasma progressive model (e.g., still use D₁=D₂=D₃ . . . ) as depicted in FIGS. 48A-C.

However, there are several techniques, methods, and parameters (e.g., amount charge density, impulse rate, energy rate, etc. from the reactor tube device) that may be done for the plasma progressive model during pulse rate or tune up frequency control operation.

There are two different charge dipoles, positive and negative. This mechanism is the theory of separation of charges in a plasma beam. The small circles shown in FIG. 47 may be the electrode ring or different geometrical shape instead of cloud model as the charge ions build up and E is the electric field in the process. There are two potential different streamer of charge, upward and downward. These mechanisms may depend on the polarity of the concentration of charge build up along the distance path.

Again, there are also several different methods using laser-guided energetic discharge over long distance gap by electric field plasma filaments. A first example includes plasma flows on surface of the electron beam. A second example is that plasma flows on the external surface of electron beam paths. Another method are the feeding plasma flow by a high voltage generator such as AC, DC, and impulse. Also, using either continuity and/or pulse beam. Also, there is resistance among its electrical loop paths in medium, such as vacuum, space, air, or atmosphere. The key is the resistance in medium that involving the speed of leaders. If there is zero resistance, then it will travel at the speed of light. And if there is much lower resistance, then it is nearly to the speed of light.

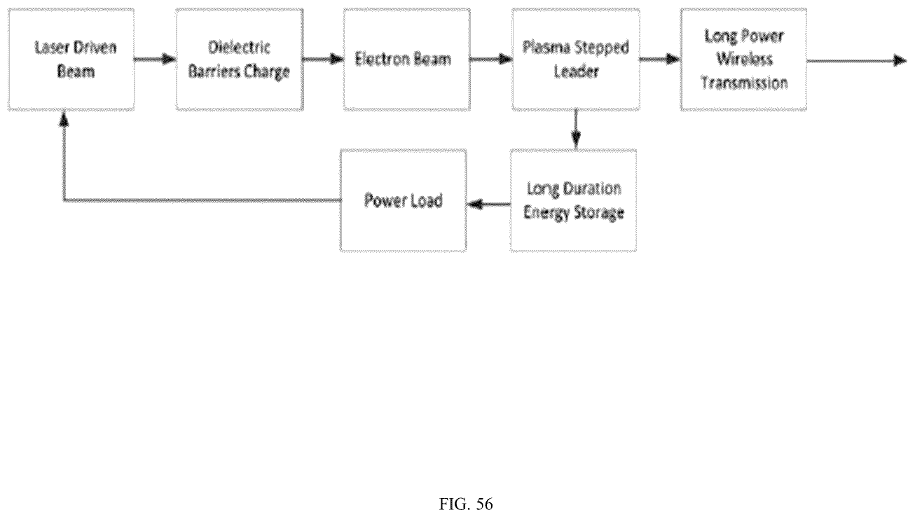

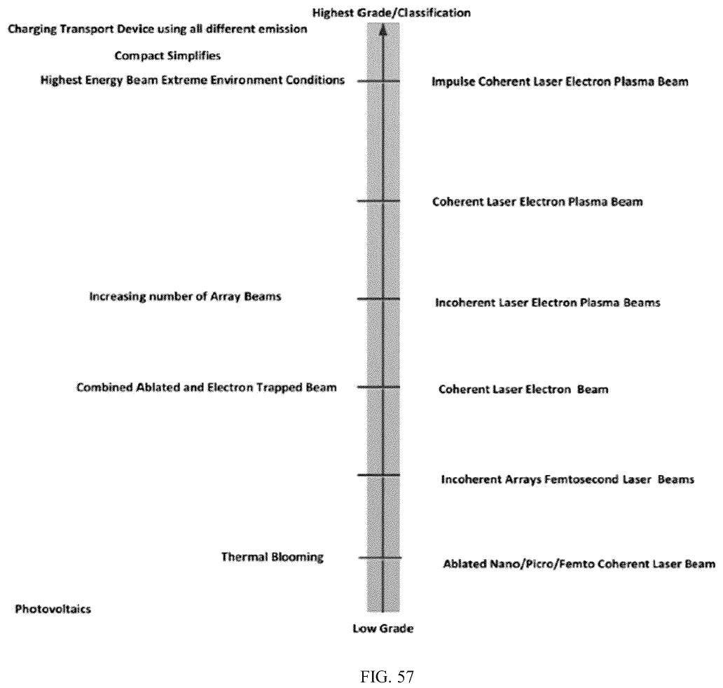

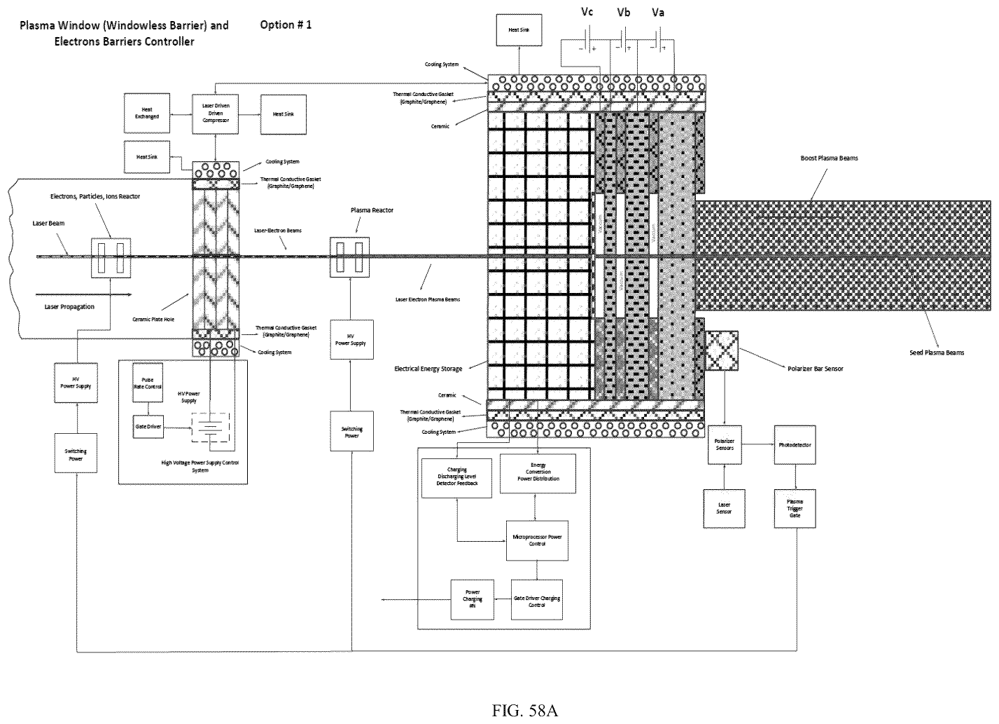

FIG. 49 depicts a global electric field. FIG. 50 depicts a plasma one step leader model in accordance with some embodiments. FIG. 51 depicts a plasma one stepped leader circuit in accordance with some embodiments. The global electrical circuit depicted in FIG. 49 is similar to plasma one stepped leader model and circuit depicted in FIGS. 50-51, respectively.

The speed of the leader may be obtained using current, resistance, and capacitance, parameters. The positive charge q+ is concentrated in plate B shown in FIG. 47, while the negative plate charge is located in plate A, q−. The current density (I) may depend on the capacitance (C), and the potential variation with respect to time (d #_{AB}/dt). The capacitance represents the capacitor between the electrode and ground or chassis. The potential may be defined between the two plates (electrodes). Hence, the carried current is the current density, and may be given by:

$$I = \frac{1}{2} \cdot C \cdot \frac{d {ϕ}_{A B}}{dt} \qquad ( Equation 54 )$$

The capacitance in this equation uses: (1) the vacuum permittivity (Fo); (2) the diameter (D) of the inside electrode region; and (3) length (L) covered by the stepped leader. In these parameters, the distance between the electrode and the ground or chassis may be given by:

$$C = {ε}_{0} \cdot \frac{π \cdot {D}^{2}}{4 \cdot L} \qquad ( Equation 55 )$$

Hence, this may be transformed using the derivative of length with respect to time, and may be given by:

$$I = \frac{1}{2} \cdot C \cdot \frac{d {ϕ}_{A B}}{dt} \to \frac{1}{2} \cdot C \cdot \frac{d {ϕ}_{A B}}{d l} \cdot \frac{d l}{dt} \qquad ( Equation 56 )$$

This equation may be used with the derivative potential with respect to the length that is equal to the electrical field (E) and the derivative of the length with respect to time. Hence, this is the leader speed that relates the discharge intensity of the capacitor with two electrodes (correspond to the geometrical electrode and ground) and may be given by:

$$I = {ε}_{0} \cdot \frac{π \cdot {D}^{2}}{8 \cdot L} \cdot {E}_{A B} \cdot v . \qquad ( Equation 57 )$$

The plasma discharge is considered as a resistive electrical circuit and may be given by:

$$I = \frac{{ϕ}_{A B}}{R} \qquad ( Equation 58 )$$

Where R may be given by:

$$R = δ \cdot \frac{4 \cdot L}{π \cdot {d}^{2}} \qquad ( Equation 59 )$$

Where the relationship between potential and length is replaced by the electric field: E_{AB}=ϕ_{AB}/L.

Thus, the equation may be given by:

$${ε}_{0} \cdot \frac{π \cdot {D}^{2}}{8 \cdot L} \cdot {E}_{AB} \cdot v . = \frac{π \cdot {d}^{2}}{4 \cdot δ \cdot } \cdot {E}_{AB} \to v = \frac{2 \cdot {d}^{2} \cdot L}{{ε}_{0} \cdot δ \cdot {D}^{2}} \qquad ( Equation 60 )$$

This equation must meet the relativistic theory following with Lorentz-Fitzgerald contraction. This establishes that the length of an element in movement is lower than in rest. And, without this contraction, the leader would reach higher than the speed of light. However, corrected physics should be made using the Lorentz-Fitzgerald contraction equation, which may be given by:

$$l = {l}_{0} \cdot \sqrt{1 - \frac{{v}^{2}}{{C}_{L}^{2}}} \qquad ( Equation 61 )$$

### Where:

l₀ is the length of the element in rest;
I is the length in movement;
v is the speed of movement; and
c_{L} is the speed of light.

The resistivity is a function of the environment dielectric strength and the material dielectric constant. Thus:

$$I = \frac{π \cdot {d}^{2}}{4 \cdot δ \cdot L} \cdot {ϕ}_{AB} \to δ = \frac{\frac{{ϕ}_{AB}}{L}}{\frac{I}{L}} \cdot \frac{π \cdot {d}^{2}}{4 \cdot L} \qquad ( Equation 62 )$$

Where the relationship ϕ_{AB}/L is the environment dielectric strength (E_{RD}) while I/L is the dielectric constant of the material k_{D}.

Hence, the new expressive (6) resistivity is obtained by combining the equations, and may be given by:

$$δ = \frac{\frac{{ϕ}_{AB}}{L}}{\frac{I}{L}} \cdot \frac{π \cdot {d}^{2}}{4 \cdot L} \to δ = \frac{{E}_{RD}}{{K}_{D}} \cdot \frac{π \cdot {d}^{2}}{4 \cdot l} \qquad ( Equation 63 )$$

The velocity equation is using leader length and resistivity equations in combination, and may be given by:

$$v = \frac{8 \cdot {K}_{D} \cdot {l}_{0}^{2} \cdot ( 1 - \frac{{v}^{2}}{{C}_{L}^{2}} )}{π \cdot {ε}_{0} \cdot {E}_{RD} \cdot {D}^{2}} \qquad ( Equation 64 )$$

The ratio (X) between the leader length (L) and the diameter of the region charge may be given by:

$$X = \frac{L}{D} \qquad ( Equation 65 )$$

The atmosphere resistance against the leader advance may be given by:

$${λ}_{R} = \frac{{E}_{ER}}{{K}_{D}} \qquad ( Equation 66 )$$

Thus, the velocity equation may be rewritten as:

$$v = \frac{8 \cdot {K}_{D} \cdot {l}_{0}^{2} \cdot ( 1 - \frac{{v}^{2}}{{C}_{L}^{2}} )}{π \cdot {ε}_{0} \cdot {E}_{RD} \cdot {D}^{2}} \to {v}^{2} + \frac{π \cdot {ε}_{0} \cdot {C}_{L}^{2} \cdot {λ}_{R}}{8 \cdot {χ}^{2}} \cdot v - {c}_{L}^{2} \qquad ( Equation 67 )$$

Hence, the velocity of leader advanced may be expressed as:

$${v}^{2} + \frac{π \cdot {ε}_{0} \cdot {C}_{L}^{2} \cdot {λ}_{R}}{8 \cdot {χ}^{2}} \cdot v - {c}_{L}^{2} \to v = \frac{π \cdot {ε}_{0} \cdot {C}_{L}^{2}}{16} \frac{{λ}_{R}}{{χ}^{2}} [ - 1 + \sqrt{1 + {( \frac{16}{π \cdot {ε}_{0} \cdot {C}_{L}} )}^{2} {( \frac{{χ}^{2}}{{λ}_{R}} )}^{2}} ] \qquad ( Equation 68 )$$

The velocity of leader advanced may be simplified as:

$$v = a \cdot \frac{{λ}_{R}}{{χ}^{2}} [ - 1 + \sqrt{1 + {b ( \frac{{χ}^{2}}{{λ}_{R}} )}^{2}} ] \qquad ( Equation 69 )$$

Where a and b are constants.

The equation for velocity of leader advanced shows that if X goes to zero, the speed will reach near the speed of light and if λ_{R}→∞, then the speed goes to zero (i.e., v→0).

Now, using the design of the reactor tube at a given time, it represents the leader length with the electrode diameter (D). The variation leader length (I) with the electrode diameter (D). The ratio (X) may be given as:

$$χ = \frac{dl}{dD} = \frac{π \cdot {φ}_{s}}{4 \cdot {φ}_{l}} \cdot ( {D}_{max} + {D}_{min} ) = \frac{π \cdot {φ}_{s}}{4 \cdot {φ}_{l}} \cdot {D}_{mean} \qquad ( Equation 70 )$$

Where L may be substituted as:

$$L = χ \cdot ( {D}_{max} + {D}_{min} ) = \frac{π \cdot {φ}_{s}}{4 \cdot {φ}_{l}} \cdot ( {D}_{max}^{2} + {D}_{min}^{2} ) and \\ {D}_{mean} = \frac{1}{2} ( {D}_{max} + {D}_{min} ) . \qquad ( Equation 71 )$$

This expression allows the simplification of the velocity equation, and may be ^{PG}P-90,^{E}given as:

$$v = \frac{{ε}_{0} \cdot {C}_{L}^{2} \cdot {φ}_{L}^{2}}{4 \cdot π \cdot {φ}_{s}^{2}} \cdot \frac{{λ}_{R}}{{D}^{2}} [ - 1 + \sqrt{1 + \frac{{C}_{L}^{2}}{\frac{{ε}_{0}^{2} \cdot {C}_{L}^{4} \cdot {φ}_{L}^{4}}{{4}^{2} \cdot {π}^{2} \cdot {φ}_{s}^{4}}} \frac{{D}^{4}}{{λ}_{R}^{2}}} ] = G \cdot \frac{{λ}_{R}}{{D}^{2}} \cdot [ - 1 + \sqrt{1 + \frac{{C}_{L}^{2}}{{G}^{2}} \frac{{D}^{4}}{{λ}_{R}^{2}}} ] \qquad ( Equation 72 )$$

The compact velocity equation may be given as:

$$v = \frac{{C}_{L}^{2} \cdot {D}^{2}}{G \cdot λ + \sqrt{{G}^{2} \cdot {λ}_{R}^{2} + {C}_{L}^{2} \cdot {D}^{4}}} \qquad ( Equation 73 )$$

Where G is given as: G=6.34*10⁴ (φ₁/φₛ)².

The parameter G defines the amount of charge carried by the plasma leader by the ohmic resistance that the air atmosphere offers and the relationship between the leader speed and the atmosphere ohmic resistance per square meter.

The G parameter is an indicator of the leader discharge capacity of the reactor tube device. For example, when G goes to zero, the plasma leader speed is close to the speed of light due to a surface charge density from the electrode that is much higher than the linear density of leader. This implies a fast discharge forces the plasma leader closer to the speed of light where the charge region of electrode is reduced very quickly.

Conversely, when G is very high, the plasma speed goes down due to the large amount of load carried by the plasma leader. This forces it to go slowly, because the linear charge density is much higher than the surface charge density.

This plasma beam model shows that the plasma length is a function of several parameters: the diameter of the charge region (e.g., geometrical electrodes such as a ring, sphere, parabolic, needle, etc.) at the beginning, and end of the step shown in FIG. 50, the surface charge density, the initial charge in the electrodes, and the linear charge density by the stepped leader. The linear and surface charge densities remain constant during the reactor tube operation. Also, this model allows either the upward streamer of another electrode or earth ground (also chassis of the object such as aircraft or satellite). Plasma may flow either through a gas filled or vacuum condition at the speed of light. Plasma is a superconductor (zero resistance). Only the effect on plasma travel is the medium resistance, such as air resistance or vacuum permittivity.

Another method may be used that includes an ultrafast leader beam that produces high excitation temperature of air or gas filled after the laser beam discharge, which induces a hydrodynamic expansion along the laser path. This is so called thermal blooming or ablated laser beam. This produces a conductive channel with an air density, which drops much lower due to its density by the breakdown voltage following discharge event. The high current flows from high voltage electrodes generator in this channel and the plasma channel diameter increase up to few millimeters during discharge operation. The electron accelerates following the plasma heating from this Joule effect. The inverse bremsstrahlung process helps the electrons gain energy from the oscillating electric field or even from a high voltage pulse. This is proportional to the inverse of the square frequency and makes the high voltage generator electric field at much higher order of magnitude more efficient for heating the plasma than other techniques using a second high power laser beam that has a wavelength in the visible or near the-infrared range. These plasma channels may have a long lifetime that may increase to much higher order of the magnitude the emission time of laser electron guide plasma.

The streamer zone is where the stepped leader starts from an initial zone. This region has an electrical field equal or higher than 300 kV/m according to some embodiments. The leader advance follows the maximum potential gradient direction between the streamer zone and the leader tip. Once the leader and the upward have met, they form the return stroke. The leader is faster than the streamer and impacts on the ground chassis or the earth ground.

The parameters used for one stepped leader model are the leader current, the electric field, and the leader speed. The step length and the leader speed increase with increasing prospective return stroke current. Also, the stepped leader speed also increases when it approaches the ground.

At each step, the direction is fixed by the laser electrical beam at zero resistance offered by the laser electron beam. This allows the speed of light and straight path for plasma flow. The leader speed is a function of several parameters, the region of concentration of charges in the target of the object among other air (atmospheric) or vacuum (space) parameters. The parameter for speed model is X, which defines the ratio between the length of advance and the region of the surface of concentration of charges. The whole process starts inside the electrode ring and then the negative charge surface, located from the ring electrode and toward the target of the positive surface plate or any shape (chassis or earth ground at different locations separately). When electric field E is applied across a conductor, a current density flows due to the ‘internal’ charge flow, which may be given by:

$$J = σ E \qquad ( Equation 74 )$$

Where σ is the conductivity.

If σ=0 in a vacuum, then electric fields do not spontaneously cause currents to flow unless there is conductor path, such as laser electron plasma beam. Thus, in this sense, the plasma filament may fable to low along the laser electron beam path in a vacuum where there is not a conductor is at all.

### External Energy Sources for Using High Voltage Supplies

In certain embodiments, the systems and methods disclosed herein may be used to harness the external power source to operate high voltage power supplies for power beaming. The conductivity and lifetime of long plasma beam channels are produced by the ultrashort laser pulses efficiently by the electric field of a hybrid AC-DC-Pulse-Impulse high voltage sources.

There are several different techniques that may be used for producing electron beam, ions/particles, and plasma filaments in air or space that act like electrical wires (conductivity path) at any location. There are two potential sources: natural energy sources and man-made clean energy resource that may provide several different types of high voltage power supply or generator.

There are four different types of high voltage sources: DC, AC, Pulse, and Impulse in ascending order by energy. In certain embodiments, the laser guide uses a solid state pulsed high voltage DC source that demonstrates increased length of discharge path following the natural voltage breakdown gap. The pulse source may be either in positive or negative voltage and current following the duty cycle rate. Another advanced method is the high voltage impulse source, which supplies huge electron discharge and ion source quickly. Although different high voltage sources may be used, the behavior mechanisms for each of the sources is different.

As disclosed in U.S. Pat. No. 10,704,540, already incorporated herein by reference, powerful impulse plasma may flow using ultrafast pulse ablated laser beam through a capillary. This compression mechanism produces shock wave that involves voltage, current, and resistance circuit under impulse operation using a gas filled condition as the medium source. Interestingly, plasma dynamic flows also acts as a capacitor mechanism to intercept dielectric field polarity quickly and produce disruptive displacement current. The impulse electrical circuit is then the real primary operation used for disrupted displacement current (break down barriers) from a mechanical system into an impulse electrical power system using controlled timescale events.

There are two different mechanism operations for voltage and current impulse. The current impulse produces unipolar displacement current energy. This was explained by Maxwell equations following Gauss and Ampere laws equation regarding polarization and displacement current into waveform against barriers. The impulse voltage induces bidirectional displacement current. This displacement polarity determines in or out flow. These show the different events between the voltage and current impulse. Hence, barriers may be controlled by impulse voltage and current which affects material polarization or dielectric field. U.S. Pat. No. 11,310,900, already incorporated herein by reference, shows that electrical phenomena mechanism.

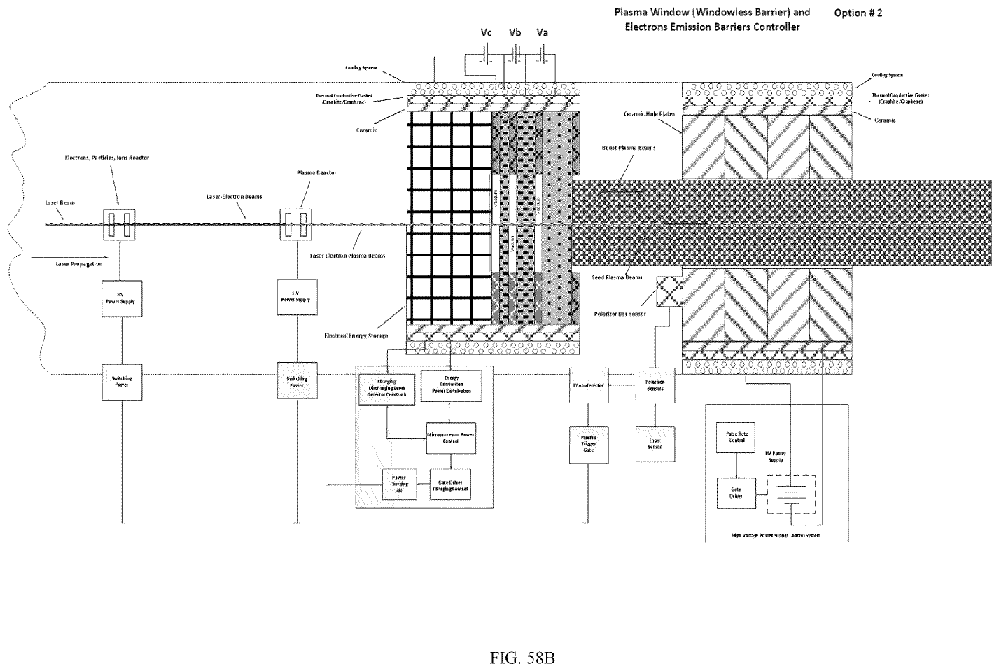

FIG. 52 depicts a block diagram of an exemplary impulse power circuit in accordance with some embodiments. In the impulse mechanism, the system either uses low or high side switching for positive voltage and negative impulse, respectively. Impulse operation is a resonant half wave ultrafast pulse phenomenon. The dielectric field and displacement current against the barriers mechanism uses combined impulse voltage/current and Fowler-Nordheim tunneling mechanisms as discussed herein.

FIG. 53 depicts a high voltage DBD and high voltage impulse power circuit for a reactor tube in accordance with some embodiments. Power sources may come from several nature and man-made energy sources. As shown in FIG. 53, the power conversion provides step up voltage, safety isolation, protect solid state, and components circuit. A pulse generator may provide pulse duration, pulse rate, pulse time, and duty cycle controller. The gate driver uses the power amplifier that accepts a low-power input from a pulse signal or trigger controller and produces a high-current drive into the gate of the MOSFET safety. High voltage MOSFET N-enhancement is the solid state device that is composed of a majority of electrons as current carriers when it is active by gate trigger pulse input. This enables operation at high voltage and current switching flows by gate control signal. A high voltage converter coil enables higher capacitance flux and electromagnetic field flows that convert into much higher voltage emission output. The load output may be connected using one electrode, such as needle, sphere, parabolic, and any geometrical shapes. In some embodiments there may be ghost capacitance (either connecting to ground or any loop in air with chassis ground from these any electrode shape).

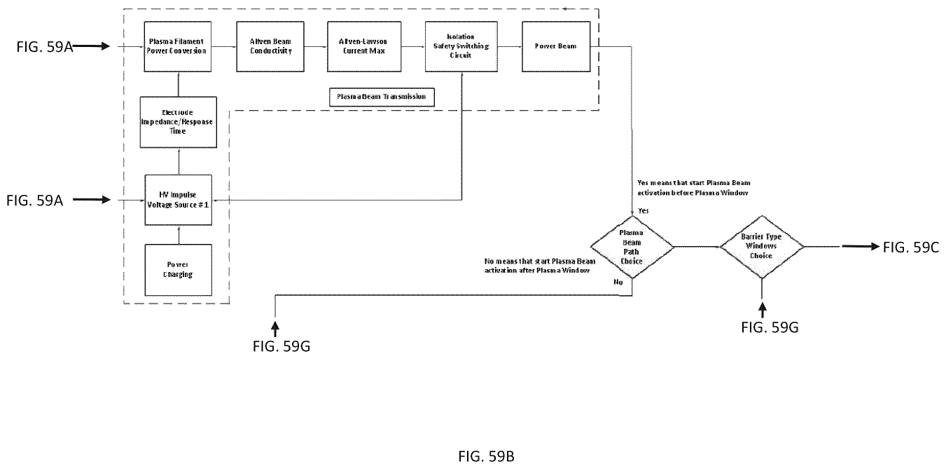

FIG. 54 depicts a block diagram of high voltage power supplies for each operation event in accordance with some embodiments. Several powerful impulse power supplies with intelligence process controllers may be used for these applications. Intelligence processors may be programed to determine what type of power source may transfer, control, and be used for switching steps, build up charge, discharge, transfer, trigger, load, and provide storage. FIGS. 52 and 54 depict exemplary operation events. Using an ultrafast impulse voltage power supply will create much greater amplitude and guide the plasma at near the speed of light. The impulse power operation will need faster laser trigger (e.g., fewer jitters) to create nanosecond time events, such as the quicker timescale events using ultrafast trigger switching disclosed in U.S. Pat. No. 11,310,900 already incorporated herein by reference.

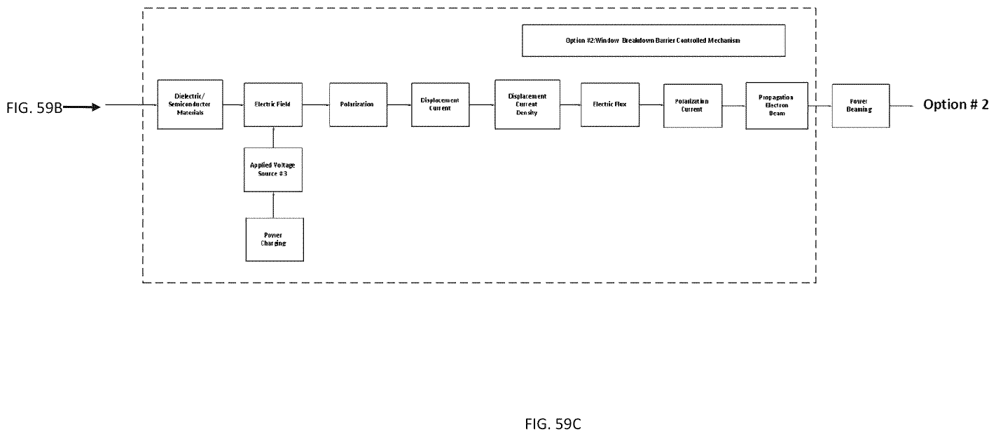

In some embodiments, the reactor tube uses two different power switching design circuits as depicted in FIG. 53. In some embodiments, these two circuits are configured for power wireless transmissions. FIG. 55 depicts potential nature and man-made energy sources for power beaming.

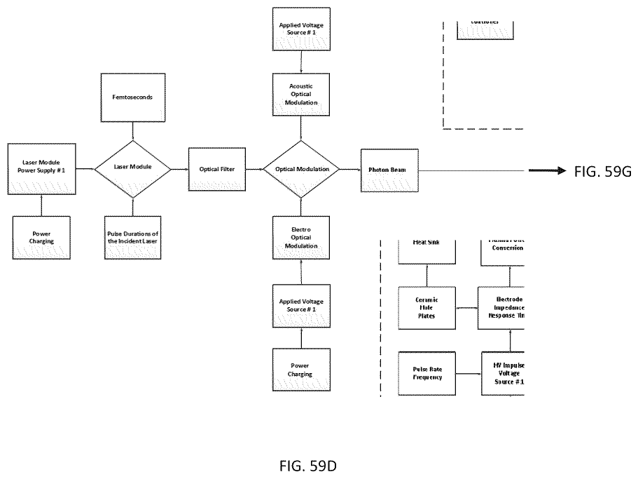

FIG. 56 depicts a block diagram of a wireless power transmission grid in accordance with some embodiments. Plasma stepped leader follows the electron beam propagation and acts as a conductor pipe path that allows the voltage travel at greater distance without using wiring. The advantage of this method is to boost its own energy along with help from electron beam propagation along the laser waveguide beam propagation at greater distance and faster speed (200,000 miles per hour). This mechanism is similar to either upward/downward streaming of the lightening stepped leader from/to earth ground where the earth acts capacitance following high voltage gradient levels of altitude air atmosphere.

As discussed, tunneling is a quantum-mechanical phenomenon and requires gain kinetic energy during tunneling barriers flow. This may be altered by applied electric field and laser-electron beams. Laser driven quantum plasma capacitor energy storage uses the Fowler-Nordheim tunneling characteristics that may transfer energy and be stored inside semiconductor layers using vacuum at nano-scale of semiconductor wafers.

The advantage of using only one plasma stepped leader is having the capability to sense the electron beam along the laser propagation easily. This allows to build-up energy itself (climb up following the electron conductor beam by feeding charging along it laser trapped electron path) along the path of laser-electron propagation beam. It also enables much compact devices. The one plasma stepped leader has the capability to bulldoze against the index refractive effect, Kerr effect, humidity, all weather, windy, turbulence, varied pressure, rainy, and any extreme conditions. Lightning stepped leader always dart, strike, and bolt down to any locations without regard for any weather climate effect even on sunny day, such as 25 miles away from the thunderstorm area. The one plasma stepped leader shields, supports, and follows its electron trap via the laser waveguide. This allows the laser-electrons beam propagation to be used at any location against any extreme conditions and act as a wireless power transmission or transfer to any location, otherwise known as a power beaming network.

Disclosed herein is a compact particle accelerator that uses an electron beam propagation from a laser driven propagation mechanism, or high voltage DBD reactor tube. The one plasma stepped leader is a boost power transmission shielding that may be controlled by adjusting voltage level to meet any desired requirements. This enables power density to be controllable. It will be appreciated that the electron beam is able to charge the quantum capacitor storage energy device without using one plasma stepped leader device. This beam power density is controlled only by the concentration of the high voltage DBD reactor tube and gas flow rate or the amount of gas region in a medium tube. The one plasma stepped leader will enable much higher power density following the path of electron beam along the laser propagation path.

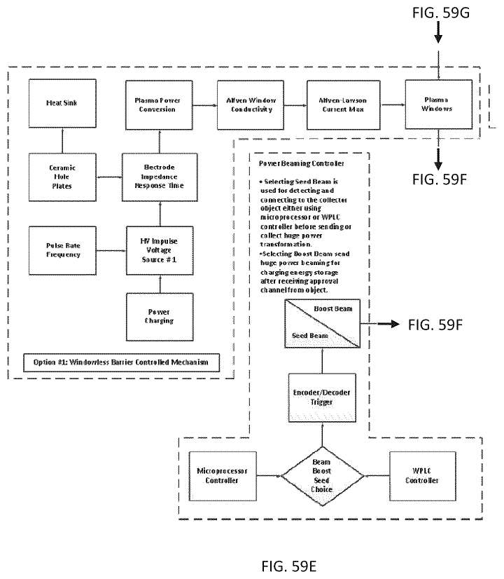

FIG. 57 depicts grade levels and classifications of power beaming in accordance with some embodiments. As illustrated in FIG. 57, the design of the power beaming network may range from lowest to highest grade. The lowest grade may use photovoltaic for storage energy, but may be limited due to Kerr effect, index refractive, turbulence weather condition, and humidity. The middle grade may be able to deal with these conditions using further advanced design of power beaming. The highest grade may be able to deal with extreme weather conditions, higher demands suppliers, defense, and emergency conditions.

### Power Beaming Transceiver with Added Isolation and Safety Switching (Polarizer Sense Switching System) and Plasma Window Shield

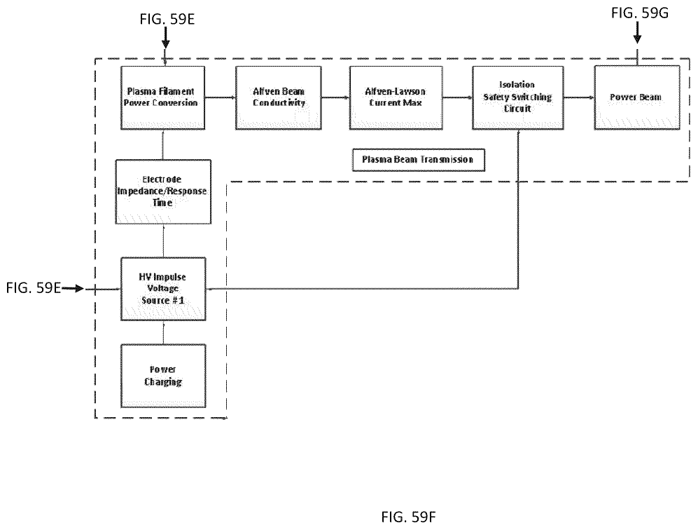

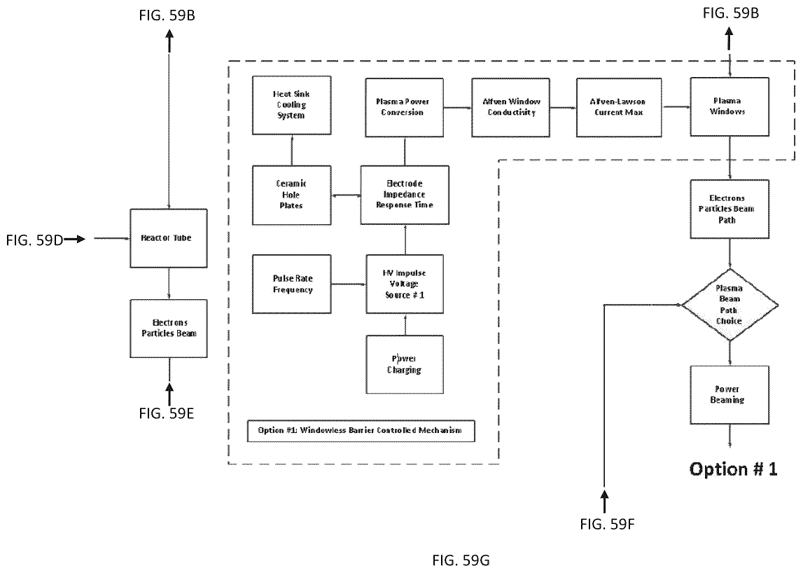

FIGS. 58A-B depict two different options for Power Beaming Transceiver, Polarizer, and Plasma Window Shield Protection in accordance with some embodiments. FIGS. 59A-G depict an exemplary block diagram of one embodiment of the system in accordance with some embodiments. Transceiver is a combination transmitter/receiver in a single package. This device shows that the power beaming may be done using a tiny seed beam transmitter as communication or even use it for power beaming transfer via tiny hole of energy storage receiver device and extract huge power beam reversely toward the large target surface of receiver device. A seed beam may communicate with another separate transceiver device at a different location for starting beam power process operation. The polarizer conversion circuit may be used to monitor the surged plasma beam (either from nature/space or man-made plasma sources) for breaker circuit (isolation switching off laser beam, electrons and plasma beams). In some embodiments, the power beaming transceiver devices are configured for unidirectional or bidirectional power beaming propagation using one line of communication between the power beaming transceiver devices.

The polarizer conversion circuit may be used to monitor the surged plasma beam (either from nature/space or man-made plasma sources) for breaker circuit (isolation switching off laser beam, electrons and plasma beams). The power beaming signal may be manipulated either using hybrid (EM transmitter/receiver circuits and optical circuits) or using separately RF, Microwave, or Plasma.

Producing plasma filaments have different meanings. When the laser (photon beam) travels toward gas filled medium, plasma filament is producing by Kerr effect. The ablated laser beam produces gas ionization that is producing some conductor path along the laser path line. This creates a plasma filament. High voltage electrode circuits produce the man-made plasma filament along the ablated path. The nature plasma filament follows the man-made filament path and then produces amplifier plasma filament by flushing down from huge charge regions of a location in upper atmospheres and even from space or also from man-made power source. These differences in manmade and nature plasma filaments need to be clarified. The difference between the man-made plasma filament and nature/space plasma filament is the current density flowing. Hence, this important key is using the isolation safety switching designs.

Different sizes of the hole and the area of diameter of the energy storage receiver devices may be done in absorption plasma density current into electron emission via barriers control system and recoil mechanism. The purpose of using the recoil mechanism is to damp the shock pressures surge from powerful interrupted plasma flowing (reverse flowing from power sources). There are two different types of isolation switching: one is spark gap mechanism connecting to ground/chassis as either heat sink loss or energy storage devices, and the second is the signal trigger to turn off the laser waveguide system that prevent its conductor path while the nature/space plasma energy is diverting into another path flow back to different components, such as heat sink as power dissipates or replenishes back into energy storage devices. The isolation switching circuit is illustrated in FIG. 59F of the exemplary block diagram.

Additionally, a plasma window shield device is used for protection from pollution or tiny objects penetrating to either the reactor tube or the power beaming transceiver.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. An energy transmission system comprising:
at least one reactor tube comprising:
an insulated gas cell disposed between two electrode rings; and
a gas feeding barter configured to feed gas to the insulated gas cell;
at least one laser configured to transmit a laser beam through the at least one reactor tube;
a high voltage power supply operatively coupled to the two electrodes; and
an energy storage device configured to store energy trapped from the laser beam.

2. The system of claim 1, wherein the at least one reactor tube comprises a first reactor tube and a second reactor tube, and wherein the first reactor tube is configured to transmit the laser beam from the first reactor tube to the second reactor tube.

3. The system of claim 1, wherein the energy transmission system further comprises:
a base; and
a support comprising:
a rest;
one or more restraints; and
one or more adjustment devices,
wherein the support is mounted to the base,
wherein the support is configured to receive the at least one reactor tube against the rest.

4. The system of claim 3, wherein the one or more restraints secure the at least one reactor tube to the support.

5. The system of claim 3, wherein the one or more adjustment devices are configured to adjust the at least one reactor tube in at least one of an x-axis, a y-axis, a z-axis, a yaw direction, or a pitch direction.

6. The system of claim 1, wherein the at least one reactor tube includes one or more restricted flow valves.

7. The system of claim 1, wherein the at least one reactor tube includes a window disk.

8. The system of claim 1, wherein the laser beam traps a plurality of electrons for transmission of energy.

9. The system of claim 1, wherein the at least one reactor tube is ceramic.

10. The system of claim 1, further comprising a pump to provide airflow to the insulated gas cell.

11. The system of claim 1, wherein the at least one reactor tube includes a dielectric barrier discharge circuit.

12. The system of claim 11, further comprising a capacitor circuit used for electrons that jump across one or more tunnels in the dielectric barrier discharge circuit.

13. The system of claim 1, further comprising at least two power beaming transceiver devices that are configured for unidirectional or bidirectional power beaming propagation using one line of communication between the at least two power beaming transceiver devices.

14. A wireless power grid system comprising:
a first reactor tube and at least a second reactor tube, each of the first and the at least second reactor tubes comprising:
an insulated gas cell disposed between two electrode rings; and
a gas feeding barter configured to feed gas to the insulated gas cell;
at least one laser configured to transmit a laser beam from the first reactor tube to the second reactor tube;
a high voltage power supply operatively coupled to the two electrodes of each of the reactor tubes; and
a first energy storage device coupled to the first reactor tube and a second energy storage device coupled to the at least second reactor tube, each energy storage device configured to store energy trapped from the laser beam.

15. The system of claim 14, wherein each reactor tube is coupled to:
a base; and
a support comprising:
a rest;
one or more restraints; and
one or more adjustment devices,
wherein the support is mounted to the base,
wherein the support is configured to receive the respective reactor tube against the rest.

16. The system of claim 15, wherein the one or more adjustment devices are configured to adjust the respective reactor tube in at least one of an x-axis, a y-axis, a z-axis, a yaw direction, or a pitch direction.

17. A method comprising:
receiving energy from an energy source into one or more energy storage devices;
activating at least one laser disposed within a first reactor tube to produce a laser beam;
trapping a plurality of electrons in the laser beam to form an electron beam; and
transmitting the electron beam from the first reactor tube to a second reactor tube.

18. The method of claim 17, further comprising storing an energy from the electron beam in a second energy storage device coupled to the second reactor tube.

19. The method of claim 18, further comprising transmitting a second electron beam from the second reactor tube to a third reactor tube.

20. The method of claim 17, further comprising adjusting the first reactor tube or the second reactor tube in at least one of an x-axis, a y-axis, a z-axis, a yaw direction, or a pitch direction, and controlling the electron beam.
